(19) United States
(12) Patent Application Publication
(10) Pub. No.: US 2010/0220272 A1
(43) Pub. Date: Sep. 2, 2010

(54) LIQUID CRYSTAL DISPLAY

(76) Inventors: Yusuke Ohashi, Kanagawa (JP); Yujiro Yanai, Kanagawa (JP); Hajime Nakayama, Kanagawa (JP)

Correspondence Address: BUCHANAN, INGERSOLL & ROONEY PC, POST OFFICE BOX 1404, ALEXANDRIA, VA, 22313-1404, US

(21) Appl. No.: 12/680,679

(22) PCT Filed: Sep. 25, 2008
(86) PCT No.: PCT/JP2008/067245

§ 371 Date: Mar. 29, 2010

(30) Foreign Application Priority Data
Sep. 28, 2007 (JP) 2007-256819
Sep. 28, 2007 (JP) 2007-256885
Sep. 24, 2008 (JP) 2008-245034

(51) Int. Cl. G02F 1/1335; C09K 19/00

(52) U.S. Cl. 349/117; 349/96

(57) ABSTRACT

The invention provides a liquid crystal display which is excellent in both display performance and moisture and heat resistance.

A liquid crystal display of the invention includes a light source, a liquid crystal cell that includes a pair of substrates and a liquid crystal layer being placed between the substrates, and a film that contains a thermoplastic resin composition containing a lactone ring-containing polymer. The film is arranged on the nearer side to the light source of the liquid crystal cell. Further, the liquid crystal display of the invention includes a film that contains a thermoplastic resin composition containing a lactone ring-containing polymer, wherein each of in-plane retardation (Re) and retardation in a thickness direction (Rth) of the film is 10 nm or less, and an optically anisotropic layer on the film.

### TECHNICAL FIELD

The present invention relates to a liquid crystal display.

### BACKGROUND ART

Liquid crystal displays are widely used as monitors of personal computers and portable equipments, and for television uses for various advantages, e.g., low voltage, low consumption of electric power, and capable of miniaturization and thinning. Various modes are proposed of these liquid crystal displays by the state of arrays of liquid crystals in liquid crystal cells.

In various kinds of liquid crystal displays, a phase difference plate is conventionally used for the purpose of optical compensation. As such phase difference plates, for example, optical biaxial phase difference plates are exemplified, and these phase difference plates can be mainly manufactured by various kinds of polymer film stretching methods such as a stretching method between rolls, a compression stretching method between rolls, and a tenter transverse uniaxially stretching method (refer to Patent Literature 1), and a method of giving anisotropy by biaxial stretching (refer to Patent Literature 2). Further, in addition to these, a phase difference plate using in combination of a uniaxially stretching polymer film having positive optical anisotropy and a biaxially stretching polymer film having negative optical anisotropy small in in-plane phase difference value (refer to Patent Literature 3), and, not stretching methods as above, a phase difference plate given negative uniaxiality by making soluble polyimide a film on a substrate according to the nature of polyimide is also exemplified (refer to Patent Literature 4).

According to the above film stretch techniques, it is possible to give an optical characteristic, e.g., nx>ny>nz, to a stretched film to be formed. nx, ny and nz respectively show refractive indexes of X axis; Y axis and Z axis in the film. X axis is the axial direction showing the maximum refractive index in the in-plane of film, Y axis is the axial direction vertical to X axis in the in-plane, and Z axis shows thickness direction vertical to X axis and Y axis. Since double refraction films having such an optical characteristic can widen viewing angle of display characteristic of the liquid crystal display when arranged between a liquid crystal cell and a polarizer of the liquid crystal display, they are useful as viewing angle compensatory films of the liquid crystal cell.

Further, the characteristics of a phase difference plate and an optically compensatory film for improving viewing angle characteristics to the display modes of various kinds of liquid crystal displays are various, and required performances to the supports of phase difference plates and optically compensatory films corresponding to the characteristics are also various. As a result, requirements are diversified such as to heighten optical anisotropy and optical isotropy of the supports of phase difference plates and optically compensatory films, and at the same time from the viewpoint of the improvement of the optical characteristics of display, e.g., front contrast, requirements for optical performances such as haze of a phase difference plate and an optically compensatory film have been increasingly severer.

Further, in the protective film of a polarizing plate and various phase difference plates and optically compensatory films, cellulose acetate films high in optical isotropy, good in moisture permeability, and high in adhesion to PVA that is used as a polarizer have been conventionally used.

However, various problems have arisen in liquid crystal displays in recent years. For example, panel temperature increases by radiation of inner side circuit and backlight due to use for long, and when liquid crystal displays are used under severe environments such as high temperature, high humidity and low humidity, triacetyl cellulose film of the protective film of the polarizing plate is subjected to influences by temperature, humidity and the elapse of time, and optical characteristics such as Re and Rth and physical characteristics such as moisture content and dimensions are changed, as a result optical compensation performance varies, light leaks at the time of black display, tint changes, or image unevenness occurs.

On the other hand, a thermoplastic resin material is disclosed in Patent Literature 5, which is a planar thermoplastic resin composition for optics containing a lactone ring-containing polymer as a main component or containing a lactone ring-containing polymer and the other thermoplastic resins to have optical characteristics and mechanical characteristics suitable for a protective film for optics, an optical film and an optical sheet, in addition to transparency and heat resistance when the resin composition is made into a film or a sheet on specific condition.

Further, as a liquid crystal display mode, conventionally, a TN mode, which is an arrange state with approximately 90° twisted toward an upper-side substrate from a lower-side substrate of a liquid crystal cell, has been typical.

Generally, a liquid crystal display includes a liquid crystal cell, an optically compensatory sheet and a polarizer. The optically compensatory sheet is used in order to prevent images from coloring, or widen viewing angle, and a film having liquid crystal applied on a stretched birefringent film or a transparent film is used. For example, Patent Literature 6 discloses a technique that applies the optically compensatory sheet fixed by applying and aligning discotic liquid crystal on a triacetyl cellulose film to liquid crystal cells of the TN mode, and accordingly widens viewing angle. However, liquid crystal displays for television which are supposed to be viewed from various angles in large screen cannot satisfy rigorous requests regarding viewing angle dependency using this method. Liquid crystal displays such as In-Plane Switching (IPS) mode, Optically Compensatory Bend (OCB) mode, Vertically Aligned (VA) mode, which are different from TN mode, have been studied. In particular, VA mode which has high contrast and relatively high yield in preparation has attracted attention as a liquid crystal display (LCD) for televisions (Patent Literature 6).

When viewed from an inclination direction by widening the viewing angle of such liquid crystal displays, as liquid crystal displays for maintaining high contrast, in which a gradation inversion is not likely to occur, liquid crystal displays using a phase difference film for viewing angle compensation have been known. For example, as the phase difference film for viewing angle compensation, a phase difference film of negative uniaxiality where in-plane retardation (Re) is substantially 0 and has an optical axis in a direction perpendicular to the film surface, and a phase difference film of biaxiality where Re is 100 nm or less, and retardation in a thickness direction (Rth) of the film is 100 nm or more have been known. As materials of such phase difference films, for example, aromatic-based polymers such as polycarbonate-based polymer, polyarylate-based polymer, or polyester-based polymer, acryl-based polymer, or cyclic polyolefin-based polymer have been known (Patent Literature 7).

Patent Literature 8 discloses a technique which has a viewing angle compensation function and reduces contrast unevenness in high temperature exposure by using a polymer which has a specific photoelastic coefficient, and Re and Rth developability.

Patent Literature 9 discloses a phase difference plate which represents wavelength dispersion characteristics of a ¼ wavelength plate or a ½ wavelength plate in a visible light region (wavelength region of 400 to 700 nm) with a relatively thin film by having a specific chemical structure.

Patent Literature 10 discloses a protective film mainly containing a lactone ring-containing polymer. By using this, a polarizing plate, which has high bonding strength regarding the polarizer and the protective film, as well as good moisture and heat resistance, was obtained. However, with reference to the relation of the arrangement position of a protective film to the display performance in liquid crystal displays, no suggestion has been described.

[Patent Literature 1] JP-A-3-33719

[Patent Literature 2] JP-A-3-24502

[Patent Literature 3] JP-A-4-194820

[Patent Literature 4] JP-T-8-511812

[Patent Literature 5] WO 2006/025445A1

[Patent Literature 6] JP 2587398

[Patent Literature 7] JP-A-11-95208

[Patent Literature 8] JP-A-2001-27707

[Patent Literature 9] JP-A-2006-171464

[Patent Literature 10] JP-A-2007-127892

### SUMMARY OF INVENTION

### Problem that the Invention is to Solve

Accordingly, a first object of the invention is to provide a liquid crystal display that has little atmosphere dependency regarding optical performance, in particular, having little humidity dependency, excellent front contrast, and further excellent durability.

Further, in Patent Literature 7, due to the use of a phase difference film including an aromatic-based polymer, there is a problem that contrast unevenness in the liquid crystal display occurs easily when exposed to high temperature. With reference to a film including an acryl-based polymer or a cyclic polyolefin-based polymer, it should be used by laminating two or three or more sheets, because there is a demand for high Re and Rth in liquid crystal displays. Accordingly, it is not preferred due to high cost and lost productivity in the liquid crystal display industry where price competition has been severe recently. Accordingly, a technique which has a single sheet, and reduces contrast unevenness in high temperature exposure is desired.

Further, it was found that, in Patent Literature 8, the suppression of contrast unevenness which has been improved in high temperature exposure is insufficient, and display performance and quality of a liquid crystal display which have recently been demanded may not be obtained. Further, it was found that, in a high temperature exposure test of a polarizing plate form in which a protective film, a polarizer, and a phase difference film are laminated sequentially, curling occurs in the polarizing plate, and contrast unevenness is deteriorated. The contrast unevenness is a level which is visually recognized as unevenness when an optical film and a polarizing plate thereof are laminated on liquid crystal displays. Development of an optical film reducing contrast unevenness in high temperature exposure has been desired.

A second object of the invention is to provide a liquid crystal display which is excellent in developability of in-plane retardation and retardation in a thickness direction (Rth) of the film, is excellent in process compatibility regarding a polarizing plate, is excellent in durability regarding atmosphere change, and is able to be produced cheaply and with good productivity.

That is, an object which is common to the first and second objects in the invention is to provide a liquid crystal display which is excellent in both display performance and moisture and heat resistance.

### Means for Solving the Problem

As a result of earnest examinations for solving the above problems, the present inventors have found the optically compensatory sheet, the polarizing plate, and the liquid crystal display shown below; thus the invention has been achieved.

That is, the first object of the invention is achieved by the following means.

[1] A VA (vertical alignment) liquid crystal display including at least a light source, a liquid crystal cell that includes a pair of substrates and a liquid crystal layer being placed between the substrates, and a film that contains a thermoplastic resin composition containing a lactone ring-containing polymer, wherein the film is arranged on the nearer side to the light source of the liquid crystal cell.

[2] A VA (vertical alignment) liquid crystal display including at least a film that contains a thermoplastic resin composition containing a lactone ring-containing polymer, wherein each of in-plane retardation (Re) and retardation in a thickness direction (Rth) of the film is 10 nm or less, and an optically anisotropic layer on the film.

[3] The VA (vertical alignment) liquid crystal display as claimed in [2], wherein the optically anisotropic layer is formed by applying a liquefied polymer on the film.

[4] The VA (vertical alignment) liquid crystal display as claimed in [2], wherein the optically anisotropic layer contains polyimide.

The second object of the invention is achieved by the following means.

[5] A VA (vertical alignment) liquid crystal display including a liquid crystal cell, two polarizing plates disposed outside the liquid crystal cell, and an optically anisotropic layer disposed at either of two spaces between the liquid crystal cell and two polarizing plates, wherein the optically anisotropic layer contains a lactone ring-containing polymer, and in-plane retardation Re and retardation in a thickness direction Rth of the optically anisotropic layer satisfy the following formulae (A) and (B),

40 nm≦Re(550)≦275 nm (A)

0 nm≦Rth(550)≦275 nm (B)

wherein Re(550) and Rth(550) represent in-plane retardation and retardation (nm) in a thickness direction at the wavelength of 550 (nm).

[6] A VA (vertical alignment) liquid crystal display including a liquid crystal cell, two polarizing plates disposed outside the liquid crystal cell, and optically anisotropic layers disposed at both of two spaces between the liquid crystal cell and two polarizing plates, wherein the optically anisotropic layers contain a lactone ring-containing polymer, and in-plane retardation Re and retardation in a thickness direction Rth of the optically anisotropic layers satisfy the following formulae (C) and (D).

30 nm≦Re(550)≦80 nm (C)

75 nm≦Rth(550)≦155 nm (D)

[7] The VA (vertical alignment) liquid crystal display as claimed in [5] or [6], wherein the optically anisotropic layer containing the lactone ring-containing polymer contains at least one retardation developer.

[8] The VA (vertical alignment) liquid crystal display as claimed in [7], wherein the retardation developer is a compound represented by the following formula (I):

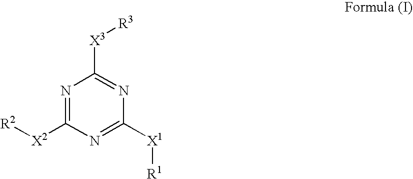

Wherein X¹ represents a single bond, —NR⁴—, —O— or S—; X² represents a single bond, —NR⁵—, —O— or S—; X³ represents a single bond, —NR⁶—, —O— or S—. R¹, R² and R³ each independently represents an alkyl group, an alkenyl group, an aromatic group, or a heterocyclic group, R⁴, R⁵ and R⁶ each independently represents a hydrogen atom, an alkyl group, an alkenyl group, an aryl group or a heterocyclic group.

[9] The VA (vertical alignment) liquid crystal display as claimed in [7], wherein the retardation developer is a compound represented by the following formula (II):

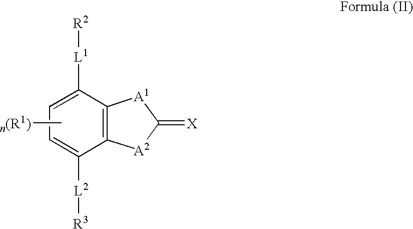

Wherein L¹ and L² each independently represents a single bond, or a divalent connecting group. A¹ and A² each independently represents a group selected from the group consisting of —O—, —NR— (R represents a hydrogen atom or a substituent), —S— and —CO—. R¹, R² and R³ each independently represents a substituent. X represents an atom of 6th group, 5th group, or 4th group. n represents an integer of 0 to 2.

[10] The VA (vertical alignment) liquid crystal display as claimed in [7], wherein the retardation developer is a compound represented by the following formula (III):

Ar¹-L²-X-L³-Ar² Formula (III)

Wherein Ar¹ and Ar² each independently represents an aromatic group, L² and L³ each independently represents a divalent connecting group selected from —O—CO— or CO—O— group, and X represents a 1,4-cyclohexylene group, a vinylene group, or an ethynylene group.

[11] The VA (vertical alignment) liquid crystal display as claimed in [5] to [10], wherein the optically anisotropic layer including the lactone ring-containing polymer is stretched in at least one direction.

[12] The VA (vertical alignment) liquid crystal display as claimed in [11], wherein a stretch ratio in the stretching is 1.3 to 5 times.

### ADVANTAGE OF THE INVENTION

The invention may provide a liquid crystal display which is excellent in both display performance and moisture and heat resistance.

According to an embodiment of the invention, a liquid crystal display that has little atmosphere dependency regarding optical performance, in particular, having little humidity dependency, excellent front contrast, and further excellent durability, is provided.

Further, according to another embodiment of the invention, images of high contrast at a wide viewing angle may be displayed, and a VA mode liquid crystal display where color shift (tint changes when viewed from inclination direction) is reduced may be provided. Further, according to this embodiment, a liquid crystal display of the invention may be produced by a simple method.

### BRIEF DESCRIPTION OF DRAWINGS

FIG. 1 is the outline of the cross sectional view of an example of the optically compensatory sheet in embodiments 1-1 and 1-2 of the invention.

FIG. 2 is the outline of the cross sectional view of an example of the polarizing plate embodiments 1-1 and 1-2 of the invention.

FIG. 3 is the outline of the cross sectional view of the liquid crystal display in Examples and Comparative Examples.

FIG. 4 is the outline of the cross sectional view of the liquid crystal display in Examples and Comparative Examples.

FIG. 5 is the outline of the cross sectional view of the liquid crystal display in Examples 1-1 to 1-8 and Comparative Examples 1-1 to 1-8).

FIG. 6 is the outline of the cross sectional view of the liquid crystal display in Examples 2-1 to 2-3 and Comparative Examples 2-1 to 2-3.

FIG. 7 is the outline of the cross sectional view of the liquid crystal display in Examples 3-1 to 3-3 and Comparative Examples 3-1 to 3-3.

FIG. 8 is the outline of the view of the liquid crystal display according to Example 2-1 of the invention.

FIG. 9 is the outline of the view of the liquid crystal display according to Example 2-2 of the invention.

### EXPLANATION OF REFERENCE NUMERALS

1: UPPER SUBSTRATE OF LIQUID CRYSTAL CELL
3: LOWER SUBSTRATE OF LIQUID CRYSTAL CELL
5: LIQUID CRYSTAL LAYER (LIQUID CRYSTAL MOLECULE)
8a, 8b: POLARIZING FILM
9a, 9b: ABSORPTION AXIS OF POLARIZING FILM
10a, 10b: OPTICALLY ANISOTROPIC LAYER
11a, 11b: SLOW AXIS OF OPTICALLY ANISOTROPIC LAYER
10: OPTICALLY COMPENSATORY SHEET
12: THERMOPLASTIC RESIN FILM
14: OPTICALLY ANISOTROPIC LAYER
16: POLARIZING FILM
18: PROTECTIVE FILM
20: POLARIZING PLATE
101: OUTER PROTECTIVE FILM OF UPPER POLARIZING PLATE
102: POLARIZING FILM OF UPPER POLARIZING PLATE
103: SUPPORT
104: UPPER OPTICALLY ANISOTROPIC LAYER
105: UPPER SUBSTRATE OF LIQUID CRYSTAL CELL
106: LIQUID CRYSTAL LAYER
107: LOWER SUBSTRATE OF LIQUID CRYSTAL CELL
108: LOWER OPTICALLY ANISOTROPIC LAYER
109: SUPPORT
110: POLARIZING FILM OF LOWER POLARIZING PLATE
111: OUTER PROTECTIVE FILM OF LOWER POLARIZING PLATE

### DESCRIPTION OF EMBODIMENTS

The invention will be described in detail below. In the specification of the invention, the description “from a certain value to a certain value” is used to mean to include these values as the greatest lower bound and the least upper bound respectively. In the specification of the invention, “group” such as alkyl group and the like may have or may not have a substituent, unless otherwise indicated. Further, in a case of a group in which a carbon atom number is restricted, the carbon atom number means the number including the carbon atom number of the substituent. Substantially orthogonal or parallel' strictly means a range of angle ±10°.

In the specification of the invention, Re(λ) and Rth(λ) are respectively in-plane retardation and retardation in a thickness direction at wavelength λ. Re(λ) is measured by projecting light of wavelength λ nm in the direction of normal line of the film by KOBRA 21ADH or WR (manufactured by Oji Scientific Instruments).

When the film to be measured is a film expressed by uniaxial or biaxial refractive index ellipsoid, Rth(λ) is computed according to the following method.

With in-plane slow axis (judged by KOBRA 21ADH or WR) as inclined axis (rotation axis) (when there is no slow axis, arbitrary direction in the plane of the film is taken as a rotation axis), Re(λ) is measured at six points from the normal line in the direction of the normal line of the film of one side to 50° with every 10° step by making incidence of light of wavelength λ nm from each inclined direction, and Rth(λ) is computed by KOBRA 21 ADH or WR on the basis of the measured retardation values, the assumption value of the average refractive index, and the inputted film thickness value.

In the above, in the case of a film having the direction where the value of retardation is zero at a certain inclined angle with the slow axis in the plane from the normal line direction as a rotation axis, after the sign of the retardation value at an inclined angle larger than the inclined angle is changed to minus, Rth(λ) is computed by KOBRA 21ADH or WR.

Incidentally, with the slow axis as the inclined axis (rotation axis) (when there is no slow axis, arbitrary direction in the plane of the film is taken as a rotation axis), and the retardation value is measured from arbitrary inclined two directions, and Rth can also be computed according to the following expressions (10) and (11) on the basis of the measured retardation values, the assumption value of the average refractive index, and the inputted film thickness value.

$$\begin{matrix}Re ( θ ) = [ nx - \frac{ny \times nz}{\sqrt{\begin{matrix}{\{ ny sin [ {sin}^{- 1} ( \frac{sin ( - θ )}{nx} ) ] \}}^{2} + \\ {\{ nz cos [ {sin}^{- 1} ( \frac{sin ( - θ )}{nx} ) ] \}}^{2}\end{matrix}}} ] \times \frac{d}{cos [ \begin{matrix}{sin}^{- 1} \\ ( \frac{sin ( - θ )}{nx} )\end{matrix} ]} & ( 10 ) \\ Rth = \frac{nx + ny}{2 - nz} \times d & ( 11 )\end{matrix}$$

In the expression, Re(θ) represents a value of retardation in the direction inclined by angle θ from the direction of the normal line.

In the expressions, nx represents the refractive index in the slow axis direction in the plane, ny represents the refractive index in the direction orthogonal to nx in the plane, nz represents the refractive index in the direction orthogonal to nx and ny, and d represents a film thickness (μm).

In the case of a film that cannot be expressed by uniaxial or biaxial refractive index ellipsoid, i.e., a film not having what is called an optical axis, Rth(λ) is computed according to the following method.

With in-plane slow axis (judged by KOBRA 21ADH or WR) as inclined axis (rotation axis), Re(λ) is measured at eleven points in the direction of the normal line of the film from −50° to +50° with every 10° step by making incidence of light of wavelength λ nm from each inclined direction, and Rth(λ) is computed by KOBRA 21 ADH or WR on the basis of the measured retardation values, the assumption value of the average refractive index, and the inputted film thickness value.

In the above measurement, as the assumption value of the average refractive index, the values described in Polymer Handbook, John Wiley & Sons, Inc. and catalogs of various optical films can be used. With respect to optical films whose values of average refractive index are unknown, the values can be measured with an Abbe refractometer. The values of average refractive indexes of main optical films are shown below.

Cellulose acylate (1.48), cycloolefin polymer (1.52), polycarbonate (1.59), polymethyl methacrylate (1.49), and polystyrene (1.59)

By inputting the assumption value of an average refractive index and a film thickness, KOBRA 21ADH or WR computes nx, ny and nz. From the computed nx, ny and nz, Nz=(nx−nz)/(nx−ny) is further computed.

In the specification of the invention, when the measurement wavelength is not especially described, Re and Rth are taken as those at wavelength of 550 nm.

### Embodiments 1-1 and 1-2

A VA (vertical alignment) liquid crystal display according to Embodiment 1-1 of the invention includes at least a light source, a liquid crystal cell having a pair of substrates and a liquid crystal layer being placed between the substrates, and a film containing a thermoplastic resin composition containing a lactone ring-containing polymer. The film is arranged on the nearer side of the light source of the liquid crystal cell. Regarding the film containing a thermoplastic resin composition containing a lactone ring-containing polymer, the description of “a thermoplastic resin film containing a lactone ring-containing polymer” in the optically compensatory sheet described below can be referred to as it is.

“The film is arranged on the nearer side of the light source of the liquid crystal cell” means that the film containing a thermoplastic resin composition containing a lactone ring-containing polymer is provided on the outermost layer (i.e., the nearest side to light source) when one film layer or more is provided on the side of the light source of the liquid crystal cell. The film preferably is provided as a protective film of a polarizing plate.

According to the VA (vertical alignment) liquid crystal display according to Embodiment 1-1 of the invention, the VA (vertical alignment) liquid crystal display has little atmosphere dependency regarding optical performance, in particular, little humidity dependency, little haze, excellent front contrast, and further excellent durability and atmosphere dependency.

A VA (vertical alignment) liquid crystal display according to Embodiment 1-2 of the invention includes at least a film containing a thermoplastic resin composition containing a lactone ring-containing polymer, has 10 nm or less of in-plane retardation Re and retardation in a thickness direction Rth of the film respectively, and has an optically anisotropic layer on the film.

According to the VA (vertical alignment) liquid crystal display according to Embodiment 1-2 of the invention, the VA (vertical alignment) liquid crystal display is excellent in developability of in-plane retardation and retardation in a thickness direction, is excellent in process compatibility of a polarizing plate, is excellent in durability regarding atmosphere change, and is able to be produced cheaply and with good productivity.

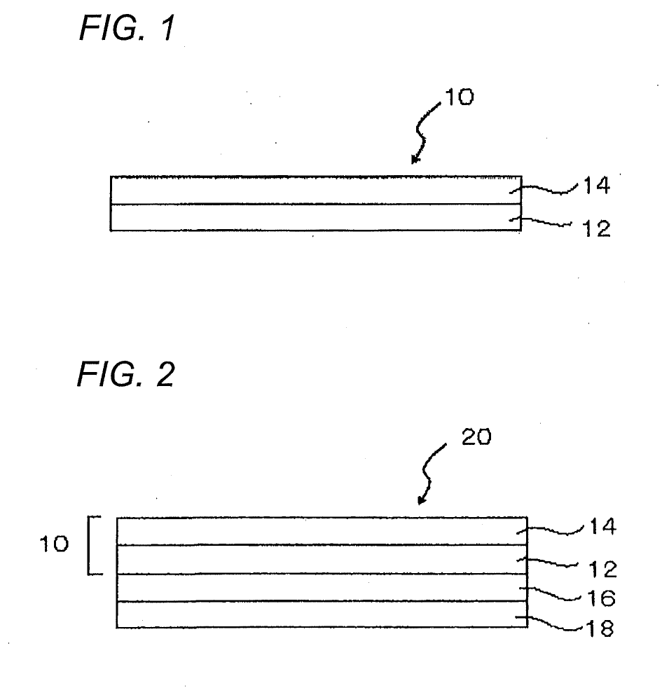

The outline of the cross sectional view of an example of the optically compensatory sheet usable in Embodiments 1-1 and 1-2 of the invention is shown in FIG. 1.

Optically compensatory sheet 10 shown in FIG. 1 is a laminate of thermoplastic resin film 12 containing a prescribed polymer and optically anisotropic layer 14. Optically anisotropic layer 14 consists of a polymer layer formed by application. Optical characteristics of optically compensatory sheet 10 are adjusted responding to the mode of the liquid crystal cell to be an object of optical compensation. Thermoplastic resin film 12 may be an optically anisotropic film contributing to optical compensation or may be an optically isotropic film, but when thermoplastic resin film 12 is isotropic, adjustment of optimization of optical characteristics of the optically compensatory sheet 10 is easy. For example, in adjusting optical characteristics by subjecting thermoplastic resin film 12 to stretching treatment after forming a polymer layer on the film by application, it is sufficient to determine stretching condition considering only the portion of contribution of the optical characteristics of optically anisotropic layer 14 capable of obtaining by stretching the polymer layer without taking the portion of contribution of thermoplastic resin film 12 into consideration. Thermoplastic resin film 12 may of course be optically anisotropic. When thermoplastic resin film 12 is optically anisotropic, it is preferred in the aspects that the portion of contribution of the optical characteristics of optically anisotropic layer 14 to optical compensation performance can be reduced, and the thickness of the polymer layer can be made thinner.

The outline of the cross sectional view of an example of the polarizing plate in the invention is shown in FIG. 2.

Polarizing plate 20 shown in FIG. 2 consists of optically compensatory sheet 10, polarizing film 16 and protective film 18. Thermoplastic resin film 12 of optically compensatory sheet 10 also functions as the protective film of polarizing film 16. Protective film 18 includes a polymer film such as a cellulose acylate film, or a cycloolefin-based polymer film. Protective film 18 may be the same as thermoplastic resin film 12.

Incidentally, when polarizing plate 20 is arranged in a liquid crystal display, it is preferred to arrange optically compensatory sheet 10 to face the liquid crystal cell side, i.e., inner side.

Since optically compensatory sheet 10 in this embodiment has a structure of lamination of optically anisotropic layer 14 comprising a polymer layer and thermoplastic resin film 12 containing a lactone ring-containing polymer, atmosphere dependency, in particular atmospheric humidity dependency, of optical performance is little, and variation in in-plane retardation (Re) and retardation in a thickness direction (Rth) due to atmosphere is smaller. As a result, the performances of polarizing plate 20 having optically compensatory sheet 10 as a protective film also hardly vary depending upon atmosphere, and the display characteristics such as contrast of the liquid crystal display having optically compensatory sheet 10 as the protective film are also little in atmosphere dependency and excellent in durability. On one hand, when thermoplastic resin film 12 alone is subjected to stretching treatment to give sufficient optical characteristics to optical compensation performance, a haze value increases and characteristics as the optically compensatory sheet result in impairment. In the embodiment, by making a laminate of thermoplastic resin film 12 and polymer layer 14, atmosphere dependency of the optical performance can be reduced without increasing the haze value.

The optically compensatory sheet in the embodiment is a laminate of a thermoplastic resin film containing a prescribed polymer and a polymer layer formed by application, and by this lamination constitution, the optically compensatory sheet shows characteristics such that haze is small and atmosphere dependency of optical characteristics is small. Specifically, the liquid crystal display according to the Embodiment 1-2 may be obtained.

It is preferred for the thermoplastic resin film of the optically compensatory sheet in the embodiment to have the differences of both 10 nm or less in the value of in-plane retardation (Re) and the value of retardation in a thickness direction (Rth) measured at the atmosphere of 25° C. 10% RH and the Re value and Rth value measured at the atmosphere of 25° C. 80% RH, and more preferably from 0 to 5 nm.

In the optically compensatory sheet in the embodiment, the equilibrium moisture content at atmosphere of 25° C. 80% RH is preferably 1.5% or less.

In the optically compensatory sheet in the embodiment, the haze value is preferably 1.5% or less, and more preferably from 0 to 1.0%.

Various materials for use in the manufacture of the optically compensatory sheet in the embodiment and manufacturing methods will be described in detail below.

The optically compensatory sheet in the embodiment is an optically compensatory sheet obtained by lamination of an optically anisotropic layer comprising a polymer layer formed by application and a thermoplastic resin film containing a lactone ring-containing polymer.

### [Optically Anisotropic Layer]

In the invention, it is preferred that the optically anisotropic layer be formed by applying a liquefied polymer on a thermoplastic resin film containing a lactone ring-containing polymer. That is, it is preferred that the optically anisotropic layer include a polymer layer formed by application. More specifically, the polymer layer is formed as a coating layer by liquefying a polymer (including making a solution of a polymer by dissolving a polymer in a solvent), extending, and solidifying the extended layer (hereinafter referred to as “a coating method”). That is, the optically anisotropic layer is a polymer layer formed by application. By forming the optically anisotropic layer according to a coating method, an optically anisotropic layer having sufficient optical characteristics can be obtained even if the thickness of the layer is 0.1 to 20 μm or so. In a stretching film method to reveal optical characteristics by stretching one polymer film, it is difficult to make the thickness of the film 20 μm or less from the point of film strength, in particular it is difficult to give aiming phase difference characteristics in that thickness. In the invention, thinning of a film is possible by forming a polymer layer according to the above method. From the points of thinning of a film and impartation of aiming phase difference characteristics, the thickness of the polymer layer is preferably 15 μm or less, more preferably 12 μm or less, and still more preferably 10 μm or less.

The polymer materials for use in forming a polymer layer are not especially restricted and any materials can be used so long as a film can be formed by a coating method, and optical characteristics sufficient for optical compensation can be revealed without or with stretching treatment. It is preferred to select polymer materials from polymer materials capable of forming a polymer layer having Re(630) in the range of from 0 to 200 nm and Rth(630) in the range of from 0 to 400 by a coating method. It is especially preferred to select polymer materials from heat resisting polymer materials capable of forming a polymer layer having excellent light transmittance of 75% or more, particularly 85% or more. From the aspect of film forming property, it is preferred to use one, or two or more as mixture selected from polyether ketone (in particular, polyaryl ether ketone), polyamide, polyester, polyimide, polyamideimide, and polyester imide. In particular, it is preferred that an optically anisotropic layer includes polyimide, and accordingly optical property stability becomes excellent.

Further, the polymer layer may be a polymer layer formed by making a polymeric liquid crystal composition a prescribed orientation state, and curing the orientation state by polymerization and the like.

As the specific examples of the polyether ketone, in particular the specific examples of polyaryl ether ketone, those disclosed in JP-A-2001-49110 are exemplified. Specifically, polyaryl ether ketone having a repeating unit represented by the following formula (1) is exemplified.

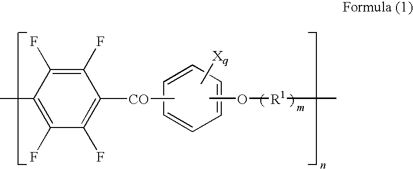

In formula (1), X represents halogen, an alkyl group, or an alkoxy group.

As the halogen represented by X in formula (1), e.g., a fluorine atom, a bromine atom, a chlorine atom and an iodine atom are exemplified, and a fluorine atom is especially preferred of them. As the alkyl group, an alkyl group having from 1 to 6 carbon atoms, e.g., a methyl group, an ethyl group, a propyl group, an isopropyl group, and a butyl group, and a halogen-substituted alkyl group of these alkyl groups are preferred, and a straight chain or branched chain alkyl group having from 1 to 4 carbon atoms, and halogen-substituted alkyl groups of these alkyl groups are especially preferred. More specifically a methyl group, an ethyl group, and a trifluoromethyl group are exemplified.

As the alkoxy group represented by X, an alkoxy group having from 1 to 6 carbon atoms, e.g., a methoxy group, an ethoxy group, a propoxy group, an isopropoxy group, and a butoxy group, and halogen-substituted alkoxy groups of these alkoxy groups are preferred, and a straight chain or branched chain alkoxy group having from 1 to 4 carbon atoms, and a halogen-substituted alkoxy group of these alkoxy groups are especially preferred. More specifically a methoxy group, an ethoxy group, and a trifluoromethoxy group are exemplified.

X especially preferably represents a fluorine atom.

In formula (1), q means a bonding number of X to the benzene ring, and is the number of substitution of the hydrogen atom, exclusive of the bonding position to a p-tetrafluorobenzoylene group and an oxyalkylene group, i.e., an integer of from 0 to 4.

In formula (1), R¹ is a group represented by the following formula (2); m represents 0 or 1; and n represents a degree of polymerization, which is from 2 to 5,000, and preferably from 5 to 500.

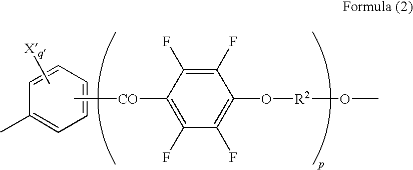

In the group represented by formula (2), X′ represents halogen, an alkyl group or an alkoxy group, and the value of q′ representing a bonding number of X′ to the benzene ring is an integer of from 0 to 4. As the halogen, alkyl group or alkoxy group represented by X′, the same groups as those described in X above can be exemplified.

The preferred examples of X′ include a fluorine atom, a methyl group, an ethyl group, halogenated alkyl groups of these alkyl groups, such as a trifluoromethyl group, a methoxy group, an ethoxy group, and halogenated alkoxy groups of these alkoxy groups, such as a trifluoromethoxy group. A fluorine atom is especially preferred.

In formula (1), X and X′ may be the same as or different from each other. Further, in formulae (1) and (2), two or more X and X′ present in the molecule when q and q′ represent 2 or more may be the same as or different from each other.

R¹ is especially preferably a group represented by the following formula (3).

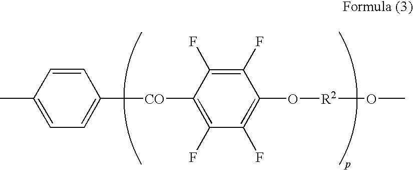

In formulae (2) and (3), R² represents a divalent aromatic group, and p is 0 or 1. The examples of the divalent aromatic groups include an (o-, m- or p-)phenylene group, a naphthalene group, a biphenyl group, an anthracene group, an (o-, m- or p-)terphenyl group, a phenanthrene group, a dibenzofuran group, a biphenyl ether group, a biphenyl sulfone group, and divalent aromatic groups selected from the following group 1. In the divalent aromatic groups, the hydrogen directly bonded to the aromatic ring may be substituted with the above halogen, alkyl group or alkoxy group.

The divalent aromatic group (R²) is represented by any of the following formulae.

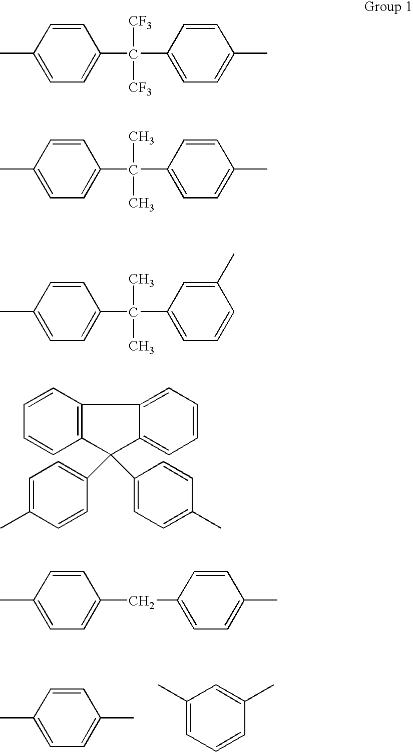

The polyaryl ether ketone represented by formula (1) may comprise the same repeating unit, or may have two or three or more different repeating units. In the latter case, each repeating unit may be present in a block state or may be present randomly.

Of the polyaryl ether ketones represented by formula (1), a polyaryl ether ketone represented by the following formula (4) is preferred.

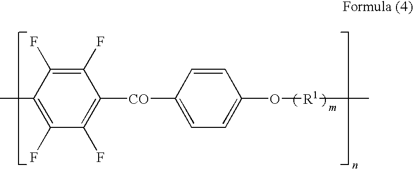

Preferred polyaryl ether ketone in the case of including the molecular terminal groups is represented by the following formula (5) corresponding to formula (1), and the one corresponding to formula (4) is represented by the following formula (6). These are polyaryl ether ketones in which a fluorine atom is bonded to the p-tetrafluorobenzoylene group side in the molecule and a hydrogen atom is bonded to the oxyalkylene group side.

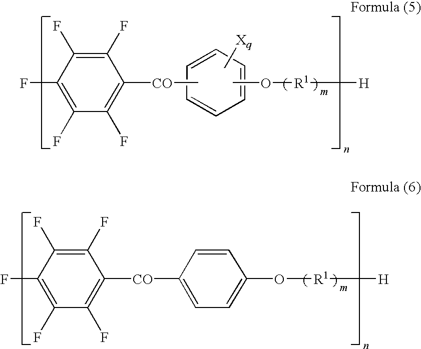

In formulae (4) to (6), formula (1), R¹, X, m, n, and q are the same as formula (1).

On one hand, as the specific examples of the above polyamides or polyesters, e.g., those having a repeating unit represented by the following formula (7) are exemplified.

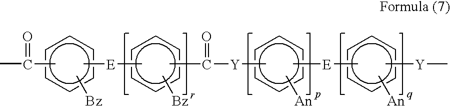

In formula (7), B represents halogen, an alkyl group having from 1 to 3 carbon atoms, a halide of the alkyl group, a phenyl group substituted with one or two or more thereof, or an unsubstituted phenyl group; z represents an integer of from 0 to 3.

E represents a covalent bond, an alkenyl group having 2 carbon atoms, or a halide thereof, a CH₂ group, a C(CX₃)₂ group, a CO group, an O atom, an S atom, an SO₂ group, an Si(R)₂ group, or an NR group.

X in the C(CX₃)₂ group represents a hydrogen atom or halogen, R in the Si(R)₂ group and NR group represents an alkyl group having from 1 to 3 carbon atoms, or a halide thereof. Incidentally, E is on the meta-position or para-position to a carbonyl group or a Y group. The halogen is a fluorine atom, a chlorine atom, an iodine atom or a bromine atom (hereinafter the same in formula (7)).

Y further represents an O atom or an NH group. A represents a hydrogen atom, halogen, an alkyl group having from 1 to 3 carbon atoms or a halide of the alkyl group, a nitro group, a cyano group, a thioalkyl group having from 1 to 3 carbon atoms, an alkoxy group having from 1 to 3 carbon atoms or a halide of the alkoxy group, an aryl group or a halide of the aryl group, an alkyl ester group having from 1 to 9 carbon atoms, an aryl ester group having from 1 to 12 carbon atoms or a substituted derivative thereof, an arylamido group having from 1 to 12 carbon atoms or a substituted derivative thereof.

n is an integer of from 0 to 4; p is an integer of from 0 to 3; q is an integer of from 1 to 3, and r is an integer of from 0 to 3. Preferred polyamide or polyester is polyamide or polyester in which each of the above r and q represents 1, and at least one biphenyl ring thereof is substituted on the 2- and 2′-positions and having a repeating unit represented by the following formula (8).

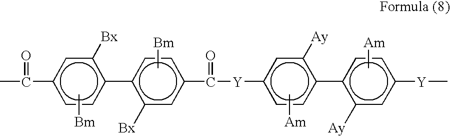

In formula (8), m represents an integer of from 0 to 3, preferably 1 or 2; x and y each represents 0 or 1, provided that they do not represent 0 at the same time. Other symbols are the same as those in formula (7), but E represents a covalent bond of para-orientation to the carbonyl group or Y group.

In formulae (7) and (8), when a plurality of B, E, Y and A are present in the molecule, they may be the same as or different from each other. z, n, m, x and y may also be the same as or different from each other. In that case, B, E, Y, A, z, n, m, x and y are judged independently.

The polyamide or polyester represented by formula (7) may comprise the same repeating unit, or may have two or three or more different repeating units. In the latter case, each repeating unit may be present in a block state or may be present randomly.

On the other hand, as the specific examples of the polyimides, e.g., those containing a condensation polymerization product of 9,9-bis(aminoaryl)fluorene and aromatic tetracarboxylic acid dianhydride and having one or more units of repeating units represented by the following formula (9) are exemplified.

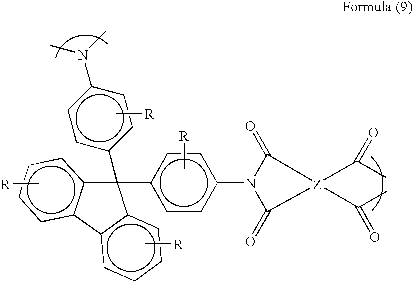

In formula (9), R represents a hydrogen atom, halogen, a phenyl group, a phenyl group substituted with an alkyl group having from 1 to 4 halogens or from 1 to 10 carbon atoms, or an alkyl group having from 1 to 10 carbon atoms. Four R's can be determined independently, and they can be substituted in the range of from 0 to 4. The substituents are preferably those described above, but different substituents may be contained partially. The halogen is a fluorine atom, a chlorine atom, an iodine atom or a bromine atom (hereinafter the same in formula (9)).

Z represents a tri-substituted aromatic group having from 6 to 20 carbon atoms. Z preferably represents a pyromellitic group, polycyclic aromatic group such as a naphthylene group, a fluorenylene group, a benzofluorenylene group, an anthracenylene group, or a substituted derivative of the polycyclic aromatic group, or a group represented by the following formula (10). As the substituents in the substituted derivative of the polycyclic aromatic group, halogen, an alkyl group having from 1 to 10 carbon atoms and a fluorinated product of the alkyl group can be exemplified.

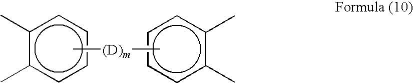

In formula (10), D represents a covalent bond, a C(R²)₂ group, a CO group, an O atom, an S atom, an SO₂ group, an Si(C₂H₅)₂ group, an N(R³)₂ group, or a combination of these groups; m represents an integer of from 1 to 10; each of two R²'s independently represents a hydrogen atom or a C(R⁴)₃ group; each of two R³'s independently represents a hydrogen atom, an alkyl group having from 1 to about 20 carbon atoms, or an aryl group having from about 6 to about 20 carbon atoms; and each of three R⁴'s independently represents a hydrogen atom, a fluorine atom or a chlorine atom.

Besides the polyimides described above, those having a repeating unit represented by the following formula (11) or (12) can also be exemplified. Polyimide having a repeating unit represented by the following formula (13) is especially preferred.

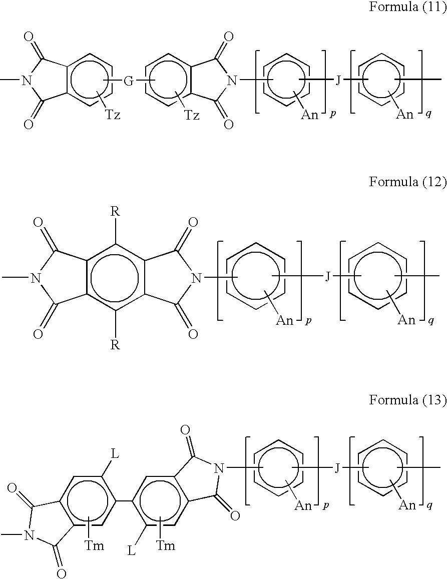

In formulae (11), (12) and (13), T and L each represents halogen, an alkyl group having from 1 to 3 carbon atoms, a halide of the alkyl group, a phenyl group substituted with one or two or more of these groups, or an unsubstituted phenyl group. The halogen is a fluorine atom, a chlorine atom, an iodine atom or a bromine atom (hereinafter the same in formulae (11), (12) and (13)). z represents an integer of from 0 to 3.

G and J each represents a covalent bond or a single bond, a CH₂ group, a C(CX₃)₂ group, a CO group, an O atom, an S atom, an SO₂ group, an Si(C₂H₅)₂ group, or an N(CH₃) group. X₃ in the C(CX₃)₂ group represents a hydrogen atom or halogen.

A represents a hydrogen atom, halogen, an alkyl group or a halide of the alkyl group, a nitro group, a cyano group, a thioalkyl group, an alkoxy group or a halide of the alkoxy group, an aryl group or a halide of the aryl group, an alkyl ester group, or a substituted derivative of the alkyl ester group.

R represents a hydrogen atom, halogen, a phenyl group or a substituted phenyl group such as a halide thereof, or an alkyl group or a substituted alkyl group such as an alkyl halide. m represents an integer of from 0 to 2, n represents an integer of from 0 to 4, p represents an integer of from 0 to 3, and q represents an integer of from 1 to 3.

In formulae (11), (12) and (13), when a plurality of T, A, R and L are independently present in the molecule, they may be the same as or different from each other, z, n and m may also be the same as or different from each other. In that case, T, A, R, L, z, n and m are judged independently.

Polyimides represented by any of formula (9), (11), (12) and (13) may include the same repeating unit, or may have two or three or more different repeating units. The different repeating units may be formed by copolymerization of at least either of acid dianhydride and diamine other than the above. As the diamine, aromatic diamine is especially preferred. In the latter case of having different repeating units, each repeating unit may be present in a block state or may be present randomly.

As the acid dianhydrides for forming different repeating units, e.g., pyromellitic acid dianhydride, 3,6-diphenylpyromellitic acid dianhydride, 3,6-bis(trifluoromethyl)pyromellitic acid dianhydride, 3,6-dibromopyromellitic acid dianhydride, 3,6-dichloropyromellitic acid dianhydride, 3,3′,4,4′-benzophenone-tetracarboxylic acid dianhydride, 2,3,3′,4′-benzophenonetetracarboxylic acid dianhydride, 2,2′,3,3′-benzophenonetetracarboxylic acid dianhydride, 3,3′,4,4′-biphenylcarboxylic acid dianhydride, and bis(2,3-dicarbophenyl)methane dianhydride are exemplified.

Further, bis(2,5,6-trifluoro-3,4-dicarboxyphenyl)methane dianhydride, 2,2-bis(3,4-dicarboxyphenyl)-1,1,1,3,3,3-hexafluoropropane dianhydride, bis(3,4-dicarboxyphenyl)ether dianhydride (4,4′-oxydiphthalic acid anhydride), bis(3,4-dicarboxyphenyl)sulfone dianhydride (3,3′,4,4′-diphenylsulfonetetracarboxylic acid anhydride), and 4,4′-[4,4′-isopropylidene-di(p-phenyleneoxy)]bis(phthalic acid anhydride) can also be exemplified as the examples of the acid dianhydrides.

Further, as the examples of the acid dianhydrides, N,N-(3,4-dicarboxy-phenyl)-N-methylamine dianhydride, bis(3,4-dicarboxyphenyl)diethylsilane dianhydride, naphthalenetetracarboxylic acid dianhydrides, such as 2,3,6,7-naphthalene-tetracarboxylic acid dianhydride, 1,2,5,6-naphthalene-tetracarboxylic acid dianhydride, 2,6-dichloronaphthalene-1,4,5,8-tetracarboxylic acid dianhydride, and heterocyclic aromatic tetracarboxylic acid dianhydrides, such as thiophene-2,3,4,5-tetracarboxylic acid dianhydride, pyrazine-2,3,5,6-tetracarboxylic acid dianhydride, pyridine-2,3,5,6-tetracarboxylic acid dianhydride can also be exemplified.

The examples of preferably used acid dianhydrides include 2,2′-substituted dianhydride, such as 2,2′-dibromo-4,4′,5,5′-biphenyltetracarboxylic acid dianhydride, 2,2′-dichloro-4,4′,5,5′-biphenyltetracarboxylic acid dianhydride, and 2,2′-trihalo-substituted dianhydride, and 2,2-bis(trifluoromethyl)-4,4′,5,5′-biphenyltetracarboxylic acid dianhydride is especially preferred.

On the other hand, as the diamines for forming the different repeating units, e.g., benzenediamine, such as (o-, m- or p-)phenylenediamine, 2,4-diaminotoluene, 1,4-diamino-2-methoxybenzene, 1,4-diamino-2-phenylbenzene, and 1,3-diamino-4-chlorobenzene, 4,4′-diaminobiphenyl, 4,4-diaminodiphenylmethane, 2,2-bis(4-aminophenyl)propane, 2,2-bis(4-aminophenyl)-1,1,1,3,3,3-hexafluoropropane, 4,4′-diaminodiphenyl ether, 3,4′-diaminodiphenyl ether, 1,3-bis(3-aminophenoxy)-benzene, 1,3-bis(4-aminophenoxy)benzene, and 1,4-bis(4-aminophenoxy)benzene are exemplified.

Further, 4,4′-bis(4-aminophenoxy)biphenyl, 4,4′-bis(3-aminophenoxy)-biphenyl, 2,2-bis[4-(4-aminophenoxy)phenyl]propane, 2,2-bis[4-(4-aminophenoxy)-phenyl]-1,1,1,3,3,3-hexafluoropropane, 4,4′-diaminodiphenyl thioether, 4,4′-diamino-diphenylsulfone, 2,2′-diaminobenzophenone, 3,3′-diaminobenzophenone, naphthalenediamine, such as 1,8-diaminonaphthalene, and 1,5-diaminonaphthalene, and heterocyclic aromatic diamines, such as 2,6-diaminopyridine, 2,4-diaminopyridine, and 2,4-diamino-S-triazine can also be exemplified as the examples of the diamines.

Preferably used polyimides are heat resisting and solvent-soluble polyimides manufactured by using aromatic acid dianhydride, such as 2,2′-bis(3,4-dicarboxy-phenyl)-hexafluoropropane dianhydride, 4,4′-bis(3,4-dicarboxyphenyl)-2,2-diphenylpropane dianhydride, naphthalenetetracarboxylic acid dianhydride, and (3,4-dicarboxyphenyl)sulfone dianhydride.

As the diamines, heat resisting and solvent-soluble polyimides manufactured by using aromatic diamines, such as 4,4-(9-fluorenylidene)dianiline, 2,2′-bis-(trifluoromethyl)-4,4′-diaminobiphenyl, 3,3′-dichloro-4,4′-diaminodiphenylmethane, 2,2′-dichloro-4,4′-diaminobiphenyl, 2,2′,5,5′-tetrachlorobenzidine, 2,2-bis(4-aminophenoxyphenyl)propane, 2,2-bis(4-aminophenoxyphenyl)hexafluoropropane, 1,4-bis(4-aminophenoxy)benzene, 1,3-bis(4-aminophenoxy)benzene, and 1,3-bis(3-aminophenoxy)benzene are also preferably used.

On the other hand, the polyamideimides or polyester imides are not especially restricted and proper one or two or more kinds can be used. The polyamideimides disclosed in JP-A-61-162512, and the polyester imides disclosed in JP-A-64-38472 are preferably used.

By introducing a unit in which the face of a ring structure such as a fluorene ring is vertically rising to the main chain, as shown in formula (9), a refractive index in the orthogonal direction to the stretching direction increases when a polymer layer is stretched, and a film large in a refractive index in the width direction can be obtained by vertical uniaxial stretching in a rolled film. By the use of such a film, a polarizing plate having optically compensatory performance can be manufactured by sticking on a polarizing film by roll-to-roll even with a vertically uniaxially stretched film.

Further, by adjusting the proportion of a unit in which the face of a ring structure such as a fluorene ring is vertically rising to the main chain as shown in formula (9) and a unit in which aromatic rings are arrayed in the main chain direction, dispersion of the wavelengths of the polymer layer can be adjusted.

The molecular weight of the polymers for use in forming a polymer layer is not especially restricted, but the polymers soluble in a solvent are preferred. From the points of accuracy of the thickness of a coating film, accuracy of the surface, smoothness of the surface, film strength, prevention of the occurrence of cracks due to extension, contraction, and distortion in making a film, and solubility in a solvent (prevention of gelation), the molecular weight of the polymers as mass average molecular weight is preferably from 10,000 to 1,000,000, more preferably from 20,000 to 500,000, and still more preferably from 50,000 to 200,000. The mass average molecular weight is a value measured by gel permeation chromatography (GPC) with polyethylene oxide as the standard sample and dimethylformamide as the solvent.

In forming a polymer layer, polymers such as the above-described polyaryl ether ketone, polyamide, polyester and polyimide may be used alone, or two or more of the same kinds of polymers may be used as mixture. Further, a mixture of two or more kinds of polymers having different functional groups, such as polyaryl ether ketone and polyamide may also be used.

In forming a polymer layer, one or two or more proper polymers other than those described above may be used in combination. As the examples of the polymers for use in combination, thermoplastic resins such as polyethylene, polypropylene, polystyrene, polymethyl methacrylate, ABS resin, AS resin, polyacetate, polycarbonate, polyamide, polyethylene terephthalate, polybutylene terephthalate, polyphenylene sulfide, polyether sulfone, polyketone, polyimide, polycyclohexane-dimethanol terephthalate, polyallylate, and a liquid crystal polymer (including a photo-polymerizable liquid crystal monomer) are exemplified.

Further, thermosetting resins such as epoxy resins, phenolic resins, and novolak resins are also exemplified as the polymers for use in combination. The use amount of the polymers for use in combination is not especially restricted so long as the amount is in the range that the orientation of the polyether ketone does not conspicuously lower. The amount is generally preferably 50 mass % or less, more preferably 40 mass % or less, and still more preferably 30 mass % or less.

By the use of a plurality of polymers in combination as described above, dynamical mechanical characteristics such as optical anisotropy, wavelength dispersing property, strength, and modulus of elasticity, and physical characteristics such as water permeability, plane property, adhesion to a polymer film, and adhesion to an adhesive can be adjusted to a preferred range.

For the liquefaction of a solid polymer for forming a polymer layer, a method of heating and melting a thermoplastic polymer and a method of dissolving a solid polymer in a solvent to make a solution can be arbitrarily adopted. Accordingly, the solidification of the extended layer can be done by cooling the extended layer in the former melt, and eliminating the solvent from the extended layer and drying in the latter solution. In forming a polymer layer, various additives such as stabilizers, plasticizers, and metals can be blended according to necessity.

Thickness unevenness of a polymer layer causes unevenness of Re(λ) and Rth(λ) of an optically compensatory sheet, so that it is preferred to reduce thickness unevenness. Thickness unevenness of a polymer layer can be reduced by the adjustments of coating means and drying means, and the reduction is also possible by the improvement of smoothness of a support on which a polymer layer is applied. Thickness unevenness can be conspicuously reduced by the addition of a leveling agent to the coating solution of a polymer layer. As the leveling agent, materials having a surface activating property capable of reducing the surface tension of the coating solution of a polymer layer are used.

As such leveling agents, polyethylene glycol type nonionic surfactants, such as nonylphenol ethylene oxide adducts and stearic acid ethylene oxide adducts; polyhydric alcohol type nonionic surfactants, such as sorbitan palmitic acid monoester, sorbitan stearic acid monoester, and sorbitan stearic acid triester; fluorine surfactants, such as perfluoroalkyl ethylene oxide adducts, perfluoroalkyl carboxylate, and perfluoroalkyl betain; and silicone surfactants, such as alkyl-modified silicone oil and polyether-modified silicone oil are exemplified. More specifically, as silicone surfactant, Disparlon LS-009 (manufactured by Kusumoto Chemicals, Ltd.), as fluorine surfactants, Defenser MCF-323, Megafac F-171, F-172, F-177, F-142D, F-144D, and F-140NK (manufactured by Dainippon Ink and Chemicals Inc.), Fluorad FC-430, FC-170, and FC-170C (manufactured by Sumitomo 3M Limited), and as acrylic surfactants, Disparlon L-1980 (manufactured by Kusumoto Chemicals, Ltd.) and Modaflow (Monsanto Japan Limited) are exemplified. In addition, those disclosed in JP-A-9-230143 can also be used.

Since the leveling agents have a surface activating property, they are mostly distributed on the surface of a polymer layer. When a leveling agent is largely present on the surface of a polymer layer formed, the adhering property of the polymer layer to an adhesive, which is used in sticking a polarizing plate on a liquid crystal cell, becomes weak, and the adhesive remains on the liquid crystal cell in rework operation of peeling the polarizing plate from the liquid crystal cell in a case where there is disorder in the liquid crystal cell, and work of wiping off the adhesive with an organic solvent is separately necessary, which worsens operation efficiency. In particular, when a fluorine surfactant is used, there are cases where adhesion to an adhesive weakens. Although a leveling agent is very effective to reduce the thickness unevenness of a polymer layer, it is not necessary for the leveling agent to remain on the surface of the polymer layer after the polymer layer has been formed, and it is rather preferred for the leveling agent to vanish from the surface of the polymer layer. It is preferred that the leveling agent on the surface of the polymer layer be eliminated by saponification treatment carried out at the time of sticking the optically compensatory sheet having the polymer layer on a polarizing film. Alternatively, the leveling agent may be washed out with an organic solvent.

A polymer layer may be formed by applying a polymer material and then drying. Drying can be performed by a natural drying method (air drying), a heating drying method, in particular a heating drying method at 40 to 200° C., and a drying method under reduced pressure, and one or two or more proper methods can be used. For the reduction of thickness unevenness due to drying unevenness in drying, it is preferred that the air of the atmosphere just after application is laminar air flow, and air speed is preferably 1 m/min or less. Further, for the purpose of preventing generation of the thickness unevenness of a applied layer due to the movement of drying air blown just after application, it is preferred to perform condensation drying not blowing drying air.

As the above solvents, halogenated hydrocarbon solvents such as chloroform, dichloromethane, carbon tetrachloride, dichloroethane, tetrachloroethane, trichloroethylene, tetrachloroethylene, chlorobenzene, and orthodichlorobenzene, phenols such as phenol and parachlorophenol, aromatic hydrocarbons such as benzene, toluene, xylene, methoxybenzene, and 1,2-dimethoxybenzene, ketones such as acetone, methyl ethyl ketone, methyl isobutyl ketone, cyclohexanone, cyclopentanone, 2-pyrrolidone, and N-methyl-2-pyrrolidone, and esters such as ethyl acetate and butyl acetate are exemplified.

Further, as the examples of the above solvents, alcohols such as t-butyl alcohol, glycerol, ethylene glycol, triethylene glycol, ethylene glycol monomethyl ether, diethylene glycol dimethyl ether, propylene glycol, dipropylene glycol, and 2-methyl-2,4-pentanedione, amides such as dimethylformamide and dimethyl-acetamidem, nitriles such as acetonitrile and butyronitrile, ethers such as diethyl ether, dibutyl ether, and tetrahydrofuran, in addition, methylene chloride, carbon disulfide, ethyl cellosolve, and butyl cellosolve are also exemplified.

The solvents can be used by one kind alone, or two or more kinds may be mixed in proper combination. From the point of viscosity in coating, the coating solution preferably comprises from 2 to 100 mass parts of a solid polymer dissolved in 100 mass parts of the solvent, more preferably from 5 to 50 mass parts, and especially preferably from 10 to 40 mass parts of a solid polymer.

The solvents having a function of capable of dissolving the materials for forming a polymer layer are of course selected, but it is preferred to select the solvents not corroding a support on which a polymer layer solution is applied.

For extending a liquefied polymer, proper film-forming methods such as casting methods and extrusion methods, e.g., a spin coating method, a roll coating method, a flow coating method, a printing method, a dip coating method, a casting film-forming method, a bar coating method and a gravure printing method can be used. From the point of quantity production of films little in thickness unevenness and orientation distortion unevenness, a solution film-forming method such as a casting method is especially preferably used.

From the aspect of optically compensatory effect, Re(630) of the polymer layer is preferably from 0 to 200 nm, more preferably from 5 to 100 nm, and especially preferably from 10 to 50 nm. Rth(630) of the polymer layer is preferably from 0 to 400 nm, more preferably from 10 to 200 nm, and especially preferably from 20 to 150 nm.

After solidification of the extended layer, for the purpose of controlling Re and the like, if necessary, the polymer layer may be subjected to treatment of orientation of the molecules in the plane. That is, in the state of mere solidification of the extended layer, Re is generally small. Incidentally, when the layer thickness is made 5 μm, Re is generally preferably 15 nm or less, and more preferably from 0.1 to 10 nm.

On the other hand, by the orientation treatment, the accuracy of orientation axis in the plane can be heightened, and Re can be increased. Accordingly, phase difference characteristics such as Rth(λ) and Re(λ) can be controlled.

The orientation treatment of the molecules in the plane as described above can be performed by at least either extension treatment or contraction treatment. The extension treatment can be carried out as stretching treatment. As the stretching treatment, one or two or more proper methods of a biaxial stretching method by a successive system or a simultaneous system, and a uniaxial stretching method such as a free end system or a fixed end system can be used. Uniaxial stretching is preferred from the point of restraining a boring phenomenon.

On one hand, contraction treatment can be performed by a method of forming a polymer layer by applying on a substrate, and acting the contraction force by making use of dimensional change brought about by the temperature change of the substrate. In that case, substrates having contraction property such as a heat contraction film can be used, and it is preferred at that time to control the coefficient of contraction with a stretching machine and the like.

A preferred forming method of a polymer layer is a method of extending a polymer solution obtained by dissolving materials in a solvent and liquefying on the surface of a thermoplastic resin film described later, and drying, and if necessary, performing either or both of extension treatment and contraction treatment through the film. According to the method, the polymer layer can be treated in the state of being supported with the thermoplastic resin film, so that the method is excellent in manufacturing efficiency and treatment accuracy, and continuous manufacture is also possible.

### [A Thermoplastic Resin Film Containing a Lactone Ring-Containing Polymer]

The optically compensatory sheet in the embodiment has a thermoplastic resin film containing a lactone ring-containing polymer. The film may be optical anisotropy or optical isotropy. The thermoplastic resin film containing a lactone ring-containing polymer of the invention will be described in detail below, but the scope of the invention is not restricted by the following description. Those other than the following exemplifications are also practicable by arbitrarily changing without departing from the spirit of the invention.

A Lactone Ring-Containing Polymer

A thermoplastic resin film containing a lactone ring-containing polymer for use in the embodiment has a film width of preferably 1,300 mm or more, and more preferably 1,500 mm or more. The thickness of the film is preferably from 20 to 100 μm, and more preferably from 20 to 65 μm. The thermoplastic resin film containing a lactone ring-containing polymer for use in the invention contains a lactone ring-containing polymer as the main component. The thermoplastic resin film may contain other thermoplastic resins.

The lactone ring-containing polymer preferably has a lactone ring structure represented by the following formula (20).

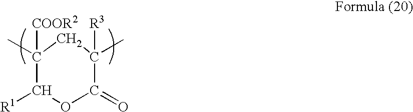

In the formula, R¹, R² and R³ each independently represents a hydrogen atom or an organic residue having from 1 to 20 carbon atoms, and the organic residue may contain an oxygen atom.

The organic residue is preferably from 1 to 15 carbon atoms, more preferably from 1 to 12 carbon atoms, further preferably from 1 to 8 carbon atoms, and more preferably from 1 to 5 carbon atoms. The organic residue includes a substituted or unsubstituted alkyl group, a substituted or unsubstituted aryl group, a substituted or unsubstituted alkoxy group and the like. The alkyl groups (a methyl group, an ethyl group, an isopropyl group, an n-butyl group, a t-butyl group and the like) are preferred. The substituent includes an alkyl group, an aryl group, an alkoxy group and the like. R¹, R² and R³ are more preferably a hydrogen atom, a methyl group, an ethyl group, and a propyl group, further preferably a hydrogen atom, a methyl group, and an ethyl group, and still more preferably a hydrogen atom, and a methyl group.

The proportion of content of the lactone ring structure represented by formula (20) in the structure of the lactone ring-containing polymer is preferably from 5 to 90 mass %, more preferably from 10 to 70 mass %, still more preferably from 10 to 60 mass %, and especially preferably from 10 to 50 mass %. By containing the lactone ring structure in the proportion of 5 mass % or more, heat resistance, solvent resistance and surface hardness of the polymer obtained are liable to increase, and by containing the lactone ring structure in the proportion of 90 mass % or less, forming processability of the obtained polymer is liable to improve.

The lactone ring-containing polymer may have structures other than the lactone ring structure represented by formula (20). As the structures other than the lactone ring structure represented by formula (20), for example, polymeric structural units (repeating structural units) formed by polymerization of at least one monomer selected from the group consisting of (meth)acrylic acid ester, a hydroxyl group-containing monomer, unsaturated carboxylic acid, and a monomer represented by the following formula (21) as described later as the manufacturing method of the lactone ring-containing polymer are preferred.

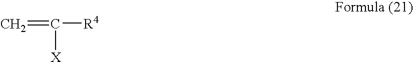

In formula (21), R⁴ represents a hydrogen atom or a methyl group; X represents a hydrogen atom, an alkyl group having from 1 to 20 carbon atoms, an aryl group, an —OAc group, a —CN group, a —CO—R⁵ group, or a —CO—O—R⁶ group; Ac represents an acetyl group; and R⁵ and R⁶ each represents a hydrogen atom or an organic residue having from 1 to 20 carbon atoms.

The organic residue having from 1 to 20 carbon atoms may be referred to as the description of the organic resesude in the formula (20).

X preferably represents an alkyl group or an aryl group (a methyl group, an ethyl group, a propyl group, an isopropyl group, an n-butyl group, an isobutyl group, a t-butyl group, a cyclohexyl group, or a benzyl group).

The proportion of the content of the structure other than the lactone ring structure represented by formula (20) in the structure of the lactone ring-containing polymer is, in the case of a polymeric structural unit (a repeating structural unit) formed by polymerization of (meth)acrylic acid ester, preferably from 10 to 95 mass %, more preferably from 10 to 90 mass %, still more preferably from 40 to 90 mass %, and especially preferably from 50 to 90 mass %, and in the case of a polymeric structural unit (a repeating structural unit) formed by polymerization of a hydroxyl group-containing monomer, the proportion of the content is preferably from 0 to 30 mass %, more preferably from 0 to 20 mass %, still more preferably from 0 to 15 mass %, and especially preferably from 0 to 10 mass %. Further, in the case of a polymeric structural unit (a repeating structural unit) formed by polymerization of unsaturated carboxylic acid, the content is preferably from 0 to 30 mass %, more preferably from 0 to 20 mass %, still more preferably from 0 to 15 mass %, and especially preferably from 0 to 10 mass %. Further, in the case of a polymeric structural unit (a repeating structural unit) formed by polymerization of a monomer represented by formula (21), the content is preferably from 0 to 30 mass %, more preferably from 0 to 20 mass %, still more preferably from 0 to 15 mass %, and especially preferably from 0 to 10 mass %.

The manufacturing methods of the lactone ring-containing polymer are not especially restricted. For example, the lactone ring-containing polymer can be obtained by forming polymer (a) having a hydroxyl group and an ester group in the molecular chain according to a polymerization process, and subjecting the obtained polymer (a) to heating treatment to introduce a cyclic structure to the polymer by a lactone cyclization condensation process.

In the polymerization process, the polymer having a hydroxyl group and an ester group in the molecular chain can be obtained by, for example, performing polymerization reaction of monomer components blended with a monomer represented by the following formula (22).

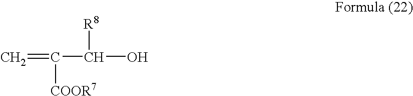

In formula (22), R⁷ and R⁸ each represents a hydrogen atom or an organic residue having from 1 to 20 carbon atoms.

The organic residue having from 1 to 20 carbon atoms may be referred to as the description of the organic resesude in the formula (20).

As the monomer represented by formula (22), e.g., methyl 2-(hydroxymethyl)acrylate, ethyl 2-(hydroxymethyl)acrylate, isopropyl 2-(hydroxymethyl)acrylate, n-butyl 2-(hydroxymethyl)acrylate, and tert-butyl 2-(hydroxymethyl)acrylate are exemplified. Of these monomers, methyl 2-(hydroxy-methyl)acrylate and ethyl 2-(hydroxymethyl)acrylate are preferred, and methyl 2-(hydroxymethyl)acrylate is especially preferred for capable of improving heat resistance effectually. These monomers may be used by one kind alone, or two or more monomers may be used in combination.

The proportion of the content of the monomer represented by formula (22) in the monomer components for use in the polymerization process is preferably from 5 to 90 mass %, more preferably from 10 to 70 mass %, still more preferably from 10 to 60 mass %, and especially preferably from 10 to 50 mass %. When the proportion of the content of the monomer represented by formula (22) is 5 mass % or more, heat resistance, solvent resistance and surface hardness of the obtained polymer are liable to better, while when proportion of the content of the monomer represented by formula (22) is 90 mass % or less, gelation occurs in the polymerization process and the lactone cyclization condensation process, and the processability of the obtained polymer is liable to improve.

Monomers other than the monomer represented by formula (22) may be blended with the monomer components for use in the polymerization process. Such monomers are not especially restricted and, for example, (meth)acrylic acid ester, a hydroxyl group-containing monomer, unsaturated carboxylic acid, and a monomer represented by the following formula (21) are exemplified. These monomers may be used by one kind alone, or two or more monomers may be used in combination.

The (meth)acrylic acid esters are not especially restricted so long as they are (meth)acrylic acid esters other than the monomer represented by formula (22), for example, acrylic acid esters, e.g., methyl acrylate, ethyl acrylate, n-butyl acrylate, isobutyl acrylate, tert-butyl acrylate, cyclohexyl acrylate, and benzyl acrylate; methacrylic acid esters, e.g., methyl methacrylate, ethyl methacrylate, propyl methacrylate, n-butyl methacrylate, isobutyl methacrylate, tert-butyl methacrylate, cyclohexyl methacrylate, and benzyl methacrylate are exemplified. These (meth)acrylic acid esters may be used by one kind alone, or two or more kinds may be used in combination. Of these (meth)acrylic acid esters, methyl methacrylate is especially preferred for being excellent in heat resistance and transparency of the obtained polymers.

When the (meth)acrylic acid esters other than the monomer represented by formula (22) are used, the proportion of their content in the monomer components for use in the polymerization process is preferably from 10 to 95 mass %, more preferably from 10 to 90 mass %, still more preferably from 40 to 90 mass %, and especially preferably from 50 to 90 mass %.

The hydroxyl group-containing monomers are not especially restricted so long as they are hydroxyl group-containing monomers other than the monomer represented by formula (22), for example, 2-(hydroxyalkyl)acrylate, e.g., α-hydroxymethylstyrene, α-hydroxyethylstyrene, and methyl 2-(hydroxyethyl)acrylate; and 2-(hydroxyalkyl)-acrylic acid, e.g., 2-(hydroxyethyl)acrylic acid are exemplified. These hydroxyl group-containing monomers may be used by one kind alone, or two or more kinds may be used in combination.

When hydroxyl group-containing monomers other than the monomer represented by formula (22) are used, the proportion of their content in the monomer components for use in the polymerization process is preferably from 0 to 30 mass %, more preferably from 0 to 20 mass %, still more preferably from 0 to 15 mass %, and especially preferably from 0 to 10 mass %.

As the unsaturated carboxylic acids, e.g., acrylic acid, methacrylic acid, crotonic acid, α-substituted acrylic acid, and α-substituted methacrylic acid are exemplified. These unsaturated carboxylic acids may be used by one kind alone, or two or more kinds may be used in combination. Of these unsaturated carboxylic acids, acrylic acid and methacrylic acid are especially preferred.

When the unsaturated carboxylic acids are used, the proportion of their content in the monomer components for use in the polymerization process is preferably from 0 to 30 mass %, more preferably from 0 to 20 mass %, still more preferably from 0 to 15 mass %, and especially preferably from 0 to 10 mass %.

As the monomers represented by formula (21), e.g., styrene, α-methylstyrene, vinyltoluene, acrylonitrile, methyl vinyl ketone, ethylene, propylene, and vinyl acetate are exemplified. These monomers may be used by one kind alone, or two or more kinds may be used in combination. Of these monomers, styrene and α-methylstyrene are especially preferred.

When the monomers represented by formula (21) are used, the proportion of their content in the monomer components for use in the polymerization process is preferably from 0 to 30 mass %, more preferably from 0 to 20 mass %, still more preferably from 0 to 15 mass %, and especially preferably from 0 to 10 mass %.

As the type of polymerization process for obtaining the polymer having a hydroxyl group and an ester group in the molecular chain by polymerization of monomer components, a type of polymerization using solvents is preferred, and solution polymerization is especially preferred.

Polymerization temperature and polymerization time vary in accordance with the kinds and proportions of the monomers to be used. For example, polymerization temperature is preferably from 0 to 150° C. and polymerization time is from 0.5 to 20 hours, and more preferably polymerization temperature is from 80 to 140° C. and polymerization time is from 1 to 10 hours.

In the case of polymerization using solvents, the polymerization solvents are not especially restricted and, for example, aromatic hydrocarbon-based solvents, e.g., toluene, xylene and ethyl benzene; ketone-based solvents, e.g., methyl ethyl ketone and methyl isobutyl ketone; ether-based solvents, e.g., tetrahydrofuran are exemplified. These solvents may be used by one kind alone, or two or more solvents may be used in combination. When the boiling point of the solvent is too high, the residual volatile content of finally obtained lactone ring-containing polymer becomes high, so that solvents having the boiling point of from 50 to 200° C. are preferred.

A polymerization initiator may be added at the time of polymerization reaction, if necessary. The polymerization initiator is not especially restricted and, for example, organic peroxides, e.g., cumene hydroperoxide, diisopropylbenzene hydroperoxide, di-tert-butyl peroxide, lauroyl peroxide, benzoyl peroxide, tert-butyl peroxyisopropyl carbonate, and tert-amylperoxy-2-ethyl hexanoate; and azo compounds, e.g., 2,2′-azobis(isobutyronitrile), 1,1′-azobis(cyclohexanecarbonitrile), and 2,2′-azobis(2,4-dimethylvaleronitrile) are exemplified. These polymerization initiators may be used by one kind alone, or two or more polymerization initiators may be used in combination. The use amount of the polymerization initiator may be arbitrarily decided according to the combination of polymers and reaction condition and is not especially restricted.

In performing polymerization reaction, it is preferred to control the concentration of the formed polymer in the polymerization reaction mixture to 50 mass % or less so as to restrain gelation of the reaction solution. Specifically, when the concentration of the formed polymer in the polymerization reaction mixture exceeds 50 mass %, it is preferred to control the concentration to lower to 50 mass % or less by properly adding a polymerization solvent to the polymerization reaction mixture. The concentration of the formed polymer in the polymerization reaction mixture is more preferably 45 mass % or less, and still more preferably 40 mass % or less. When the concentration of the formed polymer in the polymerization reaction mixture is too low, there are cases where productivity lowers, so that the concentration of the formed polymer in the polymerization reaction mixture is preferably 10 mass % or more, and more preferably 20 mass % or more.

A method of arbitrarily adding a polymerization solvent to the polymerization reaction mixture is not especially restricted. For example, a polymerization solvent may be added continuously or may be added intermittently. By controlling the concentration of the formed polymer in the polymerization reaction mixture in this manner, gelation of the reaction solution can be restrained more sufficiently. In particular, even when the proportions of the hydroxyl groups and ester groups in the molecular chains are increased by raising the proportion of the lactone ring content to improve heat resistance, the gelation can be sufficiently restrained. The polymerization solvent to be added may be the same kind as the solvent used at initial time of the polymerization reaction or may be different kind, but it is preferred to use the same kind of solvent as the solvent used at initial time of the polymerization reaction. Further, the polymerization solvent to be added may be a single solvent of one kind alone or may be a mixed solvent of two or more kinds.

A solvent is generally contained besides the obtained polymer in the mixture of polymerization reaction obtained at termination of the polymerization process, but it is not necessary to completely remove the solvent to take out the polymer in a solid state, and it is preferred that the polymer is introduced to enter the succeeding lactone cyclization condensation process in a state of containing the solvent. Alternatively, if necessary, after taking out the polymer in a solid state, a proper solvent may be added again in the succeeding lactone cyclization condensation process.

The polymer obtained in the polymerization process is polymer (a) containing a hydroxyl group and an ester group in the molecular chain. The mass average molecular weight of polymer (a) is preferably from 1,000 to 2,000,000, more preferably from 5,000 to 1,000,000, still more preferably from 10,000 to 500,000, and especially preferably from 50,000 to 500,000. Polymer (a) obtained in the polymerization process is then subjected to heating treatment in the succeeding lactone cyclization condensation process, by which a lactone ring structure is introduced into the polymer to obtain a lactone ring-containing polymer.

The reaction for introducing a lactone ring structure into polymer (a) is reaction to generate a lactone ring structure by cyclization condensation of a hydroxyl group and an ester group present in the molecular chain of polymer (a) by heating, and alcohol is by-produced by the cyclization condensation. By forming a lactone ring structure in the molecular chain (in the main skeleton of the polymer), high heat resistance is given. When the reaction rate of the cyclization condensation reaction to introduce a lactone ring structure is insufficient, there are cases where sufficient heat resistance cannot be obtained, or condensation reaction occurs in the middle of formation of a lactone ring-containing polymer by heating treatment at the time of formation and generated alcohol forms bubbles or silver streaks in a formed product.

A lactone ring-containing polymer obtained in the lactone cyclization condensation process preferably has a lactone ring structure represented by the formula (20).

The method of heating treatment of polymer (a) is not especially restricted and conventionally known methods can be arbitrarily used. For example, polymerization reaction mixture containing a solvent obtained by polymerization process may be subjected to heating treatment as it is, or may be subjected to heating treatment by using a ring closing catalyst in the presence of a solvent, if necessary. Alternatively, heating treatment can be carried out with a furnace or a reactor equipped with a vacuum device for eliminating a volatile content or a volatilizer, or with an extruder equipped with a volatilizer.

In performing the cyclization condensation reaction, in addition to polymer (a), other thermoplastic resins may be coexistent. Further, in the cyclization condensation reaction, if necessary, as a catalyst of the cyclization condensation reaction, a generally used esterification catalyst such as p-toluenesulfonic acid, or an ester exchange catalyst may be used. Further, organic carboxylic acid, such as acetic acid, propionic acid, benzoic acid, acrylic acid, or methacrylic acid may be used as a catalyst. Further, the basic compounds, organic carboxylic acids and carbonates may be used as disclosed in JP-A-61-254608 and JP-A-61-261303.

An organic phosphorus compound may be used as the catalyst in the cyclization condensation reaction as described in JP-A-2001-151814. By using an organic phosphorus compound as the catalyst, not only the reaction rate of the cyclization condensation reaction can be improved and, but also coloration of the lactone ring-containing polymer to be obtained can be widely reduced. Further, by using an organic phosphorus compound as the catalyst, reduction of molecular weight that may occur when a volatilizing process described later is used in combination can be restrained, so that excellent mechanical strength can be given.

The organic phosphorus compounds that can be used as the catalysts in the cyclization condensation reaction include, for example, alkyl(aryl)phosphonous acids, such as methylphosphonous acid, ethylphosphonous acid, and phenylphosphonous acid (however, these may be alkyl(aryl)phosphinic acids of tautomers), and monoesters or diesters of the alkyl(aryl)phosphonous acids; dialkyl(aryl)phosphinic acids, such as dimethylphosphinic acid, diethylphosphinic acid, diphenylphosphinic acid, phenylmethylphosphinic acid, phenylethylphospinic acid, and esters of the dialkyl(aryl)phosphinic acids; alkyl(aryl)phosphonic acids, such as methylphosphonic acid, ethylphosphonic acid, trifluoromethylphosphonic acid, phenylphosphonic acid, and monoesters and diesters of the alkyl(aryl)phosphonic acids; alkyl(aryl)-phosphinous acids, such as methylphosphinous acid, ethylphosphinous acid, phenylphosphinous acid, and esters of the alkyl(aryl)phosphinous acids; phosphorous acid monoester, diester and triester, such as methyl phosphite, ethyl phosphite, phenyl phosphite, dimethyl phosphite, diethyl phosphite, diphenyl phosphite, trimethyl phosphite, triethyl phosphite, and triphenyl phosphite; phosphoric acid monoesters, diesters, triesters, such as methyl phosphate, ethyl phosphate, 2-ethylhexyl phosphate, octyl phosphate, isodecyl phosphate, lauryl phosphate, stearyl phosphate, isostearyl phosphate, phenyl phosphate, dimethyl phosphate, diethyl phosphate, di-2-ethylhexyl phosphate, diisodecyl phosphate, dilauryl phosphate, distearyl phosphate, diisostearyl phosphate, diphenyl phosphate, trimethyl phosphate, triethyl phosphate, triisodecyl phosphate, trilauryl phosphate, tristearyl phosphate, triisostearyl phosphate, and triphenyl phosphate; mono-, di- and tri-alkyl(aryl)phosphine, such as methylphosphine, ethylphosphine, phenylphosphine, dimethylphosphine, diethylphosphine, diphenylphosphine, trimethylphosphine, triethylphosphine, and triphenylphosphine; alkyl(aryl)halogen-phosphine, such as methyldichlorophosphine, ethyldichloro-phosphine, phenyldichlorophosphine, dimethylchlorophosphine, diethylchloro-phosphine, and diphenylchlorophosphine; mono-, di- and tri-alkyl(aryl)phosphine oxide, such as methylphosphine oxide, ethylphosphine oxide, phenylphosphine oxide, dimethylphosphine oxide, diethylphosphine oxide, diphenylphosphine oxide, trimethylphosphine oxide, triethylphosphine oxide, and triphenylphosphine oxide; and halogenated tetraalkyl(aryl)phosphonium, such as tetramethylphosphonium chloride, tetraethylphosphonium chloride, and tetraphenylphosphonium chloride. These organic phosphorus compounds may be used by one kind alone, or two or more compounds may be used in combination. Of these organic phosphorus compounds, alkyl(aryl)phosphonous acids, phosphorous acid monoester, diester, phosphoric acid monoesters, diesters, and alkyl(aryl)phosphonic acids are preferred for being high in catalytic activity and low in coloration; alkyl(aryl)phosphonous acids, phosphorous acid monoester, diester, and phosphoric acid monoesters, diesters are more preferred; and alkyl(aryl)phosphonous acids and phosphoric acid monoesters, diesters are especially preferred.

The amount of the catalyst used in the cyclization condensation reaction is not especially restricted, but the amount is, for example, preferably from 0.001 to 5 mass % based on the amount of polymer (a), more preferably from 0.01 to 2.5 mass %, still more preferably from 0.01 to 1 mass %, and especially preferably from 0.05 to 0.5 mass %. By using the catalyst in an amount of 0.001 mass % or more, the reaction rate of the cyclization condensation reaction tends to better, and when the use amount is 5 mass % or less, a polymer to be obtained is liable to be difficultly colored, and difficulty in melting of the polymer by crosslinking is restrained.

The time of addition of the catalyst is not especially restricted and, for example, the catalyst may be added at initial time of the reaction, or may be added in the middle of the reaction, or may be added at both of these times.

It is preferred to perform the cyclization condensation reaction in the presence of a solvent and use a volatilizing process in combination with the cyclization condensation reaction. In this case, an embodiment of using the volatilizing process in combination throughout the cyclization condensation reaction, and an embodiment of using the volatilizing process in combination only in a part of the process not using throughout the cyclization condensation reaction are exemplified. In the method of using the volatilizing process together, alcohol by-produced in the cyclization condensation reaction is forcedly removed by volatilization, so that the equilibrium of the reaction is advantageous to the formation.

The volatilizing process means a process of elimination treatment of the volatile contents such as a solvent and a remaining monomer and an alcohol by-produced in the cyclization condensation reaction for introducing a lactone structure, under reduced pressure and heating condition according to necessity. When the elimination treatment is insufficient, the residual volatile content abounds in an obtained polymer, and there are cases where the polymer is colored by the decomposition at the time of forming and forming defects such as bubbles or silver streaks occur.

In the case of the embodiment of using the volatilizing process in combination throughout the cyclization condensation reaction, the apparatus to be used are not especially restricted, but it is preferred to use a volatilizer comprising a heat exchanger and volatilizing tank, an extruder equipped with a vent, and an apparatus comprising a volatilizer and an extruder arrayed in-line, and it is more preferred to use a volatilizer comprising a heat exchanger and volatilizing tank or an extruder equipped with a vent.

The temperature of the reaction process in the case of using a volatilizer comprising a heat exchanger and volatilizing tank is preferably from 150 to 350° C., and more preferably from 200 to 300° C. When the temperature of the reaction process is 150° C. or higher, the cyclization condensation reaction is sufficient and residual volatile content tends to decrease, and when the temperature is 350° C. or lower, the coloration and decomposition of an obtained polymer is liable to be difficult to occur.

The pressure in reaction process in the case of using a volatilizer comprising a heat exchanger and volatilizing tank is preferably from 931 to 1.33 hPa (from 700 to 1 mmHg), and more preferably from 798 to 66.5 hPa (from 600 to 50 mmHg). When the pressure in reaction process is 931 hPa (700 mmHg) or less, the volatile content including an alcohol is difficult to remain. On the contrary, when the pressure in the reaction process is 1.33 hPa (1 mmHg) or more, industrial execution tends to be easy.

When an extruder equipped with a vent is used, the vent may be one or two or more, but it is preferred to use an extruder having a plurality of vents.

The temperature of the reaction process in the case of using an extruder equipped with a vent is preferably from 150 to 350° C., and more preferably from 200 to 300° C. When the temperature of the reaction process is 150° C. or higher, the cyclization condensation reaction easily sufficiently advances and residual volatile content tends to decrease. On the contrary, when the temperature is 350° C. or lower, coloration and decomposition of a polymer obtained are liable to be difficult to occur.

The pressure in the reaction process in the case of using an extruder equipped with a vent is preferably from 931 to 1.33 hPa (from 700 to 1 mmHg), and more preferably from 798 to 13.3 hPa (from 600 to 10 mmHg). When the pressure in the reaction process is 931 hPa (700 mmHg) or less, the volatile content including an alcohol is difficult to remain, and when the pressure in the reaction process is 1.33 hPa (1 mmHg) or more, industrial execution tends to be easy.

Incidentally, in the case of using the volatilizing process in combination throughout the cyclization condensation reaction, the physical properties of a lactone ring-containing polymer to be obtained sometimes deteriorate under severe heating treatment conditions, as described later, so that it is preferred to perform heating treatment on moderate conditions as far as possible by using a catalyst for dealcoholation reaction with an extruder equipped with a vent.

Further, in the case of the embodiment of performing the volatilizing process in combination throughout the cyclization condensation reaction, polymer (a) obtained in the polymerization process is preferably introduced to a cyclization condensation reaction apparatus with a solvent, and in this case, if necessary, the reaction system may be passed again through the cyclization condensation reaction apparatus such as an extruder equipped with a vent.

An embodiment of using the volatilizing process in combination only in a part of the process not using in combination throughout the cyclization condensation reaction may be taken. For example, this is an embodiment of further heating the apparatus used for manufacturing polymer (a) and advancing the cyclization condensation reaction to a certain degree, if necessary, using the volatilizing process partly in combination, and successively performing the cyclization condensation reaction using the volatilizing process in combination at the same time to complete the reaction.

In the embodiment of using the volatilizing process in combination throughout the cyclization condensation reaction as described above, for example, when polymer (a) is subjected to heating treatment at about 250° C. or higher with a biaxial extruder, there are cases where decomposition and the like are partly caused by the difference in heat history before the cyclization condensation reaction occurs, and physical properties of a lactone ring-containing polymer to be obtained are deteriorated. Accordingly, when the cyclization condensation reaction has been advanced to a certain degree beforehand prior to the cyclization condensation reaction using in combination of volatilizing process at the same time, the latter half reaction condition can be relieved and the deterioration of the physical properties of a lactone ring-containing polymer to be obtained can be preferably restrained. As an especially preferred embodiment, for example, an embodiment of initiating the volatilizing process by staggering the time from the initiation of the cyclization condensation reaction is exemplified, that is, this is an embodiment of subjecting a hydroxyl group and an ester group present in the molecular chain of polymer (a) obtained by the polymerization process to the cyclization condensation reaction in advance to raise the reaction rate of the cyclization condensation reaction to a certain degree, and successively performing the cyclization condensation reaction using the volatilizing process in combination at the same time. Specifically, as a preferred embodiment, for example, an embodiment of advancing the cyclization condensation reaction to a certain degree of reaction rate by using a kiln type reactor in the presence of a solvent, and then completing the cyclization condensation reaction with a reactor equipped with a volatilizer, such as a volatilizer comprising a heat exchanger and volatilizing tank, or an extruder equipped with a vent is exemplified. In particular, in the case of the embodiment, it is more preferred that a catalyst for cyclization condensation reaction is present.

As described above, the method of subjecting a hydroxyl group and an ester group present in the molecular chain of polymer (a) obtained by the polymerization process to the cyclization condensation reaction in advance to raise the reaction rate of the cyclization condensation reaction to a certain degree, and successively performing the cyclization condensation reaction using the volatilizing process in combination at the same time is a preferred embodiment for obtaining a lactone ring-containing polymer in the invention. According to the embodiment, a lactone ring-containing polymer higher in glass transition temperature and reaction rate of the cyclization condensation reaction, and excellent in heat resistance can be obtained. In this case, as the standard of the cyclization condensation reaction rate, for example, mass reduction rate in the range of from 150 to 300° C. in dynamic TG measurement shown in the Example below is preferably 2% or less, more preferably 1.5% or less, and still more preferably 1% or less.

A reactor that can be used in the cyclization condensation reaction performed in advance prior to the cyclization condensation reaction using the volatilizing process in combination at the same time is not especially restricted, and, e.g., an autoclave, a kiln type reactor, and a volatilizer comprising a heat exchanger and volatilizing tank are exemplified, and it is also possible to use an extruder equipped with a vent suitable for the cyclization condensation reaction using a volatilizing process in combination at the same time. Of these reactors, an autoclave and a kiln type reactor are especially preferred. However, even when a reactor such as an extruder equipped with a vent is used, the cyclization condensation reaction can be carried out in the similar state as the reaction with an autoclave or a kiln type reactor by relaxing the condition of venting, omitting venting, or adjusting temperature condition, condition of barrel, the shape of screw, and screw driving condition.

In the cyclization condensation reaction performed in advance prior to the cyclization condensation reaction using the volatilizing process in combination, (i) a method of adding a catalyst to the mixture containing polymer (a) obtained by a polymerization process and a solvent, and subjecting the mixture to heating and reaction, (ii) a method of subjecting the mixture to heating and reaction not using a catalyst, and a method of performing (i) or (ii) under application of pressure are exemplified.

“The mixture containing polymer (a) and a solvent” introduced into the cyclization condensation reaction in the lactone ring cyclization condensation process means a polymerization reaction mixture itself obtained in the polymerization process, or a mixture obtained by once removing the solvent and then again adding a solvent suited for the cyclization condensation reaction.

A solvent that can be added again in the cyclization condensation reaction performed in advance prior to the cyclization condensation reaction using the volatilizing process in combination is not especially restricted, and, e.g., aromatic hydrocarbons, such as toluene, xylene, and ethylbenzene; ketones, such as methyl ethyl ketone and methyl isobutyl ketone; chloroform, dimethyl sulfoxide, and tetrahydrofuran are exemplified. These solvents may be used by one kind alone or two or more kinds may be used in combination. It is preferred to use the same solvents as used in the polymerization process.

As the catalysts added in method (i), for example, a generally used esterification catalyst such as p-toluenesulfonic acid, or an ester exchange catalyst, basic compounds, organic carboxylates, carbonates and the like are exemplified, but it is preferred in the invention to use the above organic phosphorus compounds. The addition time of the catalysts is not especially restricted, and they can be added at initial time of the reaction, or may be added in the middle of the reaction, or may be added both times. The addition amount of the catalysts is not especially restricted and, for example, the catalysts are added in proportion of preferably from 0.001 to 5 mass % to the mass of polymer (a), more preferably from 0.01 to 2.5 mass %, still more preferably from 0.01 to 0.1 mass %, and especially preferably from 0.05 to 0.5 mass %. The heating temperature and heating time of method (i) are not especially limited and, for example, the heating temperature is preferably from room temperature to 180° C., more preferably from 50 to 150° C., and heating time is preferably from 1 to 20 hours, and more preferably from 2 to 10 hours. By making the heating temperature higher than room temperature, or heating time 1 hour or more, the rate of cyclization condensation reaction is liable to be improved. On the contrary, by making heating temperature 180° C. or lower, or heating time 20 hours or less, the coloration and decomposition of the resin are difficult to occur.

Method (ii) will suffice for the polymerization reaction mixture obtained by polymerization process to be heated as it is with a pressure tight kiln type reactor. The heating temperature and heating time of method (ii) are not especially restricted and, for example, the heating temperature is preferably from 100 to 180° C., more preferably from 100 to 150° C., and the heating time is preferably from 1 to 20 hours, and more preferably from 2 to 10 hours. By making the heating temperature higher than 100° C., or heating time 1 hour or more, the rate of cyclization condensation reaction is liable to rise. On the contrary, by making heating temperature 180° C. or lower, or heating time 20 hours or less, the coloration and decomposition of the resin are difficult to occur.

In any methods, reaction may be performed under pressure according to conditions.

In the cyclization condensation reaction performed in advance prior to the cyclization condensation reaction using the volatilizing process in combination at the same time, it is out of the question that a part of solvents naturally volatilizes during reaction.

At the termination of the cyclization condensation reaction performed in advance prior to the cyclization condensation reaction using the volatilizing process in combination at the same time, that is, just before beginning of the volatilizing process, mass reduction rate in the range of from 150 to 300° C. in dynamic TG measurement is preferably 2% or less, more preferably 1.5% or less, and still more preferably 1% or less. By making the mass reduction rate 2% or less, subsequently the rate of cyclization condensation reaction is liable to rise and the physical properties of the lactone ring-containing polymer obtained tend to increase, when being subjected to the cyclization condensation reaction using the volatilizing process in combination at the same time. Further, in performing the cyclization condensation reaction, in addition to polymer (a), other thermoplastic resins may exist together.

In the embodiment in which a hydroxyl group and an ester group in the molecular chain present in polymer (a) obtained by the polymerization process are in advance subjected to cyclization condensation reaction to increase the rate of the cyclization condensation reaction to a certain degree beforehand, and successively performing the cyclization condensation reaction using the volatilizing process in combination at the same time, a polymer obtained in previously performed cyclization condensation reaction (a polymer in which at least a part of the hydroxyl group and the ester group present in the molecular chain is cyclization condensation reacted) and a solvent may be introduced as they are into the cyclization condensation reaction using the volatilizing process in combination at the same time, or if necessary, the polymer (the polymer in which at least a part of the hydroxyl group and the ester group present in the molecular chain is cyclization condensation reacted) may be introduced into the cyclization condensation reaction using the volatilizing process in combination at the same time after being subjected to other treatment such that the polymer is isolated and then a solvent is added again.

The volatilizing process is not always concluded at the same time with the cyclization condensation reaction, and it may be terminated after an interval from the end of the cyclization condensation reaction.

The mass average molecular weight of the lactone ring-containing polymer is preferably from 1,000 to 2,000,000, more preferably from 5,000 to 1,000,000, still more preferably from 10,000 to 500,000, and especially preferably from 50,000 to 500,000.

The mass reduction rate in the range of from 150 to 300° C. in dynamic TG measurement of the lactone ring-containing polymer is preferably 1% or less, more preferably 0.5% or less, and still more preferably 0.3% or less.

Since the lactone ring-containing polymer is high in the cyclization condensation reaction rate, defects such as generation of bubbles or silver streaks in a formed product can be avoided. Further, since the lactone ring structure can be sufficiently introduced into the polymer due to high cyclization condensation reaction rate, the obtained lactone ring-containing polymer has satisfactory heat resistance.

When the lactone ring-containing polymer is made a chloroform solution of the concentration 15 mass %, the index of coloration (YI) is preferably 6 or less, more preferably 3 or less, still more preferably 2 or less, and especially preferably 1 or less. When the index of coloration (YI) is 6 or less, high transparency may be liable to be obtained by coloration prevention.

The mass reduction temperature by 5% in thermal mass spectrometry (TG) of the lactone ring-containing polymer is preferably 280° C. or more, more preferably 290° C. or more, further preferably 300° C. or more, still more preferably 330° C. or more, particularly preferably 350° C. or more, and most preferably 360° C. or more. The mass reduction temperature by 5% in thermal mass spectrometry (TG) is an index of heat stability, and by making it 280° C. or more, sufficient heat stability is liable to be revealed.

The glass transition temperature (Tg) of the lactone ring-containing polymer is preferably 115° C. or more, more preferably 125° C. or more, still more preferably 130° C. or more, especially preferably 135° C. or more, and most preferably 140° C. or more.

The total amount of the residual volatile content in the lactone ring-containing polymer is preferably 5,000 ppm or less, more preferably 2,000 ppm or less, still more preferably 1,500 ppm or less, and especially preferably 1,000 ppm or less. When the total amount of the residual volatile content is 5,000 ppm or less, coloration due to decomposition at the time of formation, or forming defects such as bubbles and silver streaks is/are effectively liable to be prevented.

The transmittance of all the rays of light measured in conformity with ASTM-D-1003 for a molded product by injection molding of the lactone ring-containing polymer is preferably 85% or more, more preferably 88% or more, and still more preferably 90% or more. The transmittance of all the rays of light is an index of transparency, and transparency is liable to increase by making the transmittance 85% or more.

Other Thermoplastic Resins

The above thermoplastic resin films may contain other thermoplastic resins. The kinds of other thermoplastic resins are not especially restricted so long as they have performances of glass transition temperature of 120° C. or more, phase difference of 20 nm or less per thickness of 100 μm in the plane direction, and transmittance of all the rays of light of 85% or more when mixed with a lactone ring-containing polymer to be made a film, but thermodynamically compatible thermoplastic resins are preferred from the point of capable of providing an optical film having characteristics such as excellent transparency, heat resistance, low phase difference and excellent mechanical strength.

The proportion of the contents of the lactone ring-containing polymer and other thermoplastic resin in the thermoplastic resin film is preferably from 60/40 to 99/1 in mass %, more preferably from 70/30 to 97/3 in mass %, and still more preferably from 80/20 to 95/5 in mass %.

Other thermoplastic resins include, for example, olefin-based polymers, such as polyethylene, polypropylene, an ethylene-propylene copolymer, and poly(4-methyl-1-pentene); halogen-containing polymers, such as vinyl chloride and chlorinated vinyl resin; acrylic polymers, such as methyl polymethacrylate; styrene-based polymers, such as polystyrene, a styrene-methyl methacrylate copolymer, a styrene-acrylonitrile copolymer, and acrylonitrile-butadiene-styrene block copolymer; polyesters, such as polyethylene terephthalate, polybutylene terephthalate, and polyethylene naphthalate; polyamides, such as nylon 6, nylon 66, and nylon 610; polyacetal; polycarbonate; polyphenylene oxide; polyphenylene sulfide; polyether ether ketone; polysulfone; polyether sulfone; polyoxybenzylene; polyamideimide; and gum polymers, such as polybutadiene-based gums, and ABS resins and ASA resins blended with acryl rubber. It is preferred that the gum polymers have a grafted part of a composition compatible with the lactone ring-containing polymer on the surface thereof, and the average particle size of the gum polymers is preferably 100 nm or less in view of the improvement of transparency as a film-like state, and more preferably 70 nm or less.

As thermoplastic resins thermodynamically compatible with lactone ring-containing polymers, copolymers having vinyl cyanide monomer units and aromatic vinyl monomer units, specifically acrylonitrile-styrene copolymers, polyvinyl chloride resins, and polymers containing 50 mass % or more methacrylates are exemplified. Of these thermoplastic resins, when acrylonitrile-styrene copolymers are used, an optical film having a glass transition temperature of 120° C. or more, phase difference of 20 nm or less per thickness of 100 μm in the plane direction, and transmittance of all the rays of light of 85% or more is easily obtained. Further, the fact that the lactone ring-containing polymer and other thermoplastic resin are thermodynamically compatible can be confirmed by measuring the glass transition temperature of the thermoplastic resin composition obtained by mixing the lactone ring-containing polymer and other thermoplastic resin. Specifically, it can be said that they are thermodynamically compatible when the glass transition temperature measured by a differential scanning calorimeter is observed at only one point of the mixture of the lactone ring-containing polymer and other thermoplastic resin.

When an acrylonitrile-styrene copolymer is used as other thermoplastic resin, an emulsion polymerization method, a suspension polymerization method, a solution polymerization method, and a bulk polymerization method can be used as manufacturing methods, but it is preferred to use a solution polymerization method and a bulk polymerization in view of the transparency and optical performances of the obtained thermoplastic resin film.

Thermoplastic resin composition that is the raw material of the thermoplastic resin film may contain various additives, for example, antioxidants, e.g., hindered phenol-based, phosphorus-based and sulfur-based antioxidants; stabilizers, e.g., a light fastness stabilizer, a weather proofing stabilizer, and a heat stabilizer; reinforcing materials, e.g., glass fiber and carbon fiber; ultraviolet absorbers, e.g., phenyl salicylate, (2,2′-hydroxy-5-methylphenyl)benzotriazole, and 2-hydroxybenzophenone; near infrared absorbers; flame retardants, e.g., tris(dibromopropyl) phosphate, triallyl phosphate, and antimony oxide; antistatic agents, e.g., anionic, cationic, and nonionic surfactants; colorants, e.g., an inorganic pigment, an organic pigment, and a dye; organic fillers and inorganic fillers; resin modifiers; organic bulking agents and inorganic bulking agents; plasticizers; and lubricants are exemplified.

The proportion of the contents of these additives in the thermoplastic resin film is preferably from 0 to 5 mass %, more preferably from 0 to 2 mass %, and still more preferably from 0 to 0.5 mass %.

The thermoplastic resin film can be manufactured by thoroughly mixing, for example, the lactone ring-containing polymer, if necessary, other thermoplastic resins and additives, by a conventionally known mixing method, and forming the mixture to a film.

The thermoplastic resin film has a glass transition temperature of 120° C. or, more, preferably 125° C. or more, and more preferably 130° C. or more.

The thermoplastic resin film has preferably phase difference of 20 nm or less per thickness of 100 μm in the plane direction, and more preferably 10 nm or less.

The thermoplastic resin film has preferably transmittance of all the rays of light of 85% or more, more preferably 87% or more, and still more preferably 90% or more.

The phase difference of the thermoplastic resin film is small in incident angle dependency, and the difference in phase difference R₀ per incident angle of 0° and a thickness of 100 μm and phase difference R₄₀ per incident angle of 40° and a thickness of 100 μm (R₄₀−R₀) is preferably less than 20 nm, and more preferably less than 10 nm.

The thermoplastic resin film has a thickness of preferably 1 μm or more and less than 100 μm, more preferably from 10 to 80 μm, and more preferably 60 μm or less. When the thickness is 1 μm or more, mechanical strength is liable to be improved, and rupture is difficult to occur in stretching.

The thermoplastic resin film containing the lactone ring-containing polymer of the embodiment has tensile strength measured in conformity with ASTM-D-882-61T of preferably 10 MPa or more and less than 100 MPa, and more preferably 30 MPa or more and less than 100 MPa. By making the tensile strength 10 MPa or more, sufficient mechanical strength is liable to be revealed, and productivity tends to be improved by the tensile strength of less than 100 MPa.

The thermoplastic resin film containing the lactone ring-containing polymer of the embodiment has elongation percentage measured in conformity with ASTM-D-882-61T of preferably 1% or more, and more preferably 3% or more. The least upper bound of elongation percentage is not especially restricted, but is generally preferably 100% or less. By making elongation percentage 1% or more, tenacity is liable to increase and preferred.

The thermoplastic resin film containing the lactone ring-containing polymer of the embodiment has elastic modulus in tension measured in conformity with ASTM-D-882-61T of preferably 0.5 GPa or more, more preferably 1 GPa or more, and still more preferably 2 GPa or more. The least upper bound of elastic modulus in tension is not especially restricted, but is generally preferably 20 GPa or less. By making elastic modulus in tension 0.5 GPa or more, mechanical strength is liable to increase and preferred.

The manufacturing method of the thermoplastic resin film containing the lactone ring-containing polymer of the invention is not especially restricted. For example, the thermoplastic resin film can be manufactured by mixing the lactone ring-containing polymer and, if necessary, other thermoplastic resins and additives by a conventionally known mixing method to make a thermoplastic resin composition in advance, and forming the mixture to a film. For manufacturing the thermoplastic resin composition, a method of blending the components with an omni-mixer and the like, and extrusion kneading the resulting mixture can be adopted. In this case, kneaders for use in extrusion kneading are not especially restricted and conventionally well-known kneaders, for example, extruders, e.g., a uniaxial extruder and a biaxial extruder, and pressurizing kneaders can be used.

As film-forming methods, it will suffice to use conventionally known film-forming methods, for example, a solution casting method, a melt extrusion method, a calendering method, and a compression molding method are exemplified. Of these film-forming methods, a solution casting method and a melt extrusion method are especially preferred. At this time, the thermoplastic resin composition that has been extrusion kneaded in advance as described above may be used, or the lactone ring-containing polymer and other thermoplastic resins and, if necessary, additives are separately dissolved to make a homogeneous mixed solution, and a film may be formed according to a solution casting method and a melt extrusion method.

As the solvents for use in a solution casting method, chlorine solvents, e.g., chloroform and dichloromethane; aromatic solvents, e.g., toluene, xylene and benzene; alcohol solvents, e.g., methanol, ethanol, isopropanol, n-butanol, and 2-butanol; methyl cellosolve, ethyl cellosolve, butyl cellosolve, dimethylformamide, dimethyl sulfoxide, dioxane, cyclohexanone, tetrahydrofuran, acetone, methyl ethyl ketone, ethyl acetate, and diethyl ether are exemplified. These solvents may be used by one kind alone or two or more kinds may be used in combination.

As the apparatus for performing the solution casting method, e.g., a drum type casting machine, a band type casting machine and a spin coater are exemplified.

As the melt extrusion method, a T die method and an inflation method are exemplified, and a film-forming temperature at that time is preferably from 150 to 350° C., and more preferably from 200 to 300° C.

The film-forming speed of the solution casting method and the melt extrusion method is not especially restricted, but from the viewpoint of productivity, the speed is preferably 20 m/min or more. However, when the film-forming speed is fast, the surface smoothness deteriorates, haze conspicuously becomes worse, and transportability and a winding property are aggravated, so that the speed is preferably 50 m/min or less.

When a film is formed by a T die method, a T die is attached to the tip of known uniaxial extruder or biaxial extruder, and a film extruded in a film shape is wound to obtain a film in the form of a roll. At this time, a uniaxial extruding process is also possible by arbitrarily adjusting the temperature of the winding roll and stretching is applied in the extruding direction. Further, processes such as a successive biaxial stretching and simultaneous biaxial stretching can be added by adopting a process of stretching a film in a vertical direction to the extruding direction.

An optical film in the invention may be an unstretched film or a stretched film. When a film is stretched, the film may be a uniaxially stretched film or a biaxially stretched film. In the case of forming a biaxially stretched film, the film may be a simultaneously biaxially stretched film or a successively biaxially stretched film. In the case of biaxial stretching, mechanical strength and film performances are heightened. By blending other thermoplastic resins, the optical film in the invention can restrain increase in phase difference even when the film is stretched, and optical isotropy can be maintained.

Stretching is preferably performed at a temperature around the glass transition temperature of the thermoplastic resin composition of raw material of the film. The specific stretching temperature is preferably from (glass transition temperature −30° C.) to (glass transition temperature +100° C.), and more preferably (glass transition temperature −20° C.) to (glass transition temperature +80° C.). When the stretching temperature is less than (glass transition temperature −30° C.), there are cases where sufficient stretching magnification cannot be obtained. On the contrary, when the stretching temperature exceeds (glass transition temperature +100° C.), there are cases where the resin flows and stable stretching cannot be conducted.

Stretching magnification defined by area ratio is preferably from 1.1 to 25 times, and more preferably from 1.3 to 10 times. When stretching magnification is 1.1 times or more, tenacity by stretching is liable to increase. While when stretching magnification is 25 times or less, the effect of raising stretching magnification is liable to be revealed.

Stretching velocity (one direction) is preferably from 10 to 20,000%/min, and more preferably from 100 to 10,000%/min. When stretching velocity is 10%/min or more, the time for obtaining sufficient stretching magnification tends to be shortened, and manufacturing costs can be easily restrained. On the contrary, when stretching velocity is 20,000%/min or less, rupture of the stretched film is difficult to occur.

For stabilizing optical isotropy and mechanical strength of a film, heat treatment (annealing) may be carried out after stretching treatment.

Manufacture of an Optically Compensatory Sheet

An optically compensatory sheet in the embodiment can be manufactured by applying a polymer solution or a polymer melt on the surface of the thermoplastic resin film and drying to form a polymer layer. Forming of a polymer layer is as described above.

After forming the polymer layer on the thermoplastic resin film as described above, for controlling phase difference characteristics such as Rth(λ) and Re(λ), it is preferred to perform stretching treatment and contraction treatment. The preferred examples of the stretching treatment and contraction treatment are as described above.

An optically compensatory sheet in the embodiment can be used in various modes of liquid crystal displays. An optically compensatory sheet in the invention can be used as it is in a liquid crystal display as a single member. In addition, an optically compensatory sheet can also be used in a liquid crystal display by being stuck with a polarizing film and as a member of a polarizing plate. A polarizing plate having an optically compensatory sheet of the embodiment will be described below.

Polarizing Plate

A polarizing plate in the embodiment has at least a polarizing film and an optically compensatory sheet of the embodiment. The optically compensatory sheet may be directly stuck on the surface of the polarizing film and used as the protective film of the polarizing film. In this embodiment, it is preferred to stick the rear surface of the thermoplastic resin film (the surface of the side on which an optically anisotropic layer is not formed) on the front surface of the polarizing film. Further, it is also preferred that a protective film such as a cellulose acylate film is stuck on the other side of the polarizing film.

Polarizing Film

There are an iodine-based polarizing film, a dye-based polarizing film using a dichroic dye, and a polyene-based polarizing film in polarizing films, and any polarizing film may be used in the invention. The iodine-based polarizing film and the dye-based polarizing film are generally manufactured with a polyvinyl alcohol-based film.

Protective Film

As a protective film stuck on the surface of the other side, it is preferred to use a transparent polymer film. “Transparent” means that light transmittance is 80% or more. As the protective film, a cellulose acylate film and a polyolefin film containing polyolefin are preferred. Of the cellulose acylate films, a cellulose triacetate (triacetyl cellulose, hereinafter referred to as TAC) film is preferred. Of the polyolefin films, a polynorbornene film containing cyclic polyolefin is preferred.

The thickness of the protective film is preferably from 20 to 500 μm, and more preferably from 50 to 200 μm.

Functional layers, e.g., an antireflection layer, may further be arranged on the surface of the protective layer.

### Embodiments 2-1 and 2-2

A VA (vertical alignment) liquid crystal display according to Embodiment 2-1 of the invention includes a liquid crystal cell, two polarizing plates disposed outside the liquid crystal cell, and an optically anisotropic layer disposed at either of two spaces between the liquid crystal cell and two polarizing plates. The optically anisotropic layer includes a lactone ring-containing polymer, and in-plane retardation Re and retardation in a thickness direction Rth of the optically anisotropic layer satisfy the following formulae (A) and (B),

40 nm≦Re(550)≦275 nm (A)

0 nm≦Rth(550)≦275 nm (B)

Wherein, Re(550) and Rth(550) represent in-plane retardation (nm) and retardation (nm) in a thickness direction at the wavelength of 550 (nm).

A VA (vertical alignment) liquid crystal display according to Embodiment 2-2 of the invention includes a liquid crystal cell, two polarizing plates disposed outside the liquid crystal cell, and an optically anisotropic layers disposed at both of two spaces between the liquid crystal cell and two polarizing plates. The optically anisotropic layer includes a lactone ring-containing polymer, and in-plane retardation Re and retardation in a thickness direction Rth of the optically anisotropic layer satisfy the following formulae (C) and (D),

30 nm≦Re(550)≦80 nm (C)

75 nm≦Rth(550)≦155 nm. (C)

The optically anisotropic layer of the Embodiment preferably includes a thermoplastic resin composition containing a lactone ring-containing polymer. Regarding the lactone ring-containing polymer, the description of the lactone ring-containing polymer in Embodiments 1-1 and 1-2 can be referred to as it is. Further, the thermoplastic resin composition in the Embodiment may include other thermoplastic resins and other additives, similarly to Embodiments 1-1 and 1-2, for these, including the kinds thereof or contents thereof, the description in Embodiments 1-1 and 1-2 can be referred to as it is.

In order to satisfy the conditions as the optically anisotropic layer, it is preferred that the optically anisotropic layer includes at least one kind of retardation developer. “retardation developer” means a compound having a property which develops birefringence in an in-plane direction or a thickness direction of the optically anisotropic layer. The retardation developer is described below.

Retardation Developer

As the retardation developer, a compound which has an absorption maximum in the wavelength range of 250 nm to 380 nm and a large anisotropic polarization ratio is preferred. As the retardation developer, in particular, a compound represented by the following formula (I) may be used preferably.

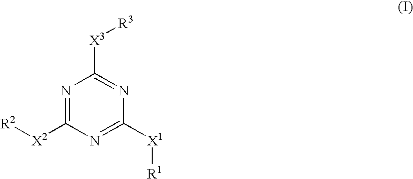

Wherein X¹ represents a single bond, —NR⁴—, —O— or S—; X² represents a single bond, —NR⁵—, —O— or S—; X³ represents a single bond, —NR⁶—, —O— or S—. R¹, R² and R³ each independently represents an alkyl group, an alkenyl group, an aromatic group, or a heterocyclic group; R⁴, R⁵ and R⁶ each independently represents a hydrogen atom, an alkyl group, an alkenyl group, an aryl group or a heterocyclic group.

Preferable examples (I-(1) to IV-(10)) of compounds represented by formula (I) are shown below, but the invention is not limited to these specific examples.

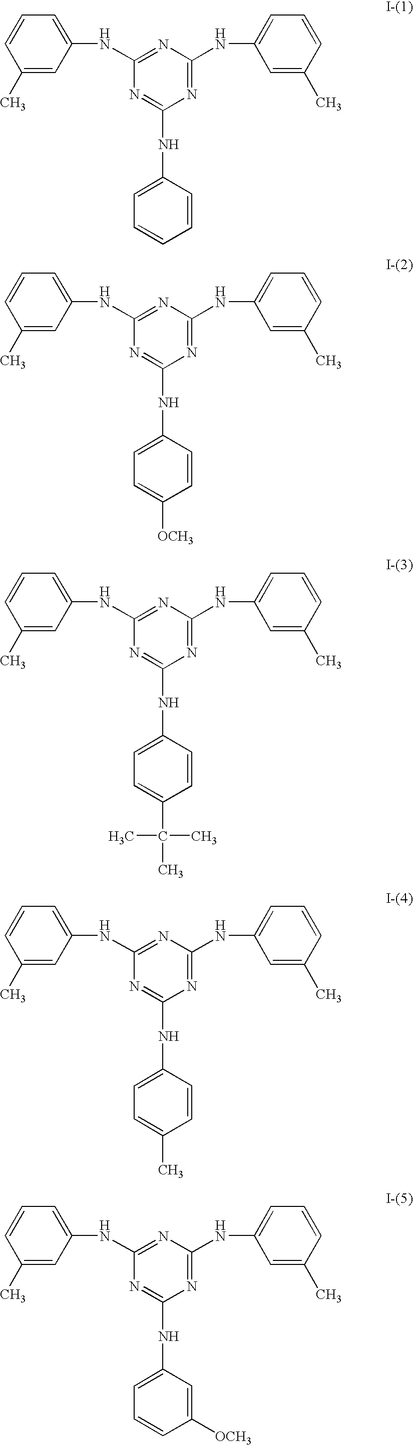

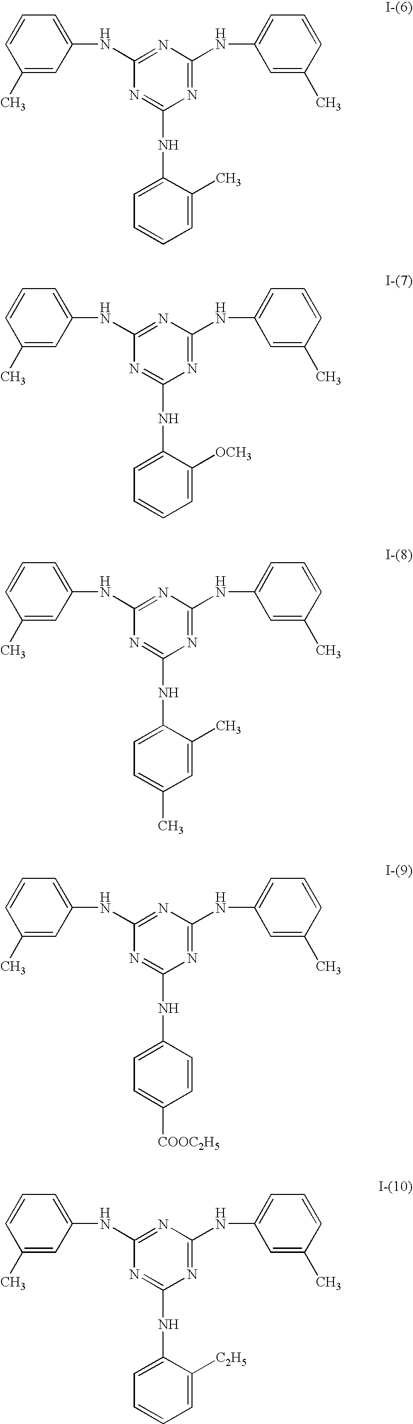

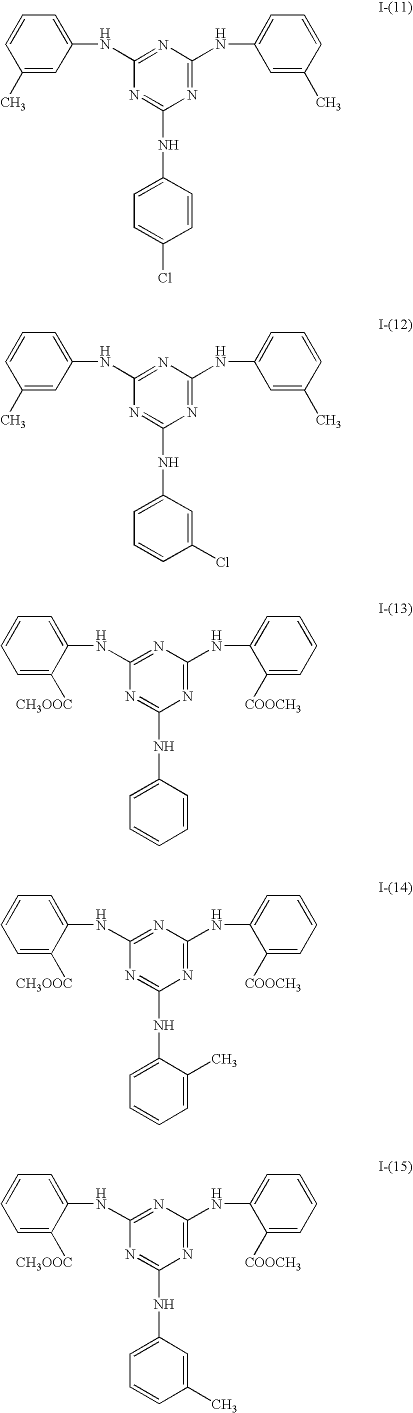

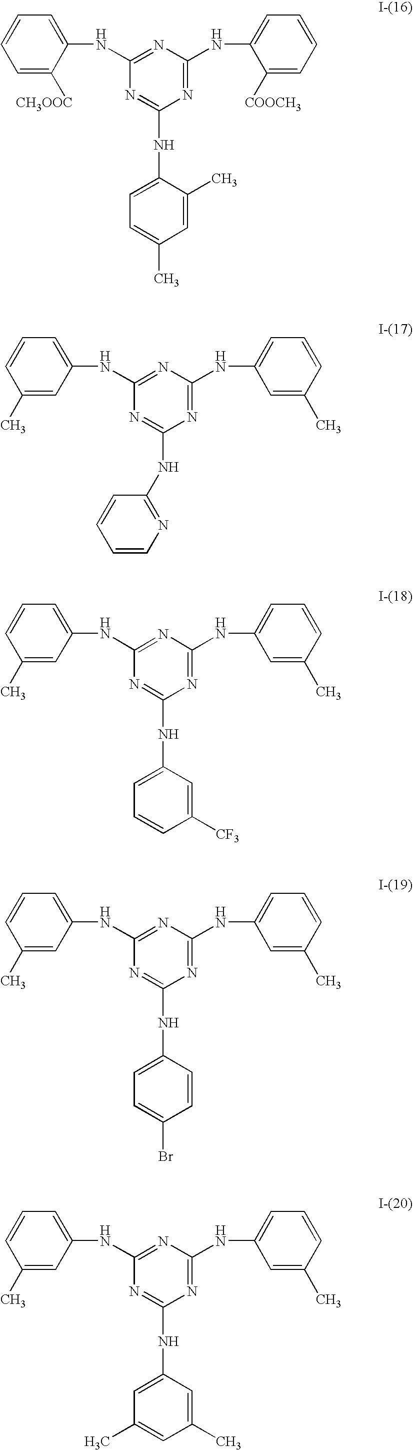

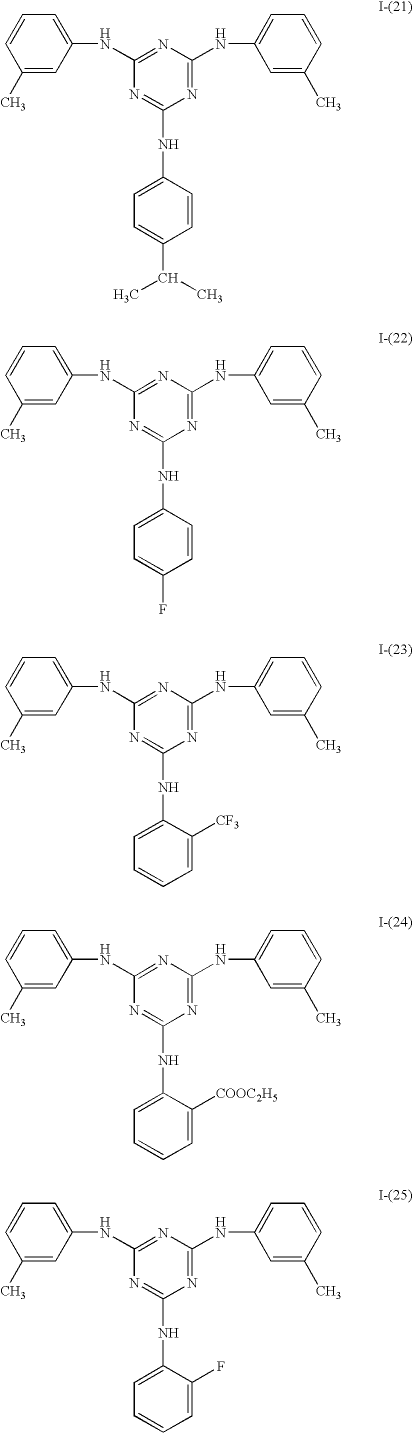

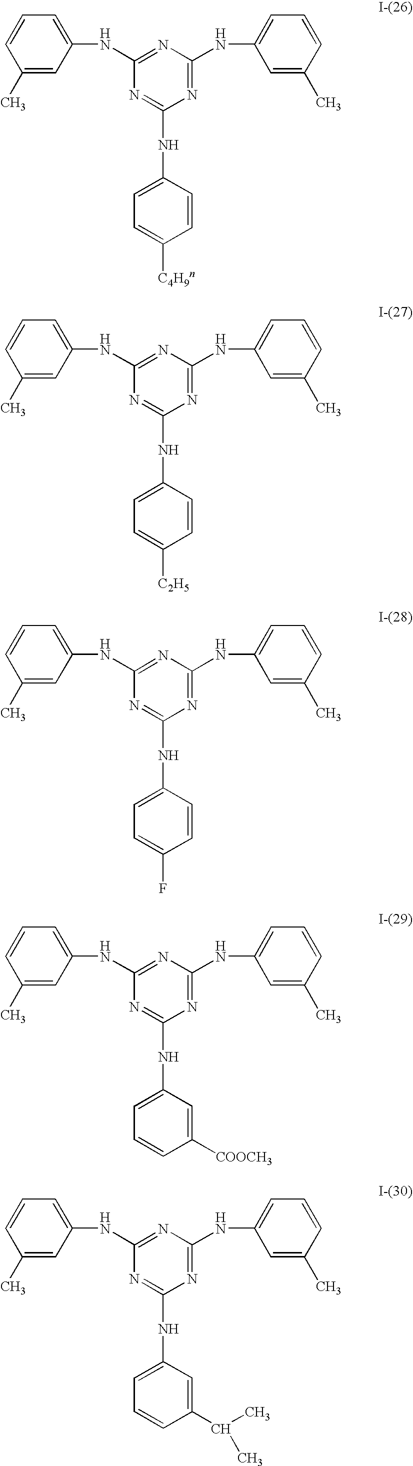

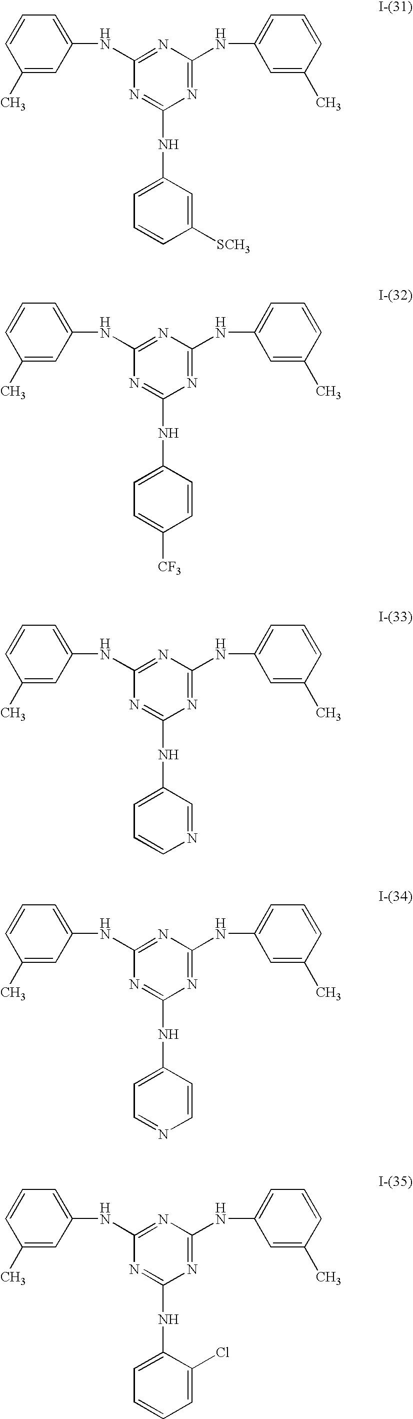

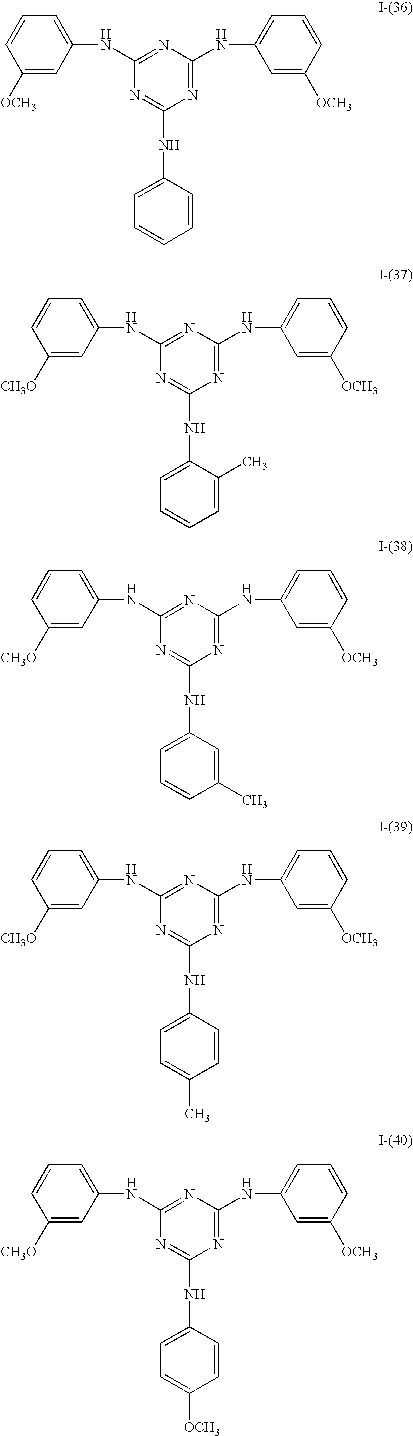

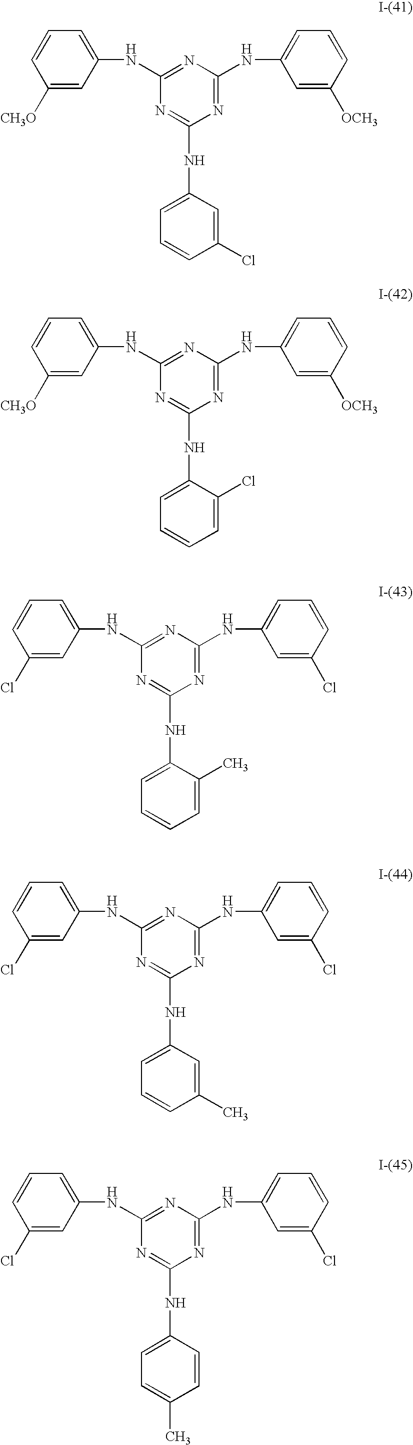

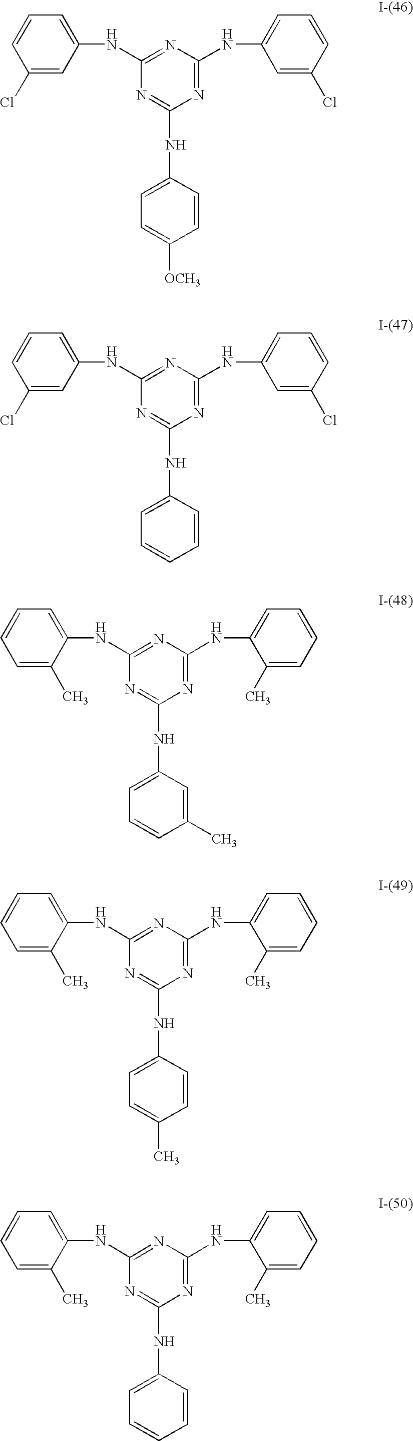

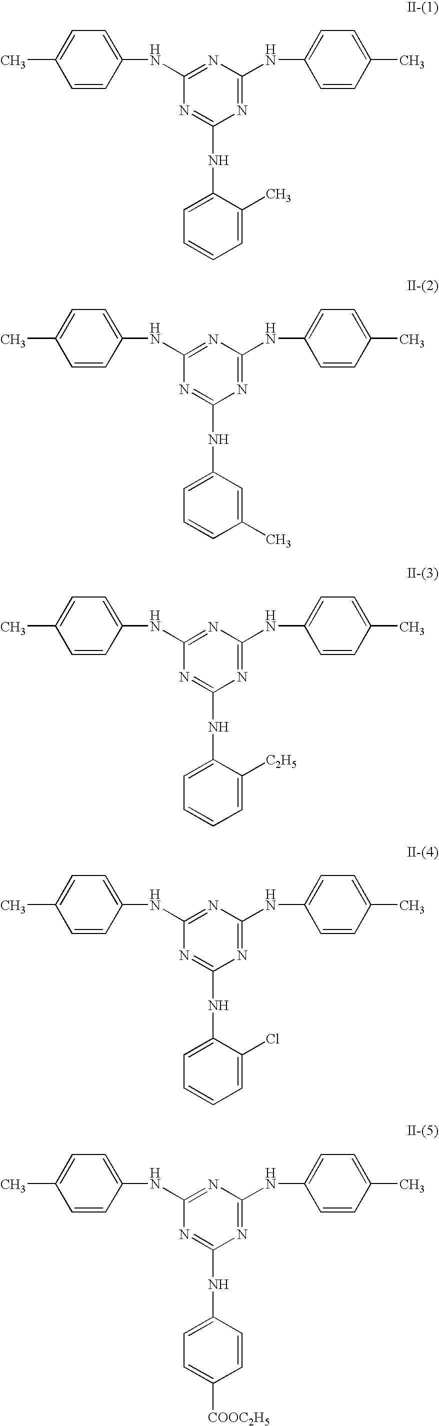

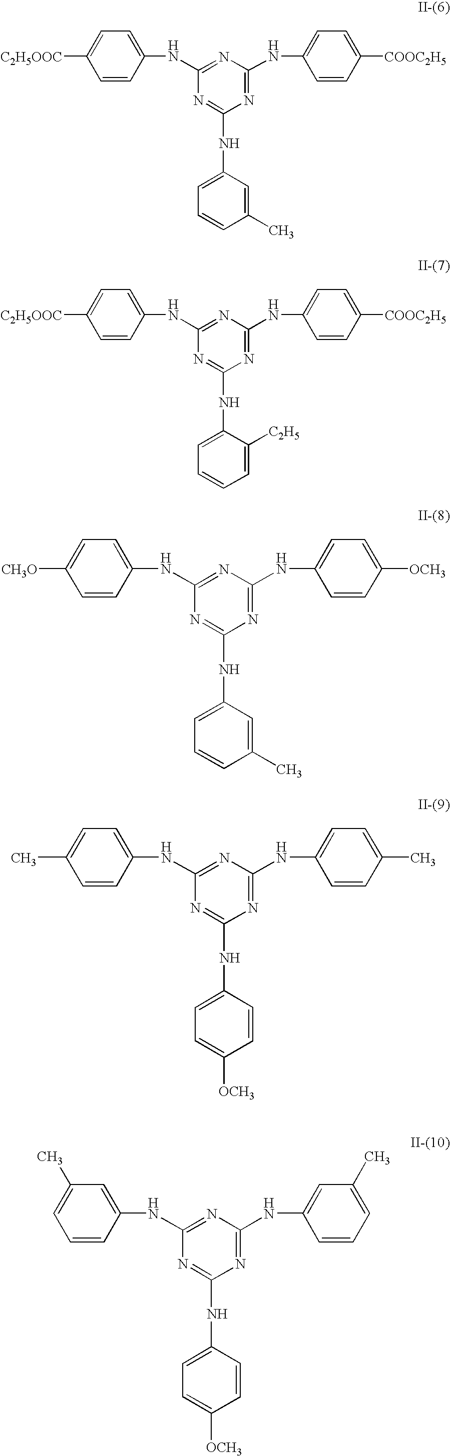

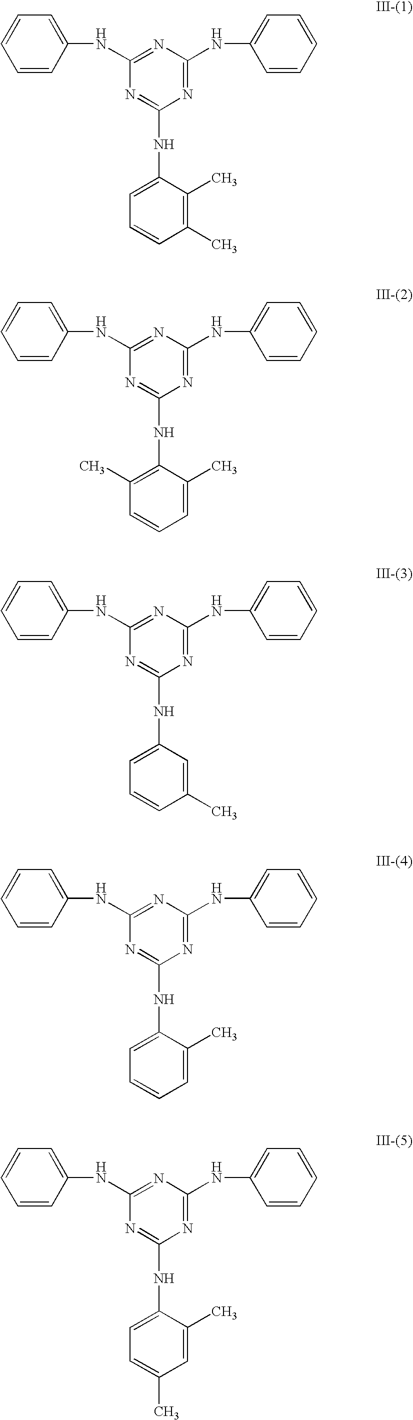

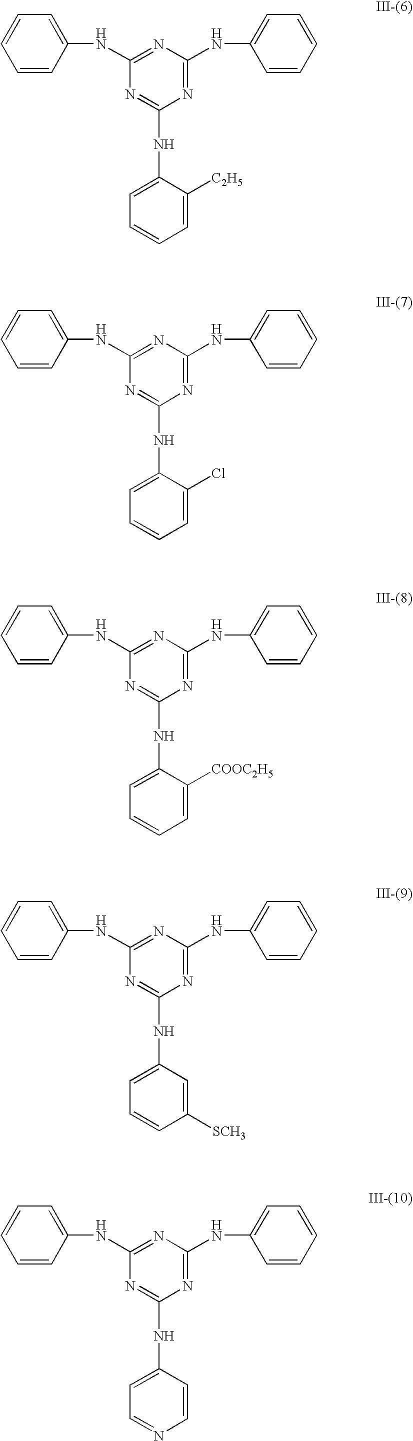

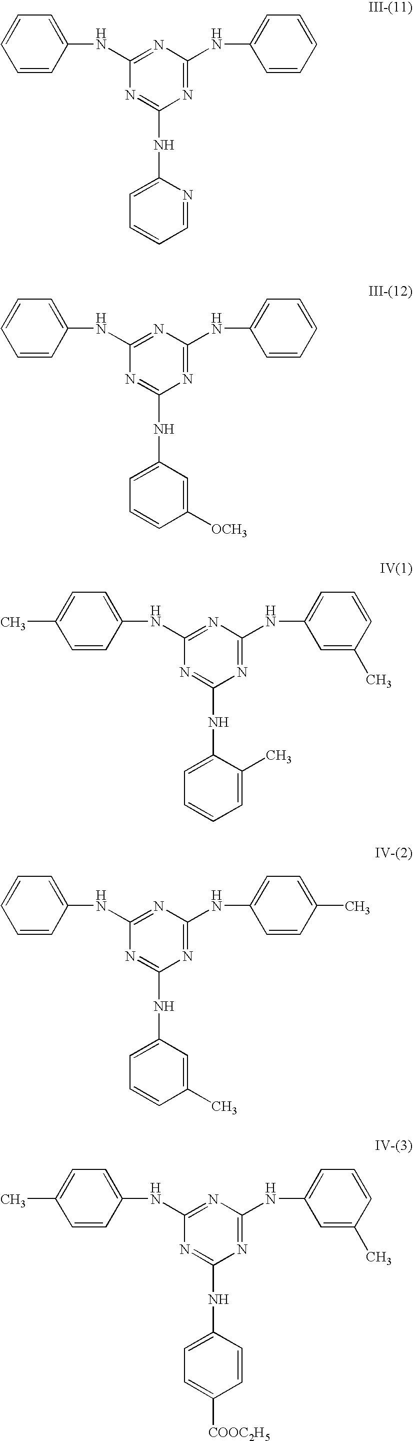

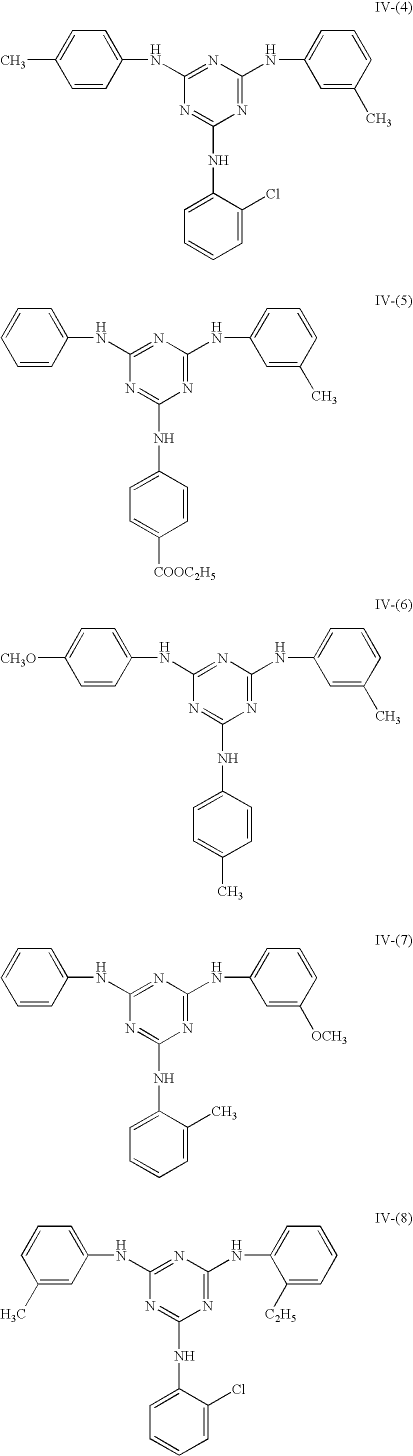

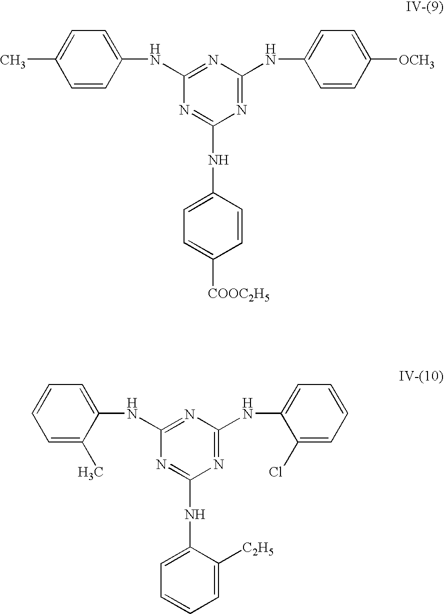

The retardation developer may include at least one kind of a compound represented by the following formula (II)-1.

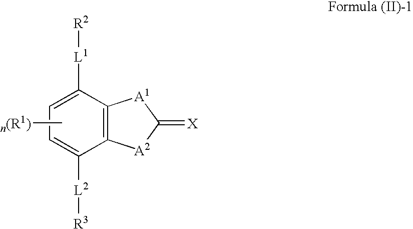

In the formula, L¹ and L² each independently represents a single bond, or a divalent connecting group. A¹ and A² each independently represents a group selected from the group consisting of —O—, —NR— (R represents a hydrogen atom or a substituent), —S— and —CO—. R¹, R² and R³ each independently represents a substituent. X represents a nonmetal atom of 14th to 16th group (provided that a hydrogen atom or a substituent may be bonded to X). n represents any integer of 0 to 2.

Among compounds represented by formula (II)-1, it is preferred that the retardation developer is a compound represented by the following formula (II)-2.

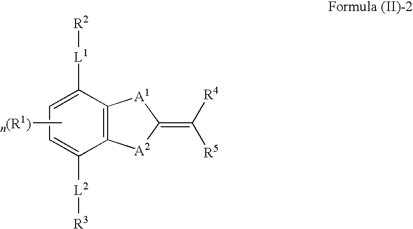

In formula (II)-2, L¹ and L² each independently represents a single bond, or a divalent connecting group. A¹ and A² each independently represents a group selected from the group consisting of —O—, —NR— (R represents a hydrogen atom or a substituent), —S— and CO—. R¹, R², R³, R⁴, and R⁵ each independently represents a substituent. n represents any integer of from 0 to 2.

As a divalent connecting group represented by L¹ and L² in formulae (II)-1 or (II)-2, preferable examples include the following examples.

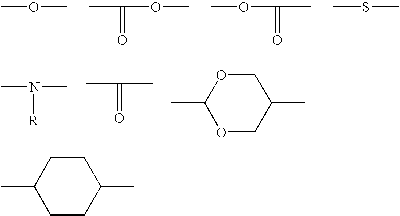

Further preferred are —O—, —COO—, and —OCO—.

In formulae (II)-1 or (II)-2, R¹ is a substituent, and when a plurality of substituents are present, the substituents may be the same or different, and may form a ring. The substituents may apply the following group.

A halogen atom (for example, a fluorine atom, a chlorine atom, a bromine atom, and an iodine atom), an alkyl group (preferably, an alkyl group having from 1 to 30 carbon atoms, for example, a methyl group, an ethyl group, n-propyl group, an isopropyl group, a text-butyl group, an n-octyl group, and a 2-ethylhexyl group), a cycloalkyl group (preferably, a substituted or unsubstituted cycloalkyl group having from 3 to 30 carbon atoms, for example, a cyclohexyl group, a cyclopentyl group, and 4-n-dodecyl cyclohexyl group), a bicycloalkyl group (preferably, a substituted or unsubstituted bicycloalkyl group having from 5 to 30 carbon atoms, that is, a monovalent group which removes a hydrogen atom from bicycloalkane having from 5 to 30 carbon atoms; for example, a bicyclo[1,2,2]heptan-2-yl group, and a bicyclo[2,2,2]octan-3-yl group), an alkenyl group (preferably, a substituted or unsubstituted alkenyl group having from 2 to 30 carbon atoms, for example, a vinyl group and an allyl group), a cycloalkenyl group (a substituted or unsubstituted cycloalkenyl group having from 3 to 30 carbon atoms, that is, a monovalent group which removes a hydrogen atom from a cycloalkane having from 3 to 30 carbon atoms, for example, a 2-cyclopenten-1-yl, and a 2-cyclohexen-1-yl group), a bicycloalkenyl group (a substituted or unsubstituted bicycloalkenyl group, preferably a substituted or unsubstituted bicycloalkenyl group having from 5 to 30 carbon atoms, that is a monovalent group removing a hydrogen atom of a bicycloalkene having a double bond; for example, a bicyclo[2,2,1]hept-2-en-1-yl group, and bicyclo[2,2,2]oct-2-en-4-yl group), an alkynyl group (preferably, a substituted or unsubstituted alkynyl group having from 2 to 30 carbon atoms, for example, an ethynyl group, and a propargyl group), an aryl group (preferably a substituted or unsubstituted aryl group having from 6 to 30 carbon atoms, for example, a phenyl group, a p-tolyl group, and a naphthyl group), a heterocyclic group (a monovalent group removing a hydrogen atom from an aromatic or nonaromatic heterocyclic compound which is five- or six-membered substituted or unsubstituted is preferred, and more preferably a five- or six-membered aromatic heterocyclic group having from 3 to 30 carbon atoms. For example, a 2-furyl group, a 2-thienyl group, a 2-pyrimidinyl group, and a 2-benzothiazolyl group), a cyano group, a hydroxyl group, a nitro group, a carboxyl group, an alkoxy group (preferably a substituted or unsubstituted alkoxy group having from 1 to 30 carbon atoms, for example, a methoxy group, an ethoxy group, an isopropoxy group, a tert-butoxy group, an n-octyloxy group, and a 2-methoxyethoxy group), an aryloxy group (preferably, a substituted or unsubstituted aryloxy group having from 6 to 30 carbon atoms, for example, a phenoxy group, a 2-methyl phenoxy group, a 4-tert-butyl phenoxy group, a 3-nitrophenoxy group, a 2-tetradecanoyl aminophenoxy group), a silyloxy group (preferably, a silyloxy group having from 3 to 20 carbon atoms, for example, a trimethyl silyloxy group, a tert-butyl dimethyl silyloxy group), a heterocyclic oxy group (preferably, a substituted or unsubstituted heterocyclic oxy group having from 2 to 30 carbon atoms, a 1-phenyl tetrazol-5-oxy group, and a 2-tetrahydropyranyloxy group), an acyloxy group (preferably, a formyloxy group, a substituted or unsubstituted alkyl carbonyloxy group having from 2 to 30 carbon atoms, (preferably, a substituted or unsubstituted aryl carbonyloxy group having from 6 to 30 carbon atoms, for example, a formyloxy group, an acetyloxy group, a pyvaloyloxy group, a stearoyloxy group, a benzoyloxy group, a p-methoxy phenyl carbonyloxy group), a carbamoyloxy group (preferably, a substituted or unsubstituted carbamoyloxy group having from 1 to 30 carbon atoms, for example, an N,N-dimethyl carbamoyloxy group, an N,N-diethyl carbamoyloxy group, a morpholino carbonyloxy group, an N,N-di-n-octylamino carbonyloxy group, and an N-n-octyl carbamoyloxy group), an alkoxy carbonyloxy group (preferably, a substituted or unsubstituted alkoxy carbonyloxy group having from 2 to 30 carbon atoms, for example, a methoxy carbonyloxy group, an ethoxy carbonyloxy group, a tert-butoxy carbonyloxy group, and an n-octyl carbonyloxy group), an aryloxy carbonyloxy group (preferably, a substituted or unsubstituted aryloxy carbonyloxy group having from 7 to 30 carbon atoms, for example, a phenoxy carbonyloxy group, a p-methoxy phenoxy carbonyloxy group, a p-n-hexadecyloxy phenoxy carbonyloxy group), an amino group (preferably, an amino group, a substituted or unsubstituted alkyl amino group having from 1 to 30 carbon atoms, a substituted or unsubstituted anilino group having from 6 to 30 carbon atoms, for example, an amino group, a methyl amino group, a dimethyl amino group, an anilino group, an N-methyl-anilino group, and a diphenyl amino group), an acyl amino group (preferably, a formyl amino group, a substituted or unsubstituted alkyl carbonyl amino group having from 1 to 30 carbon atoms, a substituted or unsubstituted aryl carbonyl amino group having from 6 to 30 carbon atoms, for example, a formyl amino group, an acetyl amino group, a pivaloyl amino group, a lauroyl amino group, and a benzoyl amino group), an aminocarbonyl amino group (preferably, a substituted or unsubstituted aminocarbonyl amino group having from 1 to 30 carbon atoms, for example, a carbamoyl amino group, an N,N-dimethyl amino carbonyl amino group, an N,N-diethyl amino carbonyl amino group, a morpholino carbonyl amino group), an alkoxy carbonyl amino group (preferably, a substituted or unsubstituted alkoxy carbonyl amino group having from 2 to 30 carbon atoms, for example, a methoxy carbonyl amino group, an ethoxy carbonyl amino group, a tert-butoxy carbonyl amino group, an n-octadecyloxy carbonyl amino group, and an N-methyl-methoxy carbonyl amino group), an aryloxy carbonyl amino group (preferably, a substituted or unsubstituted aryloxy carbonyl amino group having from 7 to 30 carbon atoms, for example, a phenoxy carbonyl amino group, a p-chlorophenoxy carbonyl amino group, and a m-n-octyloxy phenoxy carbonyl amino group), sulfamoyl amino group (preferably, a substituted or unsubstituted sulfamoyl amino group having from 0 to 30 carbon atoms, for example, a sulfamoyl amino group, an N,N-dimethyl amino sulfonyl amino group, and an N-n-octyl amino sulfonyl amino group), an alkyl sulfonyl amino group and an aryl sulfonyl amino group (preferably, a substituted or unsubstituted alkyl sulfonyl amino group having from 1 to 30 carbon atoms, a substituted or unsubstituted aryl sulfonyl amino group having from 6 to 30 carbon atoms, for example, a methyl sulfonyl amino group, a butyl sulfonyl amino group, a phenyl sulfonyl amino group, a 2,3,5-trichlorophenyl sulfonyl amino group, and a p-methyl phenyl sulfonyl amino group), a mercapto group, an alkyl thio group (preferably, a substituted or unsubstituted alkyl thio group having from 1 to 30 carbon atoms, for example, a methyl thio group, an ethyl thio group, and an n-hexadecyl thio group), an aryl thio group (preferably, a substituted or unsubstituted aryl thio group having from 6 to 30 carbon atoms, for example, a phenyl thio group, a p-chlorophenyl thio group, and a m-methoxy phenyl thio group), a heterocyclic thio group (preferably, a substituted or unsubstituted heterocyclic thio group having from 2 to 30 carbon atoms, for example, a 2-benzothiazolyl thio group, and a 1-phenyltetrazol-5-yl thio group), a sulfamoyl group (preferably, a substituted or unsubstituted sulfamoyl group having from 0 to 30 carbon atoms, for example, an N-ethyl sulfamoyl group, an N-(3-dodecyloxy propyl) sulfamoyl group, an N,N-dimethyl sulfamoyl group, an N-acetyl sulfamoyl group, an N-benzoyl sulfamoyl group, and an N—(N′-phenyl carbamoyl) sulfamoyl group), a sulfo group, an alkyl sulfynyl group and an aryl sulfynyl group (preferably, a substituted or unsubstituted alkyl sulfynyl group having from 1 to 30 carbon atoms, a substituted or unsubstituted aryl sulfynyl group having from 6 to 30 carbon atoms, for example, a methyl sulfynyl group, an ethyl sulfynyl group, a phenyl sulfynyl group, and a p-methyl phenyl sulfynyl group), an alkyl sulfonyl group and an aryl sulfonyl group (preferably, a substituted or unsubstituted alkyl sulfonyl having from 1 to 30 carbon atoms, a substituted or unsubstituted aryl sulfonyl group having from 6 to 30 carbon atoms, for example, a methyl sulfonyl group, an ethyl sulfonyl group, a phenyl sulfonyl group, and a p-methyl phenyl sulfonyl group), an acyl group (preferably, a formyl group, a substituted or unsubstituted alkyl carbonyl group having from 2 to 30 carbon atoms, a substituted or unsubstituted aryl carbonyl group having from 7 to 30 carbon atoms, for example, an acetyl group, and an pivaloyl benzoyl group), an aryloxy carbonyl group (preferably, a substituted or unsubstituted aryloxy carbonyl group having from 7 to 30 carbon atoms, for example, a phenoxy carbonyl group, an o-chlorophenoxy carbonyl group, m-nitrophenoxy carbonyl group, and p-tert-butyl phenoxy carbonyl group), an alkoxy carbonyl group (preferably, a substituted or unsubstituted alkoxy carbonyl group having from 2 to 30 carbon atoms, for example, a methoxy carbonyl group, an ethoxy carbonyl group, a tert-butoxy carbonyl group, an n-octadecyloxy carbonyl group), a carbamoyl group (preferably, a substituted or unsubstituted carbamoyl group having from 1 to 30 carbon atoms, for example, a carbamoyl group, an N-methyl carbamoyl group, an N,N-dimethyl carbamoyl group, an N,N-di-n-octyl carbamoyl group, and an N-(methylsulfonyl) carbamoyl group), aryl and heterocyclic azo group (preferably, a substituted or unsubstituted aryl azo group having from 6 to 30 carbon atoms, a substituted or unsubstituted heterocyclic azo group having from 3 to 30 carbon atoms, for example, a phenyl azo group, a p-chlorophenyl azo group, and 5-ethylthio-1,3,4-thiadiazol-2-yl azo group), an imido group (preferably, an N-succinimido group, and an N-phthalimido group), a phosphino group (preferably, a substituted or unsubstituted phosphino group having from 2 to 30 carbon atoms, for example, a dimethyl phosphino group, a diphenyl phosphino group, and a methyl phenoxy phosphino group), a phosphinyl group (preferably, a substituted or unsubstituted phosphinyl group having from 2 to 30 carbon atoms, for example, a phosphinyl group, a dioctyloxy phosphinyl group, and a diethoxy phosphinyl group), a phosphinyloxy group (preferably, a substituted or unsubstituted phosphinyloxy group having from 2 to 30 carbon atoms, for example, a diphenoxy phosphinyloxy group, and a dioctyloxy phosphinyloxy group), a phosphinyl amino group (preferably, a substituted or unsubstituted phosphinyl amino group having from 2 to 30 carbon atoms, for example, a dimethoxy phosphinyl amino group and dimethyl amino phosphinyl amino group), a silyl group (preferably, a substituted or unsubstituted silyl group having from 3 to 30 carbon atoms, for example, a trimethyl silyl group, a tert-butyl dimethyl silyl group, and a phenyl dimethyl silyl group).

hydrogen atoms included in the above substituent may be removed and be replaced with the above group. Examples of such functional groups include an alkyl carbonyl aminosulfonyl group, an aryl carbonyl aminosulfonyl group, an alkyl sulfonyl amino carbonyl group, and an aryl sulfonyl amino carbonyl group. Examples of these groups include a methyl sulfonyl aminocarbonyl group, a p-methyl phenyl sulfonyl amino carbonyl group, an acetyl amino sulfonyl group, and a benzoyl amino sulfonyl group.

R¹ preferably include a halogen atom, an alkyl group, an alkenyl group, an aryl group, a heterocyclic group, a hydroxyl group, a carboxyl group, an alkoxy group, an aryloxy group, an acyloxy group, a cyano group, and an amino group, and more preferably a halogen atom, an alkyl group, a cyano group, and an alkoxy group.

R² and R³ each independently represents a substituent. Examples of the substituents include examples of the R¹, and preferred are substituted or unsubstituted benzene ring, and substituted or unsubstituted cyclohexane ring. More preferred are a benzene ring having a substituent, and a cyclohexane ring having a substituent, and further preferred are a benzene ring having a substituent at 4-position and a cyclohexane ring having a substituent at 4-position.

R⁴ and R⁵ each independently represents a substituent. Examples of the substituents include examples of the R¹. Preferably, Electron-withdrawing substituents where a Hammett substitution constant σₚ value is larger than 0 are preferred. It is more preferable to have Electron-withdrawing substituents of 0 to 1.5 of σₚ value. As such substituents, a trifluoromethyl group, a cyano group, a carbonyl group, and a nitro group are exemplified. Further, R⁴ may combine with R⁵ to form a ring.

Further, hammett substitution constants σₚ and σₘ, for example, were described in “Hamettosoku-Kozo To Han'nosei (Hammett's Rule-Structure and Reactivity)” written by Naoki Inamoto (published by Maruzen); “Shinjikken Kagaku Koza 14, Yuki Kagobutsu No Gosei To Han'no V (Novel Experimental Chemistry Lecture 14, Synthesis and Reaction V of Organic Compounds)”, p. 2605, edited by the Chemical Society of Japan, (published by Maruzen); “Riron Yuki Kagaku Kaisetsu (Theoretical Organic Chemistry Handbook)”, written by Tadao Nakaya, p. 217 (published by Tokyo Kagaku Dojin), Kemikaru Rebyu (Chemical Review), vol. 91, pp. 165-195 (1991).

A¹ and A² each independently represents a group selected from the group consisting of —O—, —NR— (R represents a hydrogen atom or a substituent), —S— and —CO—. preferred are —O—, —NR— (R represents a substituent, and examples of R include examples of R¹) or S—.

X represents a nonmetal atom of 14th to 16th group, provided that a hydrogen atom or a substituent may be bonded to X. X is preferably ═O, ═S, ═NR, and ═C(R)R (R represents a substituent, and examples of R include examples of R¹).

n represents an integer of from 0 to 2, and preferably is 0 and 1.

Specific examples of compounds represented by (II)-1 or (II)-2 are shown below, but examples of the retardation developer are not limited to the following specific examples. The following compounds are represented as exemplified compounds (X) using numbers in parenteses, unless specified otherwise.

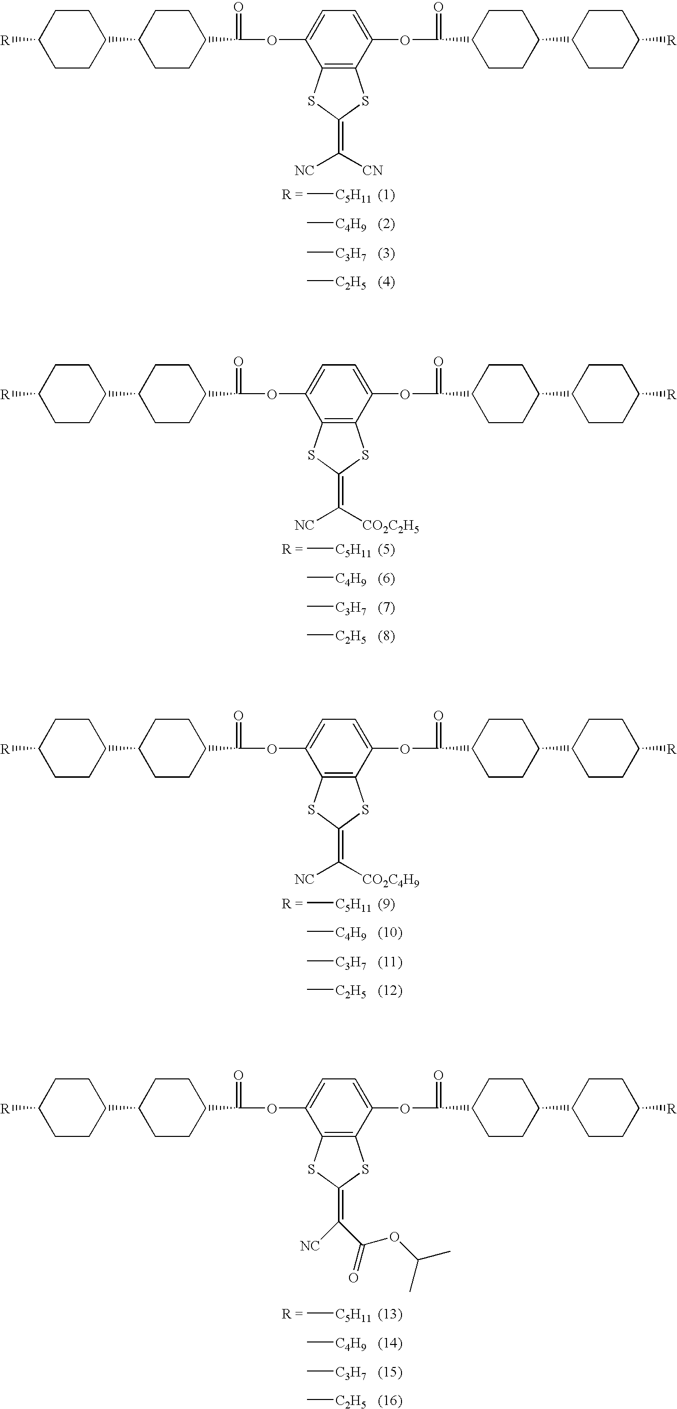

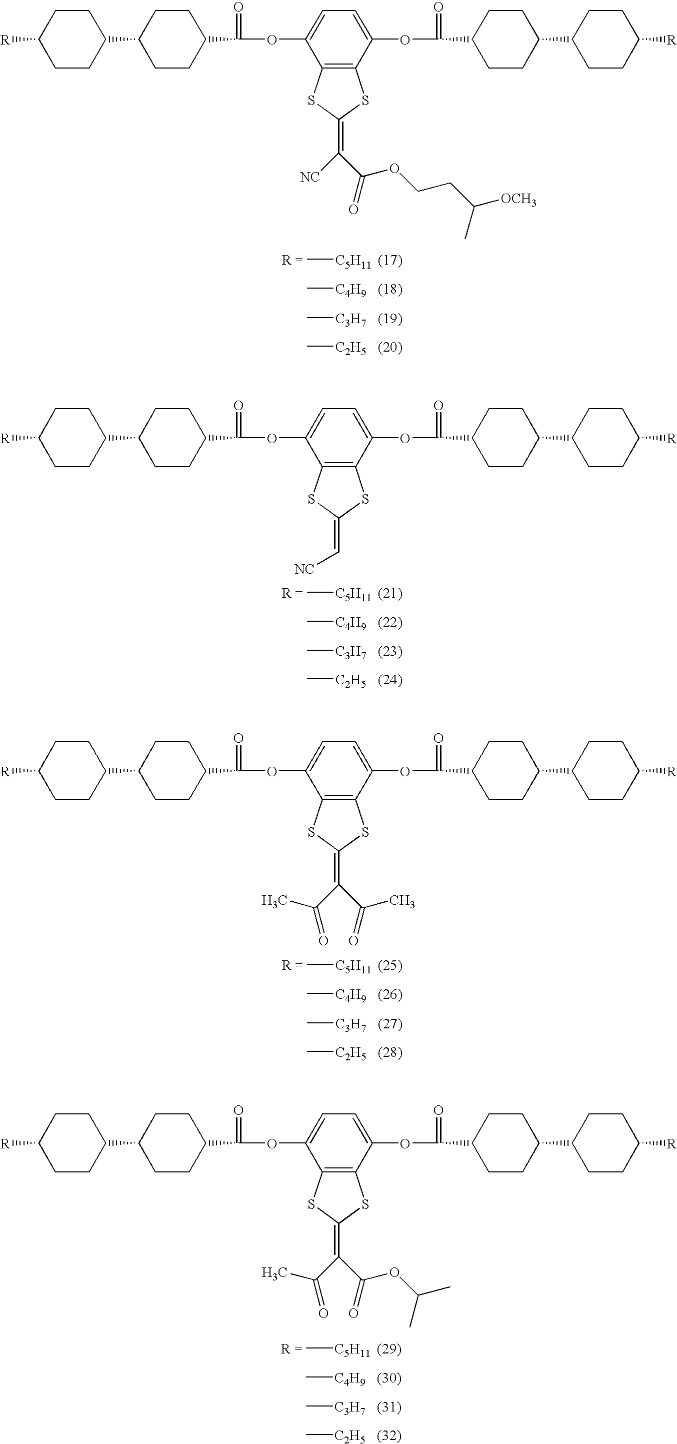

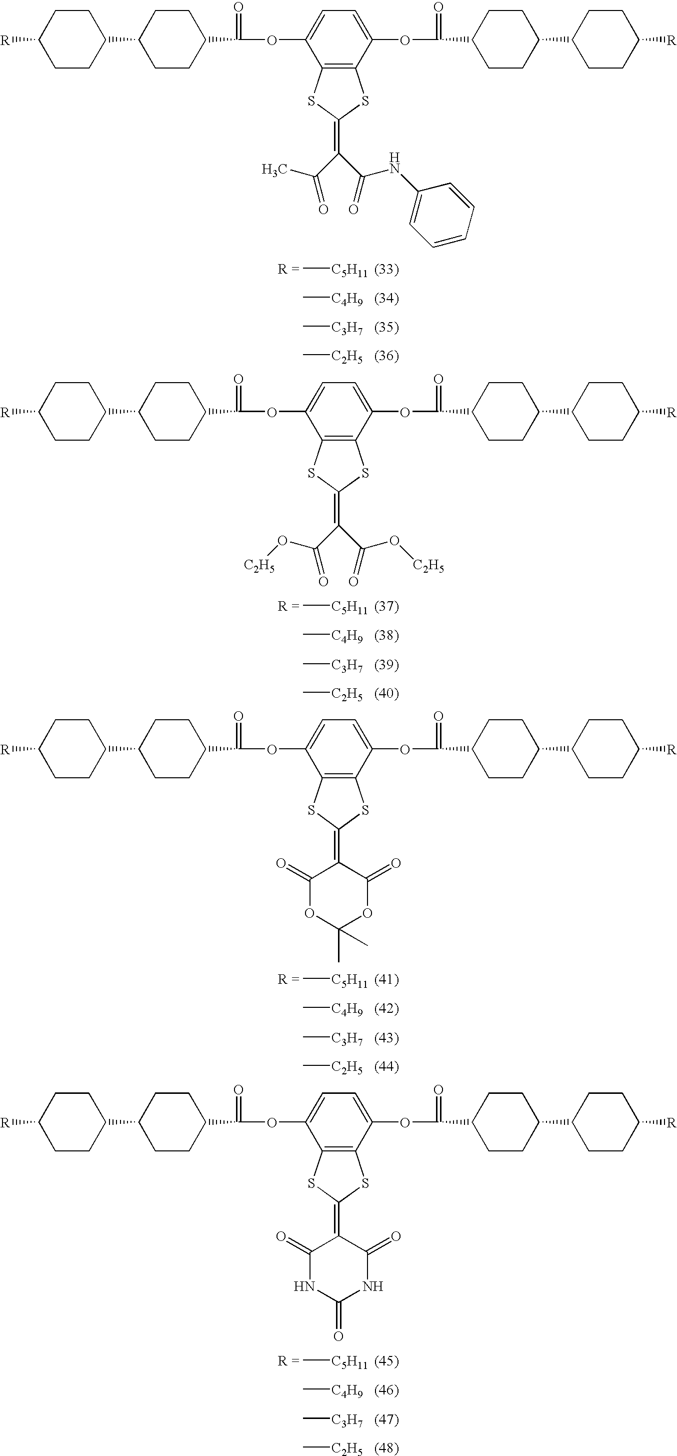

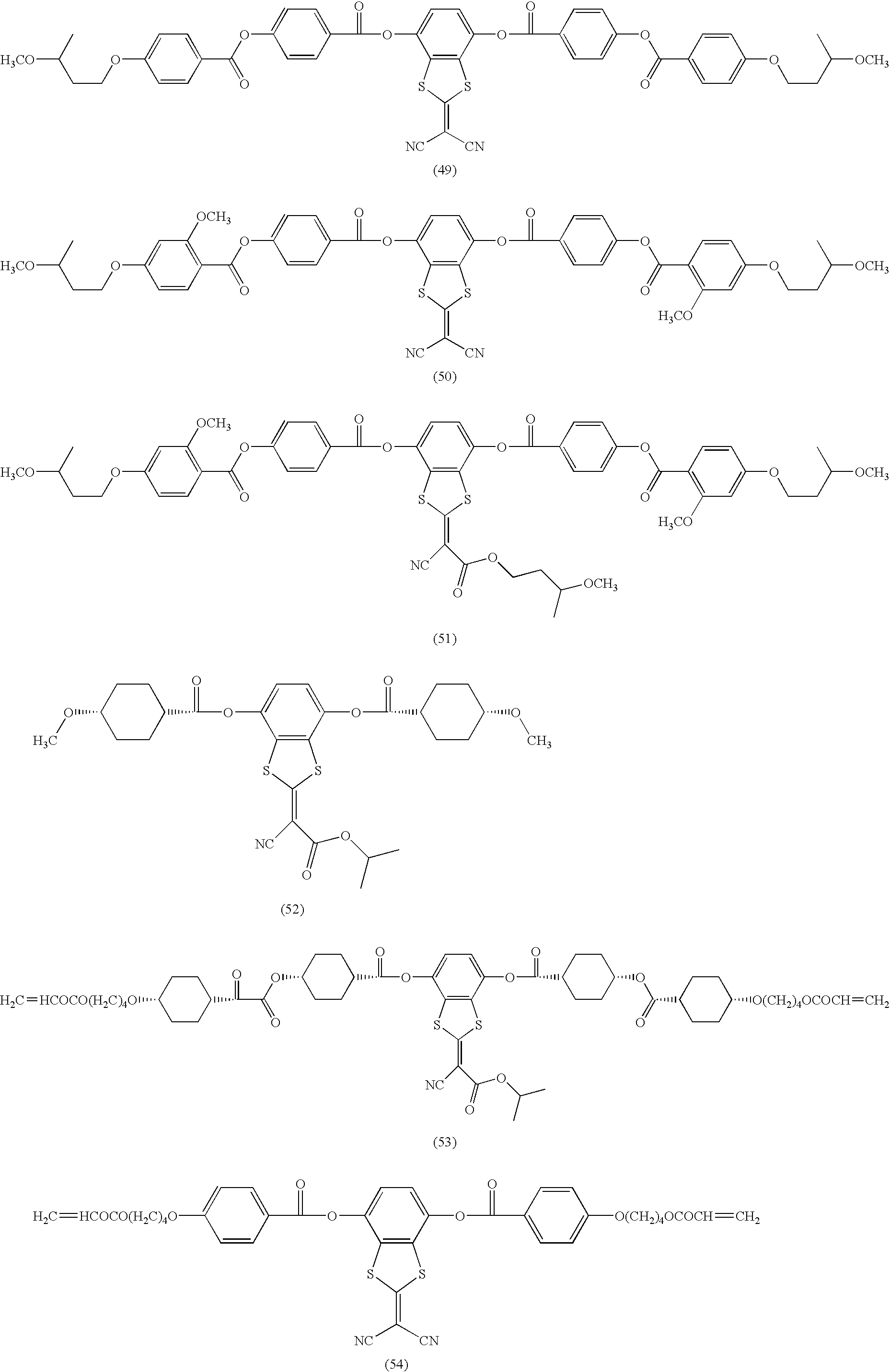

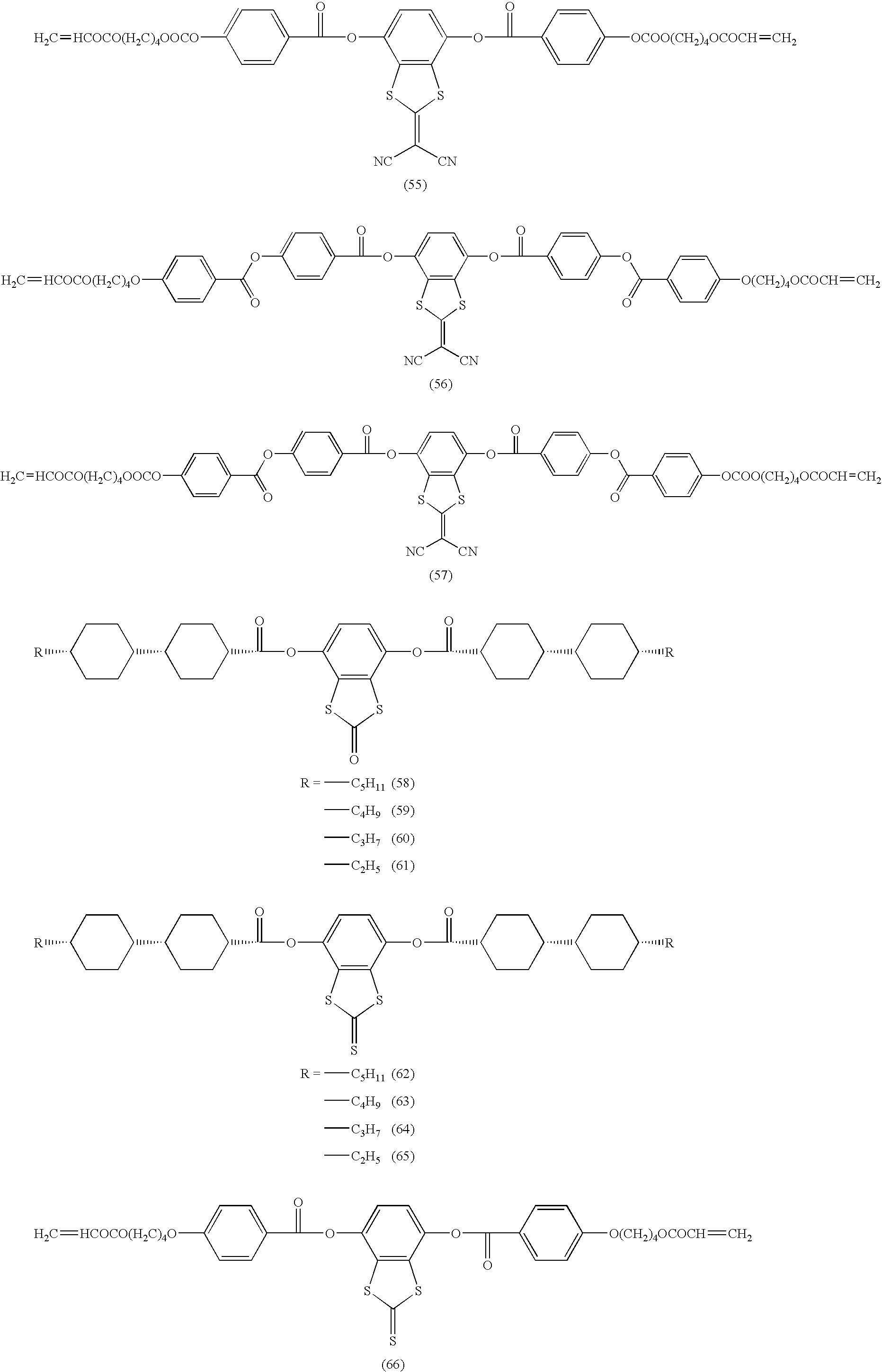

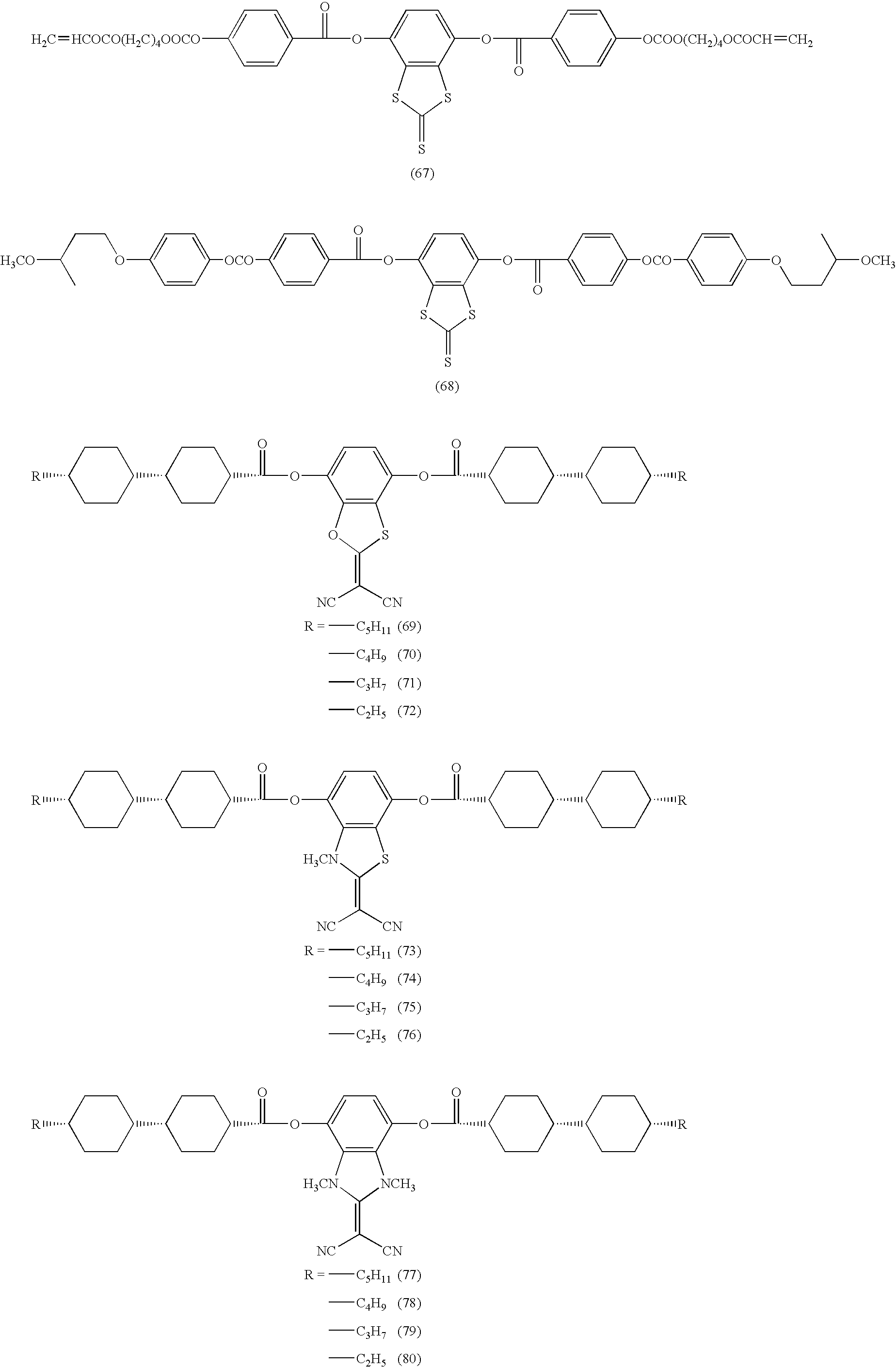

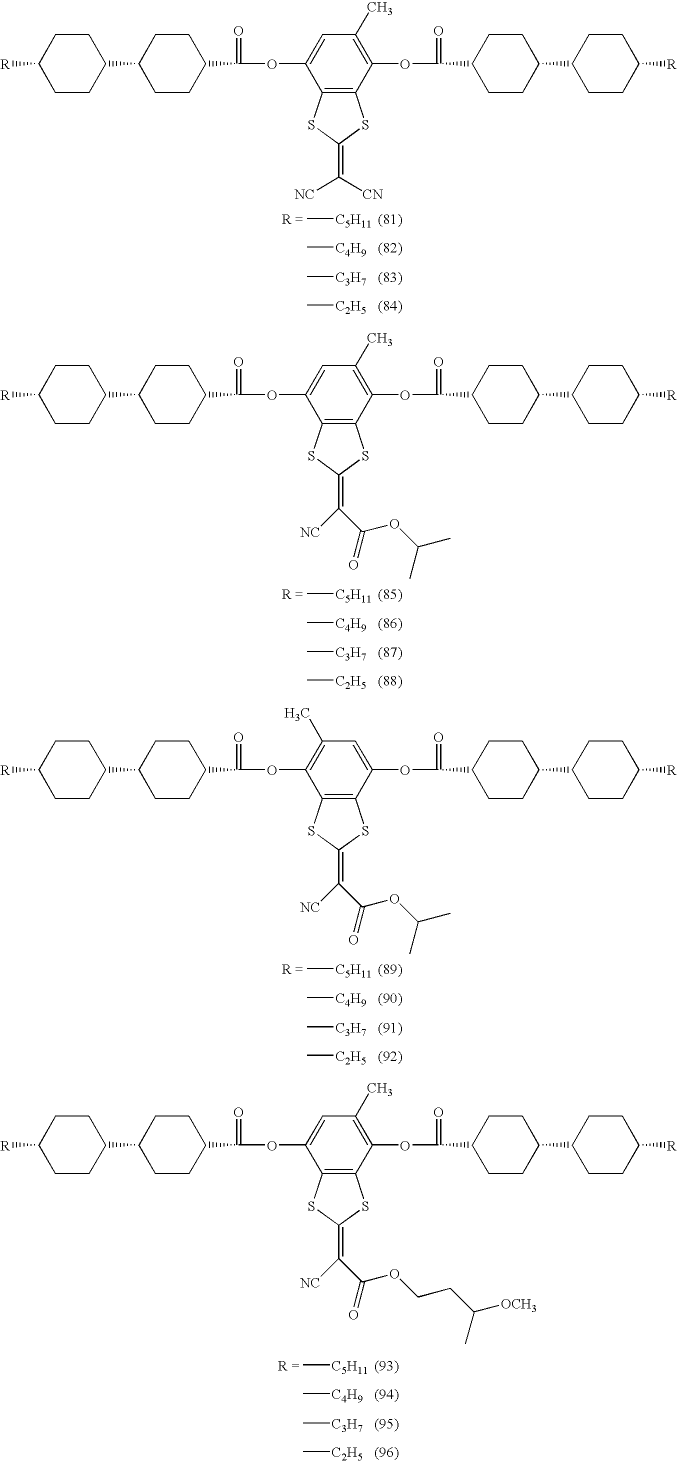

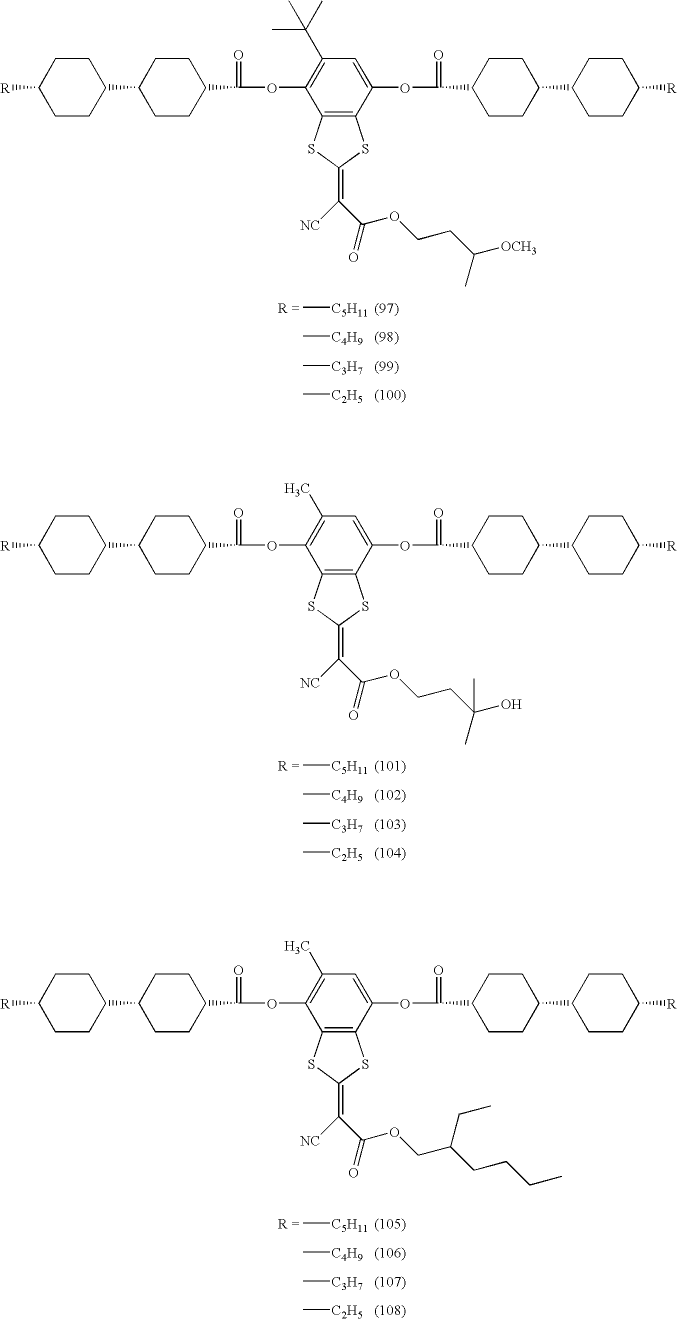

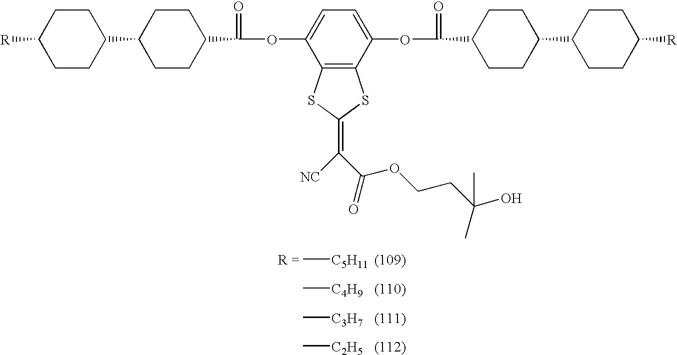

Synthesis of compounds represented by (II)-1 or (II)-2 may be performed by referring to known method. For example, exemplified compound (1) may be synthesized according to the following scheme.

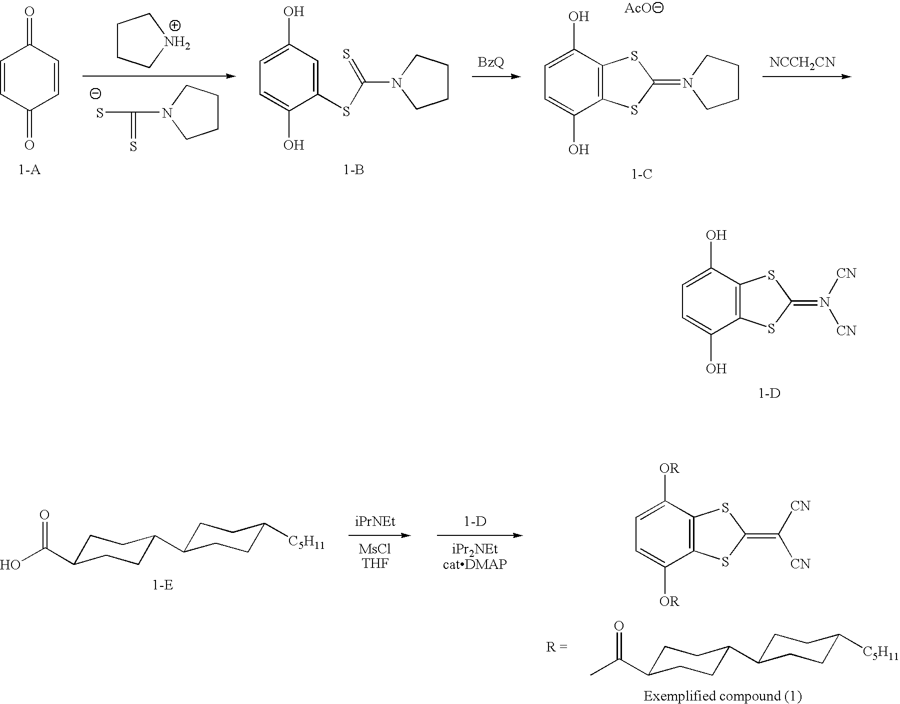

In the scheme, synthesis from compound (1-A) to compound (1-D) may be performed by referring to the method described in “Journal of Chemical Crystallography” (1997); 27(9); p 515-526.

Further, as shown in the scheme, Exemplified compound (1) may be obtained by adding methane sulfonyl chloride to the solution of compound (1-E) in tetrahydrofuran, dropping and stirring N,N-diisopropyl ethyl amine, following adding N,N-diisopropyl ethyl amine thereto, dropping the solution of compound (1-D) in tetrahydrofuran thereto, and then dropping solution of the N,N-dimethyl aminopyridine (DMAP) in tetrahydrofuran thereto.

Further, a rod aromatic compound described in p 11 to p 14 of JP-A-2004-50516 may be used as a retardation developer.

Further, as the retardation developer, one kind of the compound may be used alone or two or more kinds of compounds may be used by mixing. two kinds or more compounds which are different from each other are used as a retardation developer, which is preferred because the retardation developer which may have the wider adjustment range of retardation to be easily adjusted to desirable range.

The retardation developer may contain at least one kind of the compound represented by the following formula (III).

Ar¹-L¹²-X-L¹³-Ar² Formula (III)

In formula (III); Ar¹ and Ar² each independently represents an aromatic group, L¹² and L¹³ each independently represents a divalent connecting group selected from —O—CO— or CO—O— group, and X represents a 1,4-cyclohexylene group, a vinylene group, or an ethynylene group.

In the specification, an aromatic group includes an aryl group (aromatic hydrocarbon group), a substituted aryl group, an aromatic heterocyclic group, and a substituted aromatic heterocyclic group.

An aryl group and a substituted aryl group are more preferred than an aromatic heterocyclic group and a substituted aromatic heterocyclic group. A heterocyclic ring of the aromatic heterocyclic group is generally unsaturated. It is preferred that the aromatic heterocyclic ring is five-, six- or seven-membered rings, and is more preferably five- or six-membered rings. The aromatic heterocyclic ring generally has most double bonds. A hetero atom is preferably a nitrogen atom, an oxygen atom, or a sulfur atom, and more preferably a nitrogen atom and a sulfur atom.

An aromatic ring of the aromatic group is preferably a benzene ring, a furan ring, a thiophene ring, a pyrrol ring, an oxazole ring, a thiazol ring, an imidazole ring, a triazole ring, a pyridine ring, a pyrimidine ring, and a pyrazine ring, and particularly preferably a benzene ring.

Examples of substituents of a substituted aryl group and a substituted aromatic heterocyclic group include a halogen atom (F, Cl, Br, and I), a hydroxyl group, a carboxyl group, a cyano group, an amino group, an alkyl amino group (e.g., a methyl amino group, an ethyl amino group, a butyl amino group, and a dimethyl amino group), a nitro group, a sulfo group, a carbamoyl group, an alkyl carbamoyl group (e.g., an N-methyl carbamoyl group, an N-ethyl carbamoyl group, and an N,N-dimethyl carbamoyl group), a sulfamoyl group, an alkyl sulfamoyl group (e.g., an N-methyl sulfamoyl group, an N-ethyl sulfamoyl group, and an N,N-dimethyl sulfamoyl group), a ureido group, an alkyl ureido group (e.g., an N-methyl ureido group, an N,N-dimethyl ureido group, and an N,N,N′-trimethyl ureido group), an alkyl group (e.g., a methyl group, an ethyl group, a propyl group, a butyl group, a pentyl group, a heptyl group, an octyl group, an isopropyl group, a s-butyl group, a t-amyl group, a cyclohexyl group, and a cyclopentyl group), an alkenyl group (e.g., a vinyl group, an allyl group, and a hexenyl group), an alkynyl group (e.g., an ethynyl group, and a butynyl group), an acyl group (e.g., a formyl group, an acetyl group, a butyryl group, a hexanoyl group, and a lauryl group), an acyloxy group (e.g., an acetoxy group, butyryloxy group, a hexanoyloxy group, and a lauryloxy group), an alkoxy group (e.g., a methoxy group, an ethoxy group, a propoxy group, a butoxy group, a pentyloxy group, a heptyloxy group, and an octyloxy group), an aryloxy group (e.g., a phenoxy group), an alkoxy carbonyl group (e.g., a methyoxy carbonyl group, an ethoxy carbonyl group, a propoxy carbonyl group, a butoxy carbonyl group, a pentyloxy carbonyl group, and a heptyloxy carbonyl group), an aryloxy carbonyl group (e.g., a phenoxy carbonyl group), an alkoxy carbonyl amino group (e.g., a butoxy carbonyl amino group, and a hexyloxy carbonyl amino group), an alkyl thio group (e.g., a methyl thio group, an ethyl thio group, a propyl thio group, a butyl thio group, a pentyl thio group, a heptyl thio group, and an oxtyl thio group), an aryl thio group (e.g., a phenyl thio group), an alkyl sulfonyl group (e.g., a methyl sulfonyl group, an ethyl sulfonyl group, a propyl sulfonyl group, a butyl sulfonyl group, a pentyl sulfonyl group, a heptyl sulfonyl group, and an octyl sulfonyl group), an amido group (e.g., an acetoamido group, a butyl amido group, a hexyl amido group, and a lauryl amido group), and a nonaromatic heterocyclic group (e.g., a morpholyl group, and a pyrazinyl group).

Substituents of a substituted aryl group and a substituted aromatic heterocyclic group include preferably a halogen atom, a cyano group, a carboxyl group, a hydroxyl group, an amino group, an alkyl-substituted amino group, an acyl group, an acyloxy group, an amido group, an alkoxy carbonyl group, an alkoxy group, an alkyl thio group, and an alkyl group.

Alkyl moieties and alkyl groups of an alkyl amino group, an alkoxy carbonyl group, an alkoxy group, and an alkyl thio group may further have a substituent. Examples of substitutes of the alkyl moieties and the alkyl groups preferably include a halogen atom, hydroxyl, carboxyl, cyano, amino, and alkyl amino groups, nitro, sulfo, carbamoyl, alkyl carbamoyl groups, sulfamoyl, alkyl sulfamoyl groups, ureido, alkyl ureido groups, an alkenyl group, an alkynyl group, an acyl group, an acyloxy group, an acyl amino group, an alkoxy group, an aryloxy group, an alkoxy carbonyl group, an aryloxy carbonyl group, an alkoxy carbonyl amino group, an alkyl thio group, an aryl thio group, an alkyl sulfonyl group, an amido group, and a nonaromatic heterocyclic group. Substituents of alkyl moieties and alkyl groups are preferably a halogen atom, hydroxyl, amino, an alkylamino group, an acyl group, an acyloxy group, an acylamino group, an alkoxycarbonyl group, and an alkoxy group.

Specific examples of compounds represented by formula (III) are shown below, but examples of the retardation developer are not limited to the following specific examples.

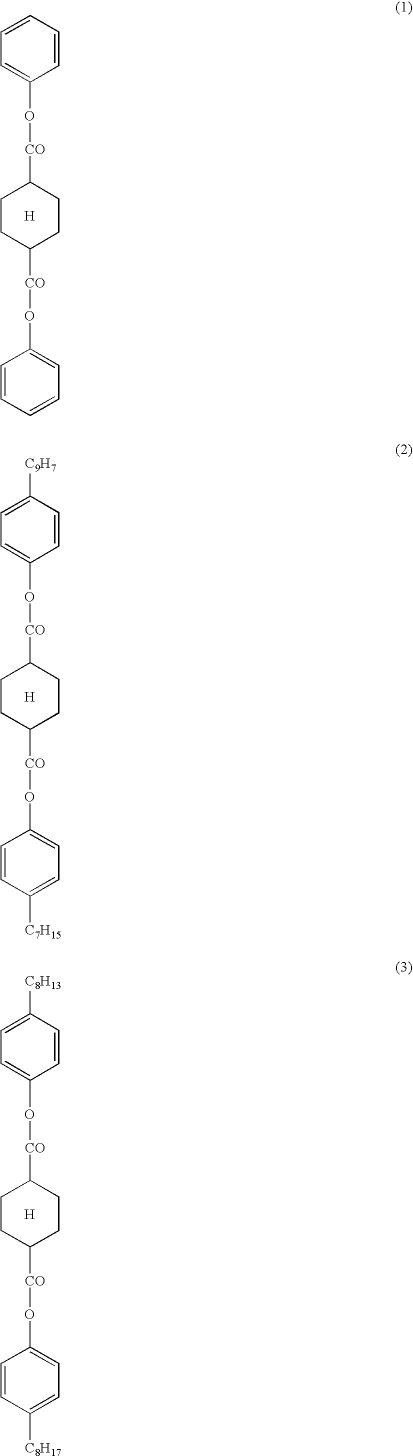

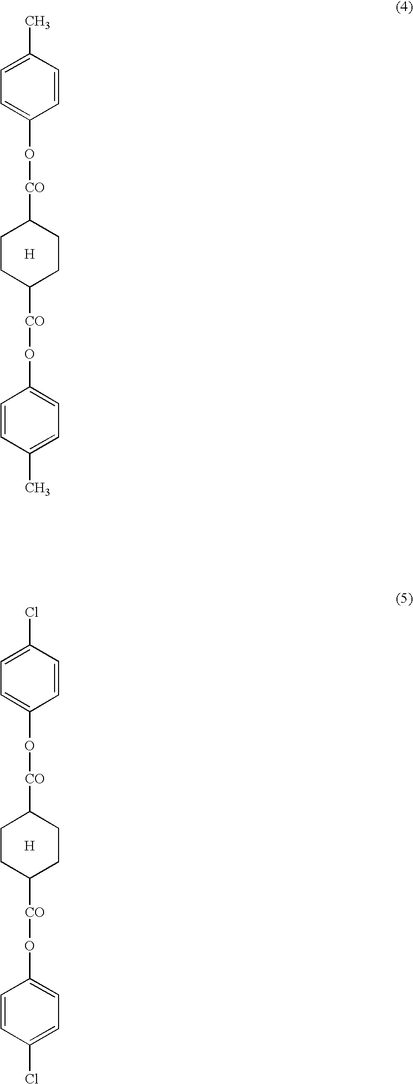

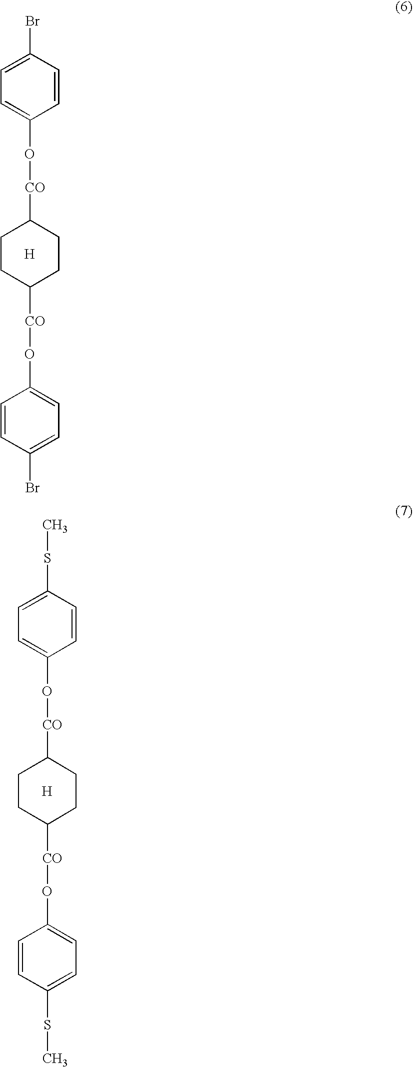

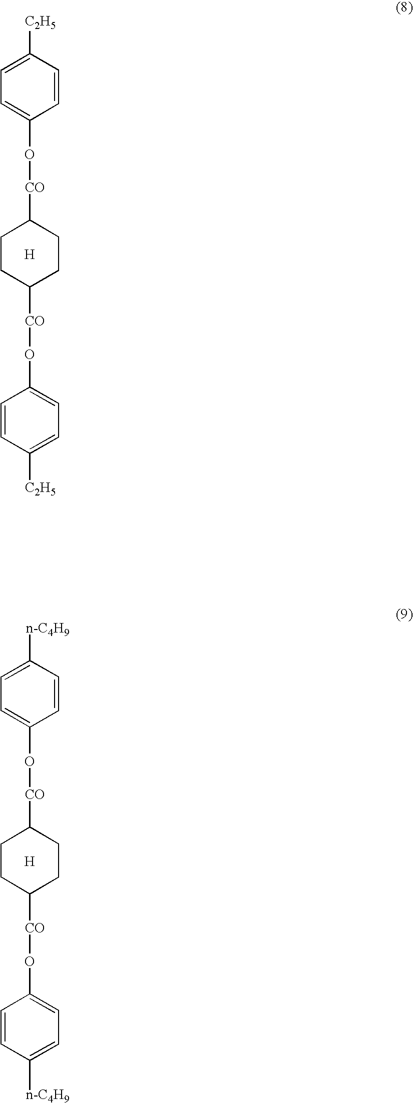

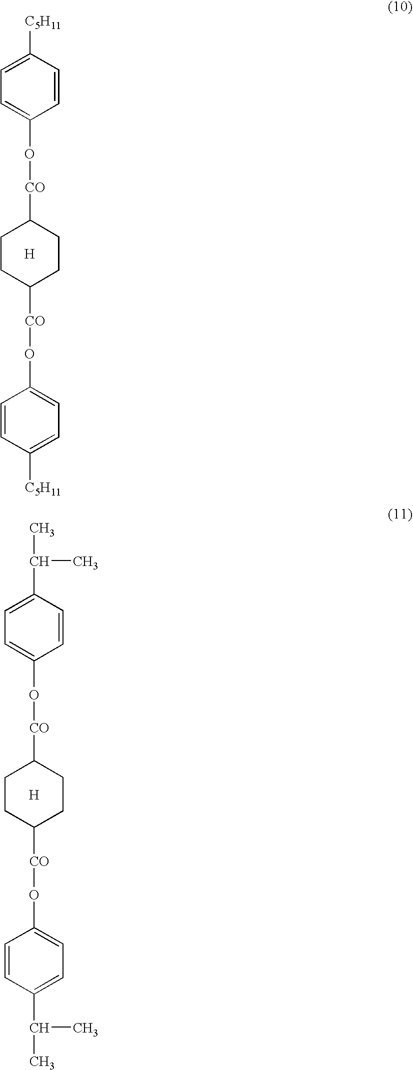

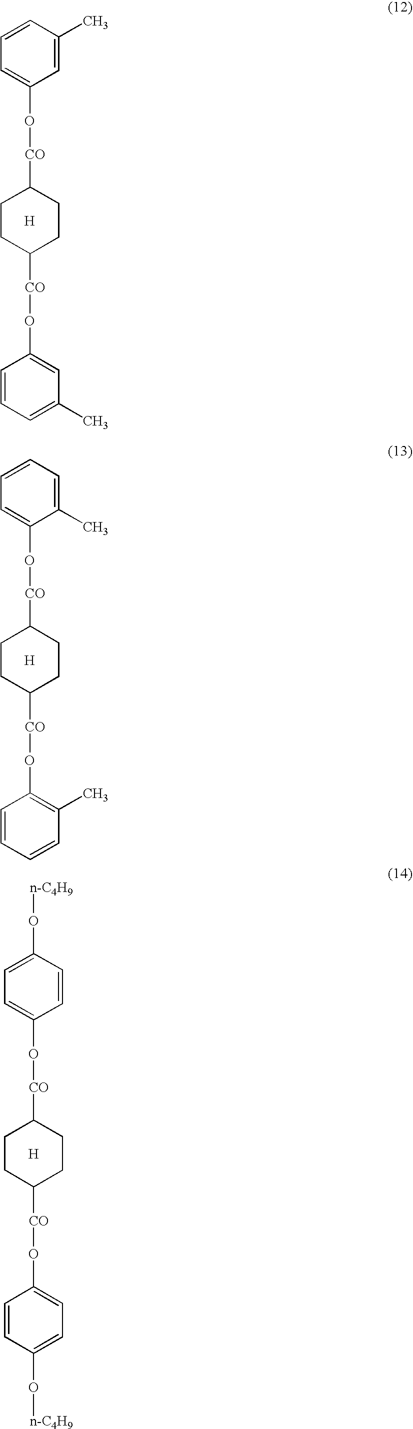

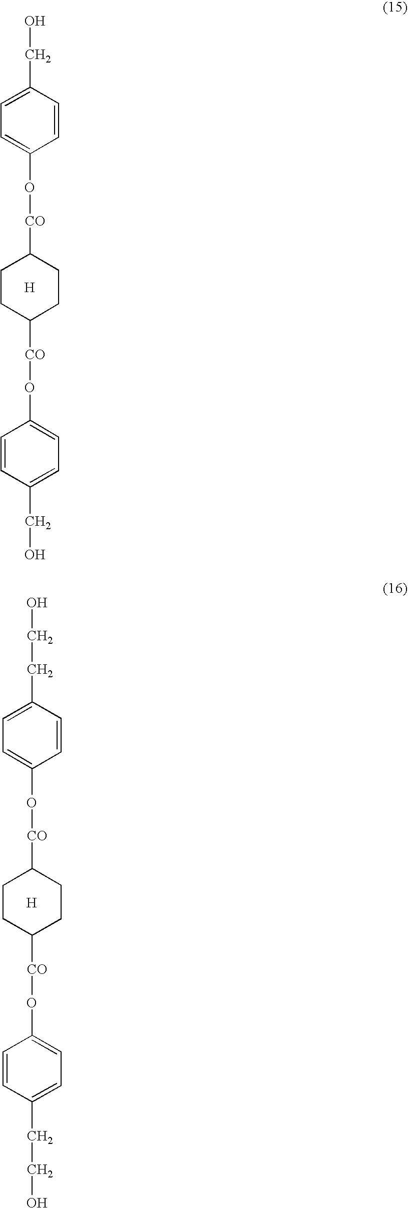

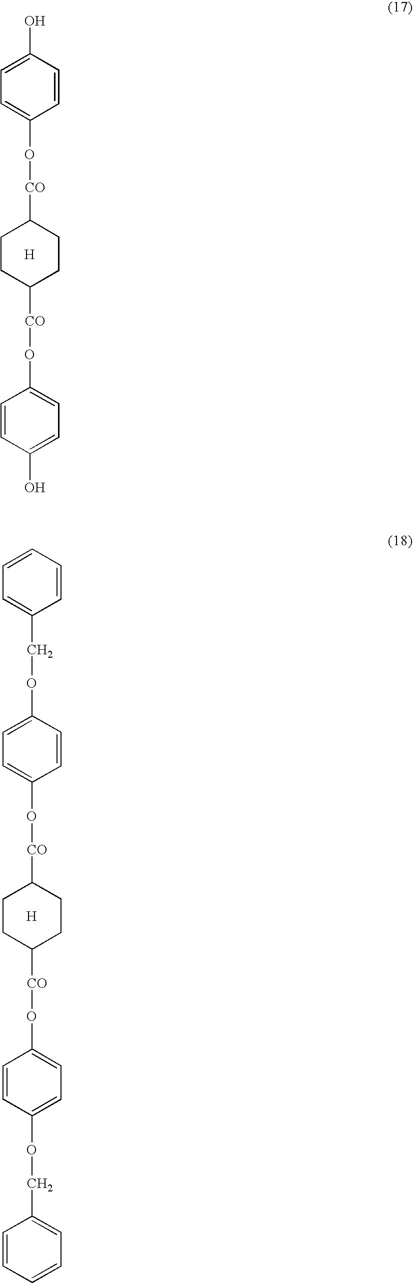

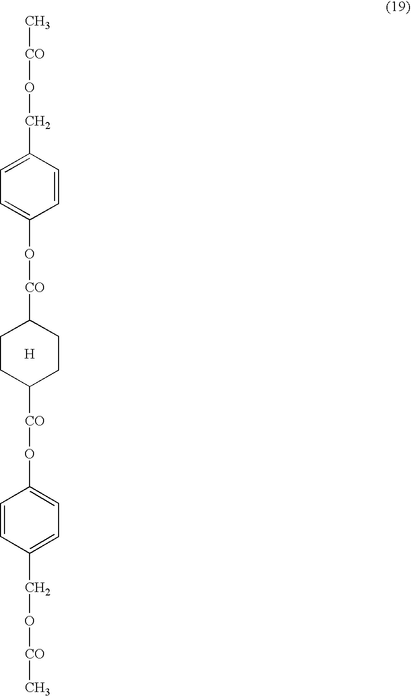

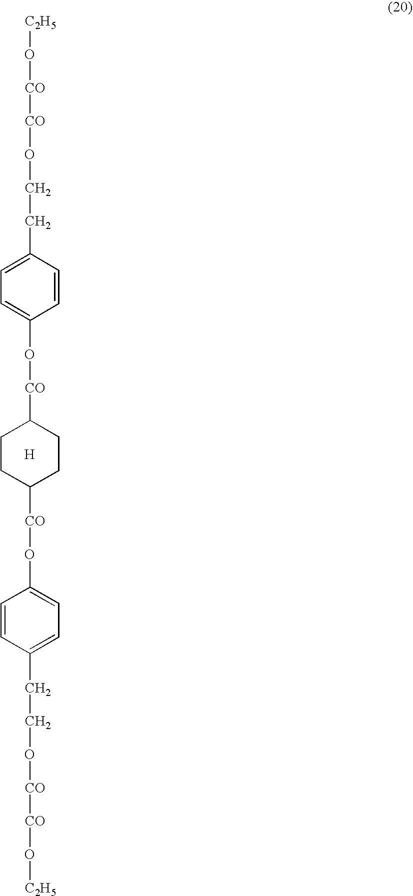

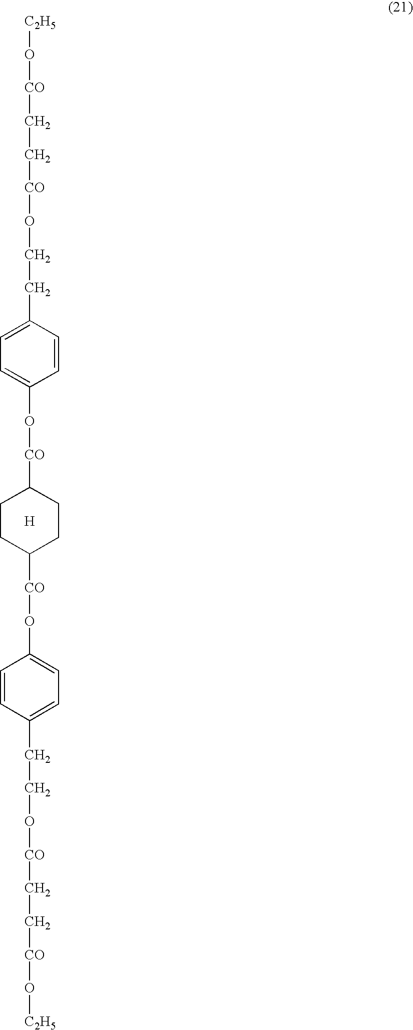

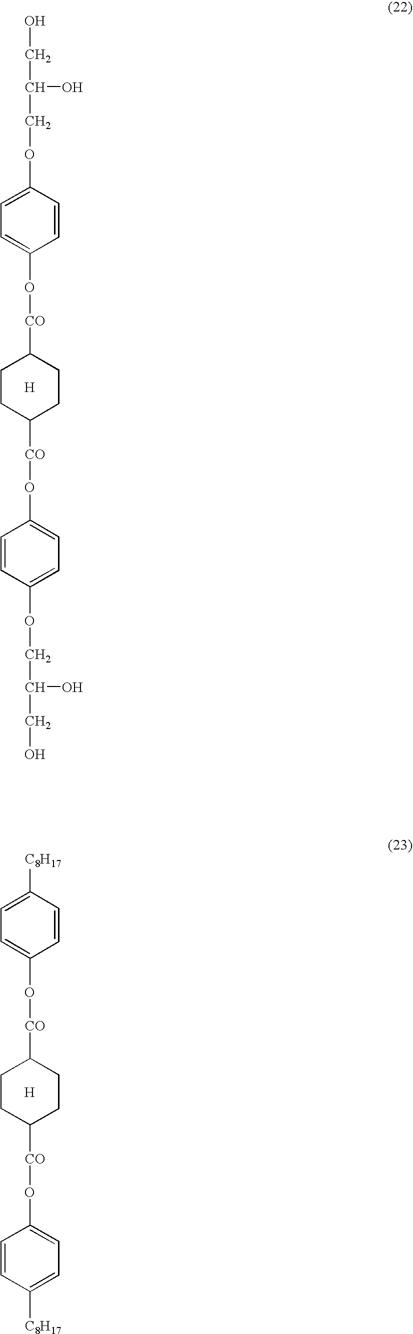

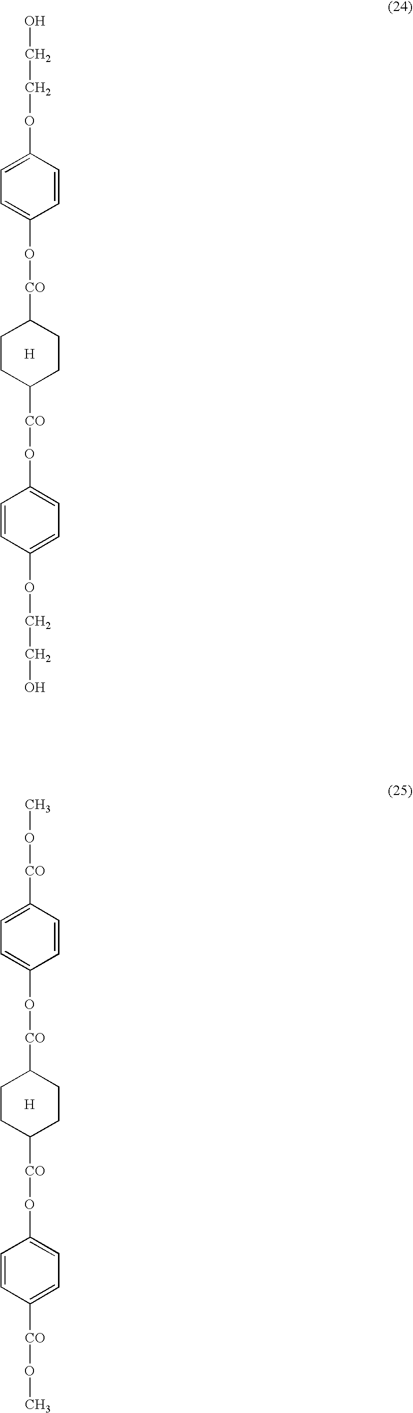

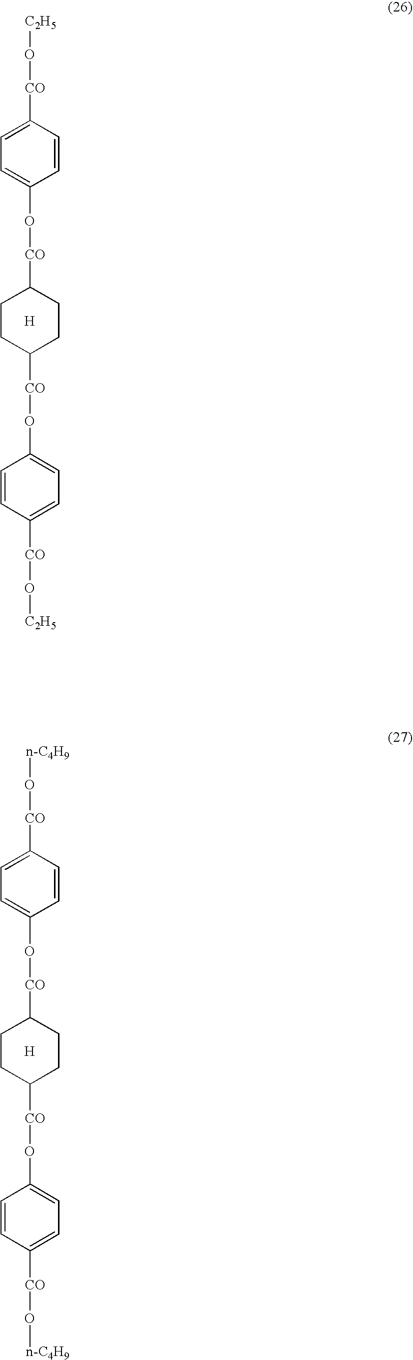

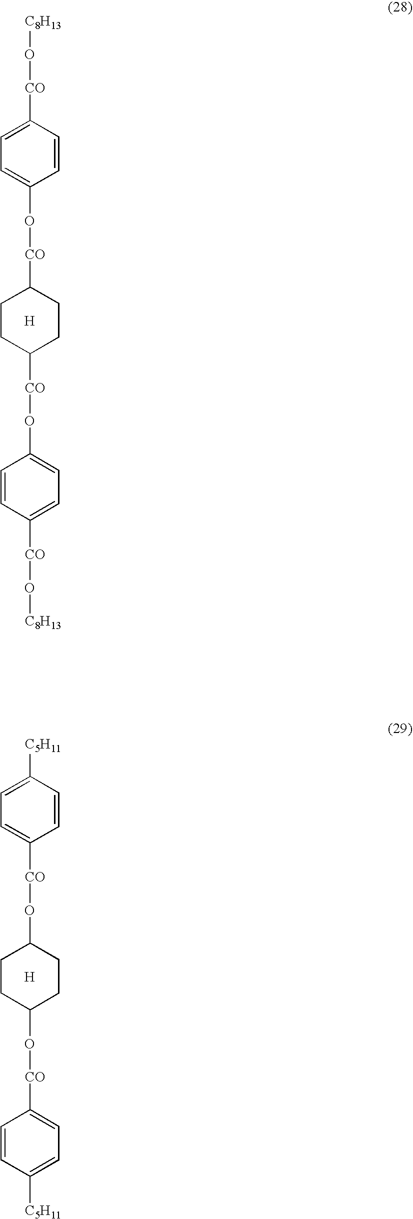

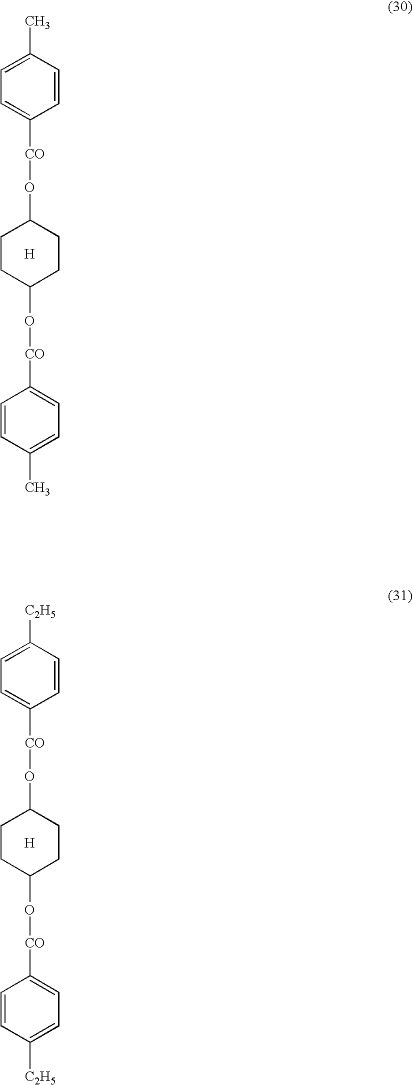

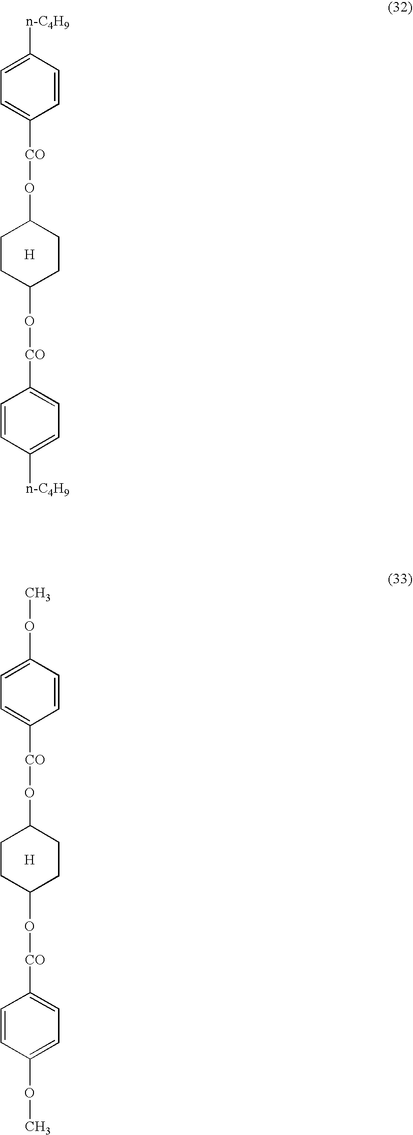

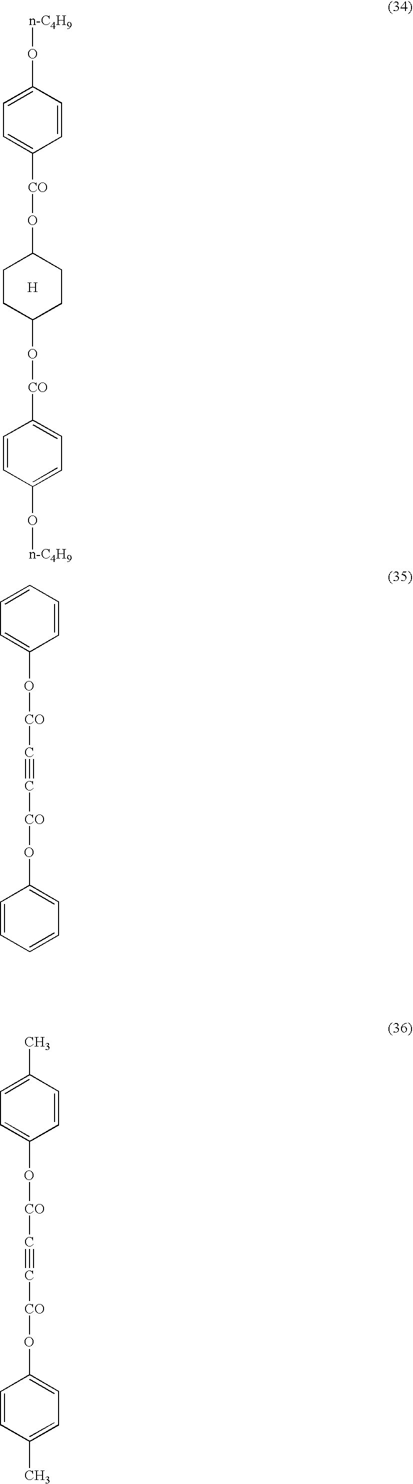

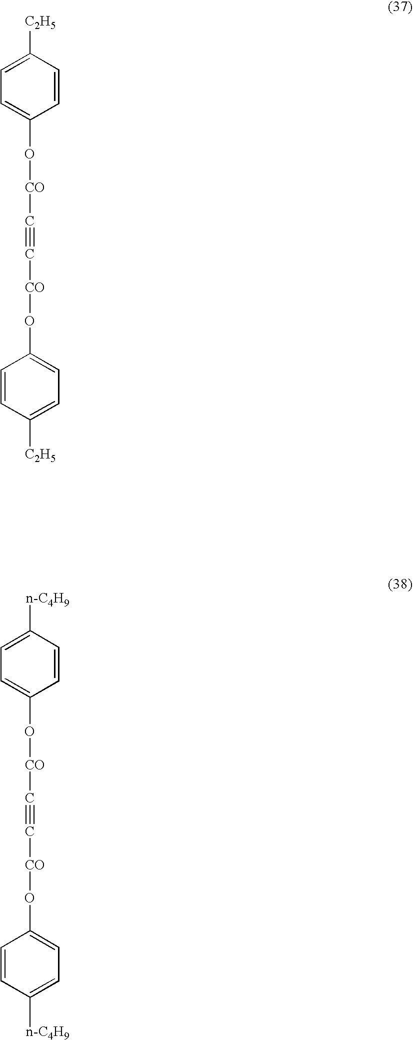

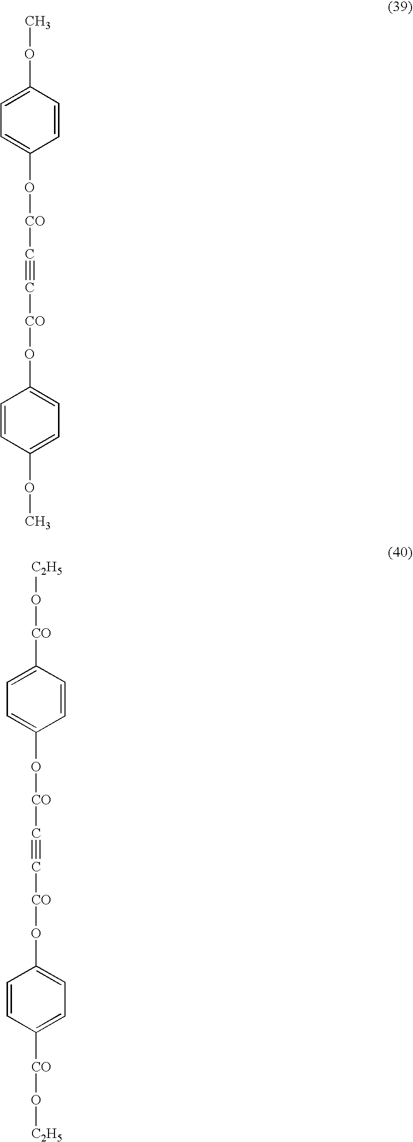

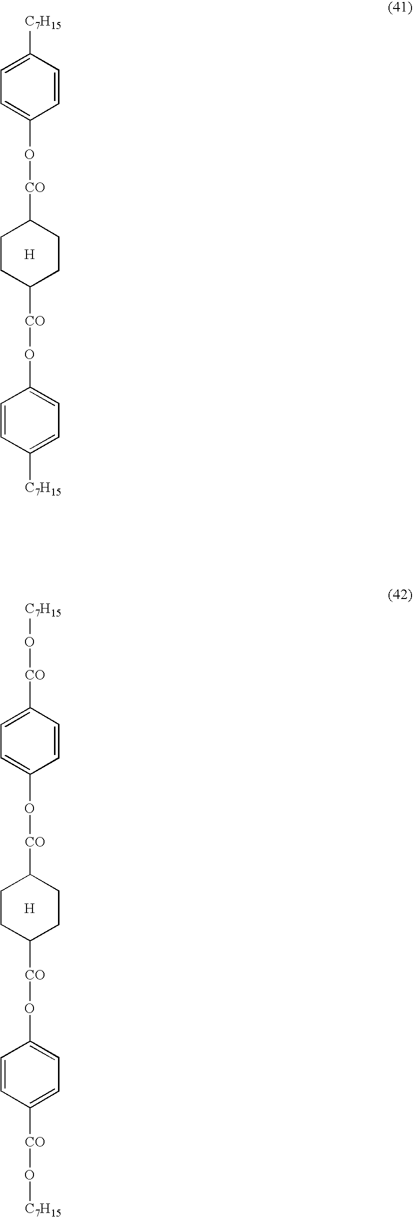

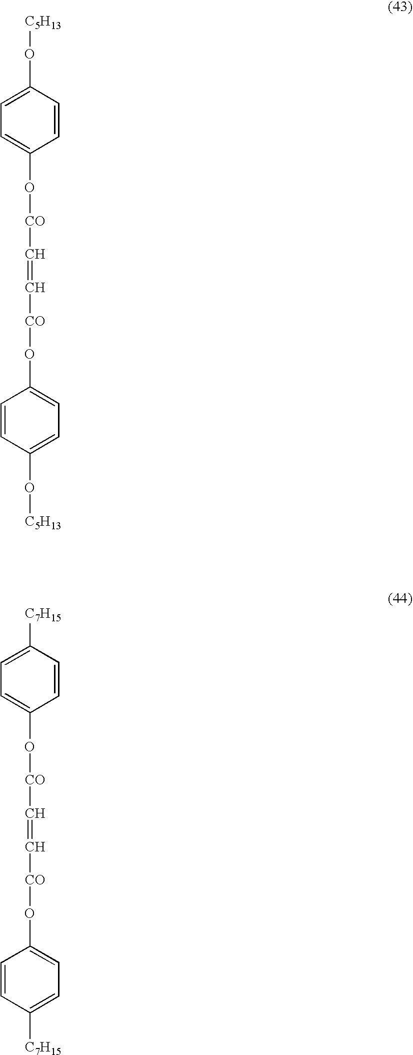

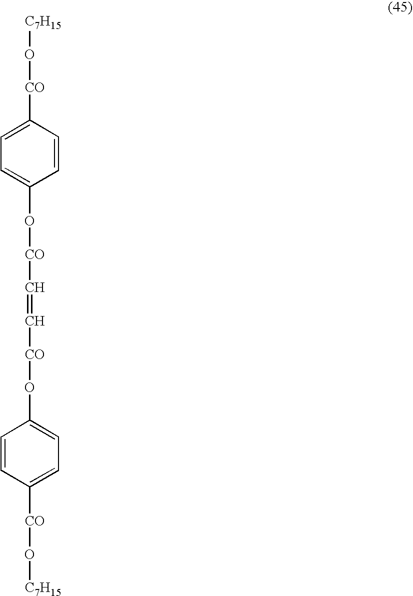

Specific examples (1) to (34), (41) and (42) have two asymmetric carbon atoms at 1-position and 4-position of a cyclohexane ring. Specific examples (1), (4) to (34), (41), and (42) have a symmetric meso type molecular structure, and therefore no optical isomer (optical activity) but only geometric isomer (trans- and cis-forms) is present. Trans form (1-trans) and cis form (1-cis) of specific example (1) are shown below.

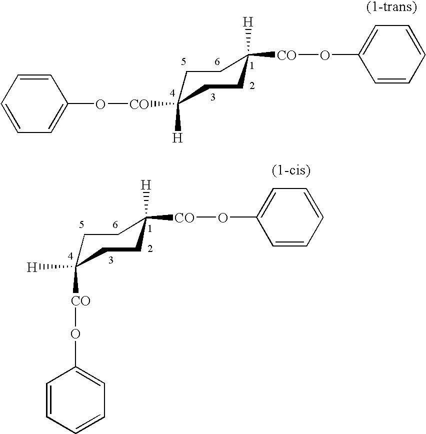

As described above, it is preferred that a rod-form compound has a linear molecular structure. Accordingly, trans-form is more preferred than cis-form.

Specific examples (2) and (3) have stereoisomers (total four kinds of isomers) in addition to geometric isomers. With reference to geometric isomers, trans-form is more preferred than cis-form as described above. In particularly optical isomers may be any one of D-form, L-form, and racemate, any of which can be employed nearly equally.

Specific examples (43) to (45) are trans-form and cis form with respect to the vinylene bond at the center. Trans form is more preferred than cis-form due to the reason as described above.

The retardation developer also is preferably a compound represented by the following formula (V).

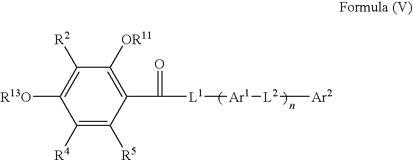

In formula (V), R², R⁴ and R⁵ each independently represents a hydrogen atom or a substituent, R¹¹ and R¹³ each independently represents a hydrogen atom or an alkyl group, and L¹ and L² each independently represents a single bond or a divalent connecting group. Ar¹ represents an arylene group or an aromatic heterocyclic ring, Ar² represents an aryl group or a an aromatic heterocyclic ring, and n represents an integer of 3 or more. n kinds of L² and Ar¹ each may be the same or different. However, R¹¹ and R¹³ are different from each other, and an alkyl group represented by R¹³ does not include a hetero atom.

In formula (V), R², R⁴ and R⁵ each independently represents a hydrogen atom or a substitutent.

Preferred R² in formula (V) is a hydrogen atom, an alkyl group, an alkoxy group, an amino group, and a hydroxyl group, more preferably a hydrogen atom, an alkyl group, and an alkoxy group, and further preferably an a hydrogen atom, an alkyl group (preferably from 1 to 4 carbon atoms, and more preferably a methyl group), and an alkoxy group (preferably from 1 to 12 carbon atoms, more preferably from 1 to 8 carbon atoms, further preferably from 1 to 6 carbon atoms, and particularly preferably from 1 to 4 carbon atoms). Particularly preferred are a hydrogen atom, a methyl group, and a methoxy group, and most preferably a hydrogen atom.

Preferred R⁴ in formula (V) is a hydrogen atom or an electron donating group, more preferably a hydrogen atom, an alkyl group, an alkoxy group, an amino group, and a hydroxyl group, further preferably a hydrogen atom, an alkyl group having from 1 to 4 carbon atoms, and an alkoxy group having from 1 to 12 carbon atoms (preferably from 1 to 12 carbon atoms, more preferably from 1 to 8 carbon atoms, further preferably from 1 to 6 carbon atoms, and particularly preferably from 1 to 4 carbon atoms), and particularly preferred are a hydrogen atom, an alkyl group having from 1 to 4 carbon atoms, and an alkoxy group having from 1 to 4 carbon atoms, and most preferably a hydrogen atom and a methoxy group.

Preferred R⁵ in formula (V) is a hydrogen atom, a halogen atom, an alkyl group, an alkoxy group, an amino group, and a hydroxyl group, more preferably a hydrogen atom, an alkyl group, and an alkoxy group, and further preferably an a hydrogen atom, an alkyl group (preferably from 1 to 4 carbon atoms, and more preferably a methyl group), and an alkoxy group (preferably from 1 to 12 carbon atoms, more preferably from 1 to 8 carbon atoms, further preferably from 1 to 6 carbon atoms, and particularly preferably from 1 to 4 carbon atoms). Particularly preferred are a hydrogen atom, a methyl group, and a methoxy group, and most preferably a hydrogen atom.

R¹¹ and R¹³ in formula (V) each independently represents a hydrogen atom or an alkyl group, R¹¹ and R¹³ are different from each other, and an alkyl group represented by R¹³ does not include a hetero atom. The hetero atom represents an atom other than a hydrogen atom and a carbon atom, and includes an oxygen atom, a nitrogen atom, a sulfur atom, phosphorus, silicon, halogen atoms (F, Cl, Br and I), and boron.

An alkyl group represented by R¹¹ and R¹³ may be linear, branched, or cyclic, and represent substituted or unsubstituted alkyl group, preferably substituted or unsubstituted alkyl group having from 1 to 30 carbon atoms, a substituted or unsubstituted cycloalkyl group having from 3 to 30 carbon atoms, a substituted or unsubstituted bicycloalkyl group having from 5 to 30 carbon atoms (i.e., monovalent group removing one hydrogen from bicycloalkane having from 5 to 30 carbon atoms), and further tricyclo-structures having many ring structures.

Preferred examples of an alkyl group represented by R¹¹ and R¹³ include methyl, ethyl, n-propyl, isopropyl, n-butyl, sec-butyl, t-butyl, an n-pentyl group, an iso-pentyl group, an n-hexyl group, an n-heptyl group, an n-octyl group, a tert-octyl group, a 2-ethylhexyl group, an n-nonyl group, a 1,1,3-trimethyl hexyl group, an n-decyl group, a 2-hexyl decyl group, a cyclohexyl group, a cycloheptyl group, a 2-hexenyl group, an oleyl group, a linoleyl group, and linolenyl group. Further a cyclcoalkyl group includes cyclohexyl, cyclopentyl, and 4-n-dodecyl cyclohexyl. A bicycloalkyl group includes bicyclo[1,2,2]heptan-2-yl, and bicyclo[2,2,2]octan-3-yl.

R¹¹ is further preferably a hydrogen atom, a methyl group, an ethyl group, an n-propyl group, and an isopropyl group, particularly preferably a hydrogen atom, and a methyl group, and most preferably a methyl group.

R¹³ is particularly preferably an alkyl group containing 2 or more carbon atom, and more preferably an alkyl group containing 3 or more carbon atom. Branched or cyclic structure is particularly preferably used.

Specific examples (O-1 to O-20) of an alkyl group represented by R¹³ are described below, but the invention is not at all limited to the following specific examples. In the following specific examples, “#” means an oxygen atom side.

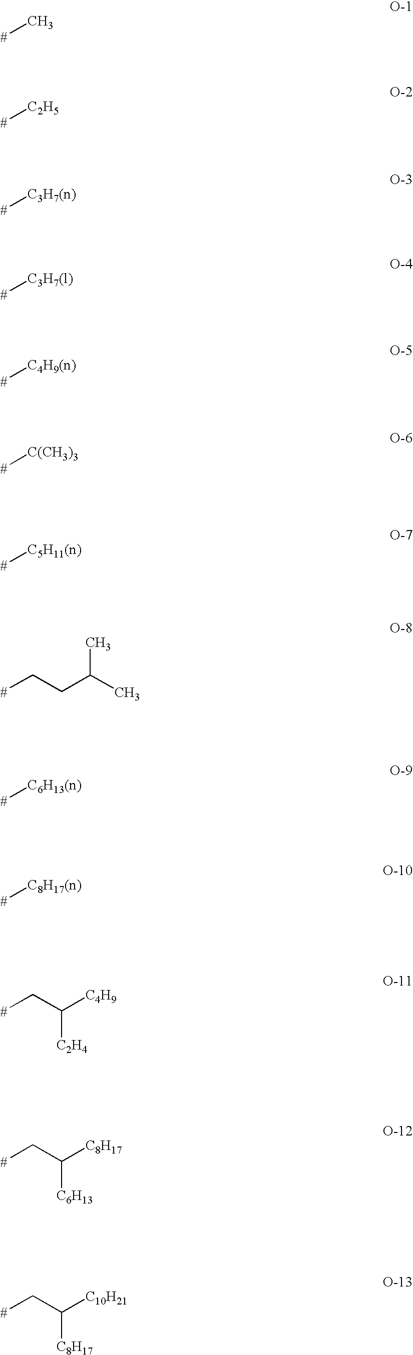

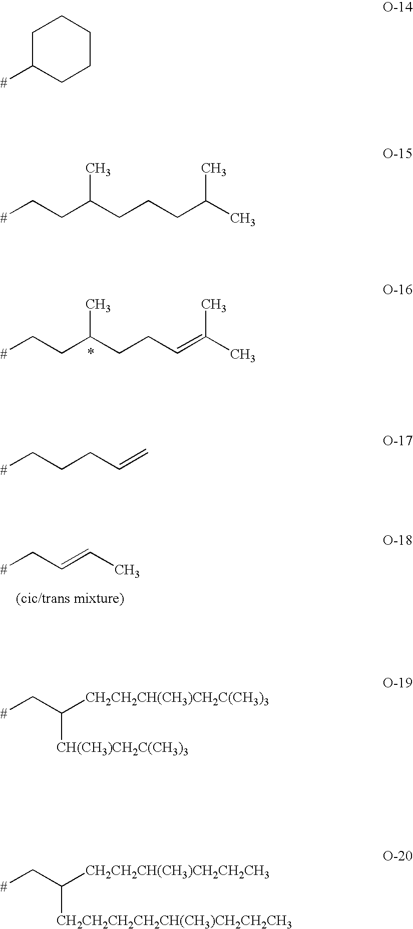

In formula (V), Ar¹ represents an arylene group or an aromatic heterocyclic ring, and all of Ar¹ of repetition unit may be the same or different. Further, Ar² represents an aryl group or an aromatic heterocyclic ring.

In formula (V), the arylene group represented by Ar¹ is preferably an arylene group having from 6 to 30 carbon atoms, and may be a single ring, or form a ring condensed with other rings. Further, if possible, the arylene group may have a substituent, and the substituent T described below may be applied as the substituent. The arylene group represented by Ar¹ is more preferably from 6 to 20 carbon atoms, and particularly from 6 to 12 carbon atoms, for example, a phenylene group, a p-methyl phenylene group, and a naphtylene group.

In formula (V), the aryl group represented by Ar² is preferably the aryl group having 6 to 30 carbon atoms, and may be a single ring or form a ring condensed with other rings. Further, if possible, the aryl group may have a substituent, and the substituent T described below may be applied as the substituent. The aryl group represented by Ar² is more preferably from 6 to 20 carbon atoms, and particularly from 6 to 12 carbon atoms, for example, a phenyl group, a p-methyl phenyl group, and a naphtyl group.

In formula (V), the aromatic heterocyclic ring represented by Ar¹ and Ar² may be an aromatic heterocyclic ring containing at least one of an oxygen atom, a nitrogen atom, or a sulfur atom, and preferably a five- or six-membered aromatic heterocyclic ring containing at least one of an oxygen atom, a nitrogen atom, or a sulfur atom. Further, if possible, the aromatic heterocyclic ring may further have a substituent. The substituent T described below may be applied as the substituent.

In formula (V), specific examples of the aromatic heterocyclic ring represented by Ar¹ and Ar² include furan, pyrrole, thiopene, imidazole, pyrazole, pyridine, pyrazine, pyridazine, triazole, triazine, indole, indazole, furine, thiazoline, thiazole, thiadiazole, oxazoline, oxazole, oxadiazole, quinoline, isoquinoline, phthalazine, naphthylidine, quinoxaline, quinazoline, cinnoline, pteridine, acridine, phenanthroline, phenazine, tetrazole, benzimidazole, benzoxazole, benzthiazole, benztriazole, tetrazaindene, pyrrolotriazole, and pyrazolotriazole. Preferred aromatic heterocyclic ring is benzimidazole, benzoxazole, benzthizole, and benztriazole.

In formula (V), L¹ and L² each independently represents a single bond or a divalent connecting group. L¹ and L² may be the same or different. All of L² in repetition unit may be the same or different.

Preferred divalent connecting group is —O—, —NR—(R represents a hydrogen atom, or an alkyl group or an aryl group which may have a substituent), —CO—, —SO₂—, —S—, an alkylene group, a substituted alkylene group, an alkenylene group, a substituted alkenylene group, an alkynylene group, and a group obtained by the combination of two or more of these divalent groups. Among these, more preferred are —O—, —NR—, —CO—, —SO₂NR—, —NRSO₂—, —CONR—, —NRCO—, —COO—, OCO—, and an alkynylene group. R represents preferably a hydrogen atom.

In the compound represented by formula (V) in the invention, Ar¹ is combined with L¹ and L², but it is particularly preferred that L¹-Ar¹-L² and L²-Ar¹-L² are in relation of para position (1,4-position) to each other when Ar¹ is a phenylene group.

In formula (V), n represents an integer of 3 or more, preferably from 3 to 7, more preferably from 3 to 6, and further preferably from 3 to 5.

As the compound represented by formula (V), the compound represented by the following formulae (V)-1 and (V)-2 may particularly preferably be used.

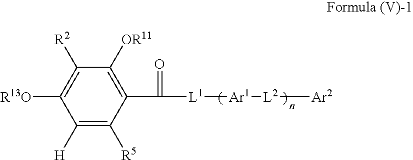

In formula (V)-1, R² and R⁵ each independently represents a hydrogen atom or a substituent, R¹¹ and R¹³ each independently represents a hydrogen atom or an alkyl group, and L¹ and L² each independently represents a single bond or a divalent connecting group. Ar¹ represents an arylene group or an aromatic heterocyclic ring, Ar² represents an aryl group or an aromatic heterocyclic ring, n represents an integer of 3 or more, and n kinds of L² and Ar¹ may be the same or different. However, R¹¹ and R¹³ are different from each other, and the alkyl group represented by R¹³ does not include a hetero atom.

In formula (V)-1, R², R⁵, R¹¹, and R¹³, have the same meanings as those in formula (V), and the preferred range thereof is also the same as that in formula (V). Further, L¹, L², Ar¹ and Ar² have the same meanings as those in formula (V), and the preferred range thereof is also the same as that in formula (V).).

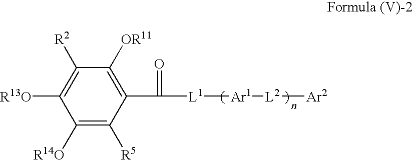

In formula (V)-2, R² and R⁵ each independently represents a hydrogen atom or a substituent, R¹¹, R¹³, and R¹⁴ each independently represents a hydrogen atom or an alkyl group, and L¹ and L² each independently represents a single bond or a divalent connecting group. Ar¹ represents an arylene group or an aromatic heterocyclic ring, Ar² represents an aryl group or an aromatic heterocyclic ring, n represents an integer of 3 or more, and n kinds of L² and Ar¹ may be the same or different. However, R¹¹ and R¹³ are different from each other, and the alkyl group represented by R¹³ does not include a hetero atom.

In formula (V)-2, R², R⁵′ R¹¹, and R¹³′ have the same meanings as those in formula (V), and the preferred range thereof is also the same as that in formula (V).). Further, L¹, L², Ar¹ and Ar² have the same meanings as those in formula (V), and the preferred range thereof is also the same as that in formula (V).).

In formula (V)-2, R¹⁴ represents a hydrogen atom or an alkyl group, the alkyl group represented by preferred examples of R¹¹ and R¹³ is preferably used as an alkyl group. Preferred R¹⁴ is a hydrogen atom or an alkyl group having from 1 to 4 carbon atoms, more preferably a hydrogen atom, or an alkyl group having from 1 to 3 carbon atoms, and more preferably a methyl group. R¹¹ and R¹⁴ may be the same or different, and a methyl group is particularly preferred for R¹¹ and R¹⁴.

Further, a compound represented by formula (V)-2 preferably is a compound represented by formula (V)-2-A or formula (V)-2-B.

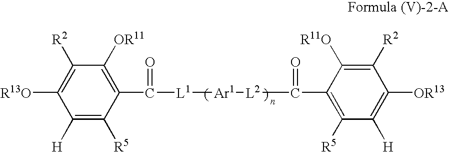

In formula (V)-2-A, R² and R⁵ each independently represents a hydrogen atom or a substituent, R¹¹ and R¹³, and each independently represents a hydrogen atom or an alkyl group, and L¹ and L² each independently represents a single bond or a divalent connecting group. Ar¹ represents an arylene group or an aromatic heterocyclic ring, n represents an integer of 3 or more, and n kinds of L² and Ar¹ may be the same or different respectively. However, R¹¹ and R¹³ are different from each other, and the alkyl group represented by R¹³ does not include a hetero atom.

In formula (V)-2-A, R², R⁵′ R¹¹, R¹³, L¹, L², Ar¹, and n have the same meanings as those in formula (V), and the preferred range thereof is also the same as that in formula (V).

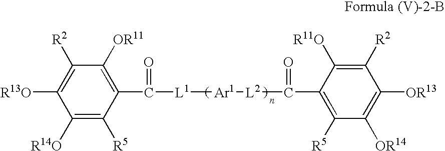

In formula (V)-2-B, R² and R⁵ each independently represents a hydrogen atom or a substituent, R¹¹′ R¹³, and R¹⁴ each independently represents a hydrogen atom or an alkyl group, and L¹ and L² each independently represents a single bond or a divalent connecting group. Ar¹ represents an arylene group or an aromatic heterocyclic ring, n represents an integer of 3 or more, and n kinds of L¹ and Ar¹ may be the same or different respectively. However, R¹¹ and R¹³ are different each other, and the alkyl group represented by R¹³ does not include a hetero atom.

In formula (V)-2-B, R², R⁵′ R¹¹, R¹³, R¹⁴, L¹, L², Ar¹, and n, have the same meanings as those in formula (V) and (V)-2, and the preferred range thereof is also the same as that in formula (V) and (V)-2.

The substituent T is described below.

Preferred substituent T includes a halogen atom (for example, a fluorine atom, a chlorine atom, a bromine atom, and an iodine atom), an alkyl group (preferably, alkyl group having from 1 to 30 carbon atoms, for example, a methyl group, an ethyl group, n-propyl group, an isopropyl group, a tert-butyl group, an n-octyl group, and a 2-ethylhexyl group), a cycloalkyl group (preferably, a substituted or unsubstituted cycloalkyl group having from 3 to 30 carbon atoms, for example, a cyclohexyl group, a cyclopentyl group, and 4-n-dodecyl cyclohexyl group), a bicycloalkyl group (preferably, a substituted or unsubstituted bicycloalkyl group having from 5 to 30 carbon atoms, that is, a monovalent group which removes a hydrogen atom from bicycloalkane having from 5 to 30 carbon atoms; for example, a bicyclo[1,2,2]heptan-2-yl group, a bicyclo[2,2,2]octan-3-yl group), an alkenyl group (preferably, a substituted or unsubstituted alkenyl group having from 2 to 30 carbon atoms, for example, a vinyl group, and an allyl group), a cycloalkenyl group (preferably, a substituted or unsubstituted cycloalkenyl group having from 3 to 30 carbon atoms, that is, a monovalent group which removes a hydrogen atom of a cycloalkene having from 3 to 30 carbon atoms, for example, a 2-cyclopenten-1-yl, and a 2-cyclohexen-1-yl group), a bicycloalkenyl group (substituted or unsubstituted bicycloalkenyl group, preferably substituted or unsubstituted bicycloalkenyl group having from 5 to 30 carbon atoms, that is a monovalent group removing a hydrogen atom of a bicycloalkene having a double bond; for example, a bicyclo[2,2,1]hept-2-en-1-yl, and bicyclo[2,2,2]oct-2-en-4-yl group), an alkynyl group (preferably, a substituted or unsubstituted alkynyl group having from 2 to 30 carbon atoms, for example, an ethynyl group, and a propargyl group), an aryl group (preferably substituted or unsubstituted aryl group having from 6 to 30 carbon atoms, for example, a phenyl group, a p-tolyl group, and a naphthyl group), a heterocyclic group (a monovalent group removing a hydrogen atom from aromatic or nonaromatic heterocyclic compound which is five- or six-membered substituted or unsubstituted is preferred, and more preferably five- or six-membered aromatic heterocyclic group having from 3 to 30 carbon atoms. For example, a 2-furyl group, a 2-thienyl group, a 2-pyrimidinyl group, and a 2-benzothiazolyl group),

a cyano group, a hydroxyl group, a nitro group, a carboxyl group, an alkoxy group (preferably substituted or unsubstituted alkoxy group having from 1 to 30 carbon atoms, for example, a methoxy group, an ethoxy group, an isopropoxy group, a tert-butoxy group, an n-octyloxy group, and a 2-methoxyethoxy group), an aryloxy group (preferably, a substituted or unsubstituted aryloxy group having from 6 to 30 carbon atoms, for example, a phenoxy group, a 2-methyl phenoxy group, a 4-tert-butyl phenoxy group, a 3-nitrophenoxy group, a 2-tetradecanoyl aminophenoxy group), a silyloxy group (preferably, a silyloxy group having from 3 to 20 carbon atoms, for example, a trimethyl silyloxy group, a tert-butyl dimethyl silyloxy group), a heterocyclic oxy group (preferably, a substituted or unsubstituted heterocyclic oxy group having from 2 to 30 carbon atoms, a 1-phenyl tetrazol-5-oxy group, and a 2-tetrahydropyranyloxy group), an acyloxy group (preferably, a formyloxy group, a substituted or unsubstituted alkyl carbonyloxy group having from 2 to 30 carbon atoms, preferably, a substituted or unsubstituted aryl carbonyloxy group having from 6 to 30 carbon atoms, for example, a formyloxy group, an acetyloxy group, a pyvaloyloxy group, a stearoyloxy group, a benzoyloxy group, a p-methoxy phenyl carbonyloxy group), a carbamoyloxy group (preferably, a substituted or unsubstituted carbamoyloxy group having from 1 to 30 carbon atoms, for example, an N,N-dimethyl carbamoyloxy group, an N,N-diethyl carbamoyloxy group, a morpholino carbonyloxy group, an N,N-di-n-octylamino carbonyloxy group, and an N-n-octyl carbamoyloxy group), an alkoxy carbonyloxy group (preferably, a substituted or unsubstituted alkoxy carbonyloxy group having from 2 to 30 carbon atoms, for example, a methoxy carbonyloxy group, an ethoxy carbonyloxy group, a tert-butoxy carbonyloxy group, and an n-octyl carbonyloxy group), an aryloxy carbonyloxy group (preferably, a substituted or unsubstituted aryloxy carbonyloxy group having from 7 to 30 carbon atoms, for example, a phenoxy carbonyloxy group, a p-methoxy phenoxy carbonyloxy group, a p-n-hexadecyloxy phenoxy carbonyloxy group),

an amino group (preferably, an amino group, a substituted or unsubstituted alkyl amino group having from 1 to 30 carbon atoms, a substituted or unsubstituted anilino group having from 6 to 30 carbon atoms, for example, an amino group, a methyl amino group, a dimethyl amino group, an anilino group, an N-methyl-anilino group, and a diphenyl amino group), an acyl amino group (preferably, a formyl amino group, a substituted or unsubstituted alkyl carbonyl amino group having from 1 to 30 carbon atoms, a substituted or unsubstituted aryl carbonyl amino group having from 6 to 30 carbon atoms, for example, a formyl amino group, an acetyl amino group, a pivaloyl amino group, a lauroyl amino group, and a benzoyl amino group), an aminocarbonyl amino group (preferably, a substituted or unsubstituted aminocarbonyl amino group having from 1 to 30 carbon atoms, for example, a carbamoyl amino group, an N,N-dimethyl amino carbonyl amino group, an N,N-diethyl amino carbonyl amino group, a morpholino carbonyl amino group), an alkoxy carbonyl amino group (preferably, a substituted or unsubstituted alkoxy carbonyl amino group having from 2 to 30 carbon atoms, for example, a methoxy carbonyl amino group, an ethoxy carbonyl amino group, a tert-butoxy carbonyl amino group, an n-octadecyloxy carbonyl amino group, and an N-methyl-methoxy carbonyl amino group), an aryloxy carbonyl amino group (preferably, a substituted or unsubstituted aryloxy carbonyl amino group having from 7 to 30 carbon atoms, for example, a phenoxy carbonyl amino group, a p-chlorophenoxy carbonyl amino group, and a m-n-octyloxy phenoxy carbonyl amino group), a sulfamoyl amino group (preferably, a substituted or unsubstituted sulfamoyl amino group having from 0 to 30 carbon atoms, for example, a sulfamoyl amino group, an N,N-dimethyl amino sulfonyl amino group, and an N-n-octyl amino sulfonyl amino group), an alkyl sulfonyl amino group and aryl sulfonyl amino group (preferably, a substituted or unsubstituted alkyl sulfonyl amino group having from 1 to 30 carbon atoms, a substituted or unsubstituted aryl sulfonyl amino group having from 6 to 30 carbon atoms, for example, a methyl sulfonyl amino group, a butyl sulfonyl amino group, a phenyl sulfonyl amino group, a 2,3,5-trichlorophenyl sulfonyl amino group, and a p-methyl phenyl sulfonyl amino group), a mercapto group, an alkyl thio group (preferably, a substituted or unsubstituted alkyl thio group having from 1 to 30 carbon atoms, for example, a methyl thio group, an ethyl thio group, and an n-hexadecyl thio group), an aryl thio group (preferably, a substituted or unsubstituted aryl thio group having from 6 to 30 carbon atoms, for example, a phenyl thio group, a p-chlorophenyl thio group, and a m-methoxy phenyl thio group), a heterocyclic thio group (preferably, a substituted or unsubstituted heterocyclic thio group having from 2 to 30 carbon atoms, for example, a 2-benzothiazolyl thio group, and a 1-phenyltetrazol-5-yl thio group),

a sulfamoyl group (preferably, a substituted or unsubstituted sulfamoyl group having from 0 to 30 carbon atoms, for example, an N-ethyl sulfamoyl group, an N-(3-dodecyloxy propyl) sulfamoyl group, an N,N-dimethyl sulfamoyl group, an N-acetyl sulfamoyl group, an N-benzoyl sulfamoyl group, and an N—(N′-phenyl carbamoyl) sulfamoyl group), a sulfo group, alkyl sulfynyl group and aryl sulfynyl group (preferably, a substituted or unsubstituted alkyl sulfynyl group having from 1 to 30 carbon atoms, a substituted or unsubstituted aryl sulfynyl group having from 6 to 30 carbon atoms, for example, a methyl sulfynyl group, an ethyl sulfynyl group, a phenyl sulfynyl group, and a p-methyl phenyl sulfynyl group), alkyl sulfonyl group and aryl sulfonyl group (preferably, a substituted or unsubstituted alkyl sulfonyl group having from 1 to 30 carbon atoms, a substituted or unsubstituted aryl sulfonyl group having from 6 to 30 carbon atoms, for example, a methyl sulfonyl group, an ethyl sulfonyl group, a phenyl sulfonyl group, and a p-methyl phenyl sulfonyl group), an acyl group (preferably, a formyl group, a substituted or unsubstituted alkyl carbonyl group having from 2 to 30 carbon atoms, a substituted or unsubstituted aryl carbonyl group having from 7 to 30 carbon atoms, for example, an acetyl group, and pivaloyl benzolyl group), an aryloxy carbonyl group (preferably, a substituted or unsubstituted aryloxy carbonyl group having from 7 to 30 carbon atoms, for example, a phenoxy carbonyl group, an o-chlorophenoxy carbonyl group, m-nitrophenoxy carbonyl group, and p-tert-butyl phenoxy carbonyl group), an alkoxy carbonyl group (preferably, a substituted or unsubstituted alkoxy carbonyl group having from 2 to 30 carbon atoms, for example, a methoxy carbonyl group, an ethoxy carbonyl group, a tert-butoxy carbonyl group, an n-octadecyloxy carbonyl group), a carbamoyl group (preferably, a substituted or unsubstituted carbamoyl group having from 1 to 30 carbon atoms, for example, a carbamoyl group, an N-methyl carbamoyl group, an N,N-dimethyl carbamoyl group, an N,N-di-n-octyl carbamoyl group, and an N-(methylsulfonyl) carbamoyl group), aryl azo group and heterocyclic azo group (preferably, a substituted or unsubstituted aryl azo group having from 6 to 30 carbon atoms, a substituted or unsubstituted heterocyclic azo group having from 3 to 30 carbon atoms, for example, a phenyl azo group, a p-chlorophenyl azo group, and 5-ethylthio-1,3,4-thiadiazol-2-yl azo group), an imido group (preferably, an N-succinimido group, and an N-phthalimido group), a phosphino group (preferably, a substituted or unsubstituted phosphino group having from 2 to 30 carbon atoms, for example, a dimethyl phosphino group, a diphenyl phosphino group, and a methyl phenoxy phosphino group), a phosphinyl group (preferably, a substituted or unsubstituted phosphinyl group having from 2 to 30 carbon atoms, for example, a phosphinyl group, a dioctyloxy phosphinyl group, and a diethoxy phosphinyl group), a phosphinyloxy group (preferably, a substituted or unsubstituted phosphinyloxy group having from 2 to 30 carbon atoms, for example, a diphenoxy phosphinyloxy group, and a dioctyloxy phosphinyloxy group), a phosphinyl amino group (preferably, a substituted or unsubstituted phosphinyl amino group having from 2 to 30 carbon atoms, for example, a dimethoxy phosphinyl amino group and dimethyl amino phosphinyl amino group), a silyl group (preferably, a substituted or unsubstituted silyl group having from 3 to 30 carbon atoms, for example, a trimethyl silyl group, a tert-butyl dimethyl silyl group, and a phenyl dimethyl silyl group).

From the above substituents with hydrogen atoms, the hydrogen atom is removed and is substituted with an above group. Examples of such functional groups include an alkyl carbonyl aminosulfonyl group, an aryl carbonyl aminosulfonyl group, an alkyl sulfonyl amino carbonyl group, and an aryl sulfonyl amino carbonyl group. Specific examples of these groups include a methyl sulfonyl aminocarbonyl group, a p-methyl phenyl sulfonyl amino carbonyl group, an acetyl amino sulfonyl group, and a benzoyl amino sulfonyl group.

Further, when two or more substituents are present, the substituents may be the same or different. Further, if possible, the substituents may be combined to each other to form a ring.

Preferred compounds represented by formula (V)-2-A are those in which all of R¹¹ is a methyl group, all of R² and R⁵ are a hydrogen atom, R¹³ is an alkyl group having 3 or more carbon atoms, L¹ is a single bond, —O—, —CO—, —NR—, —SO₂NR—, —NRSO₂—, —CONR—, —NRCO—, —COO—, OCO—, and an alkynylene group (R represents a hydrogen atom, an alkyl group, and aryl group which may have a substituent. Preferred is a hydrogen atom), L² is —O— or NR—(R represents a hydrogen atom, an alkyl group, and an aryl group which may have a substituent. Preferred is a hydrogen atom), Ar¹ is an arylene group, and n is from 3 to 6.

Compounds represented by formulae (V)-2-A and (V)-2-B are described below, but the invention is not at all limited by the following specific examples.

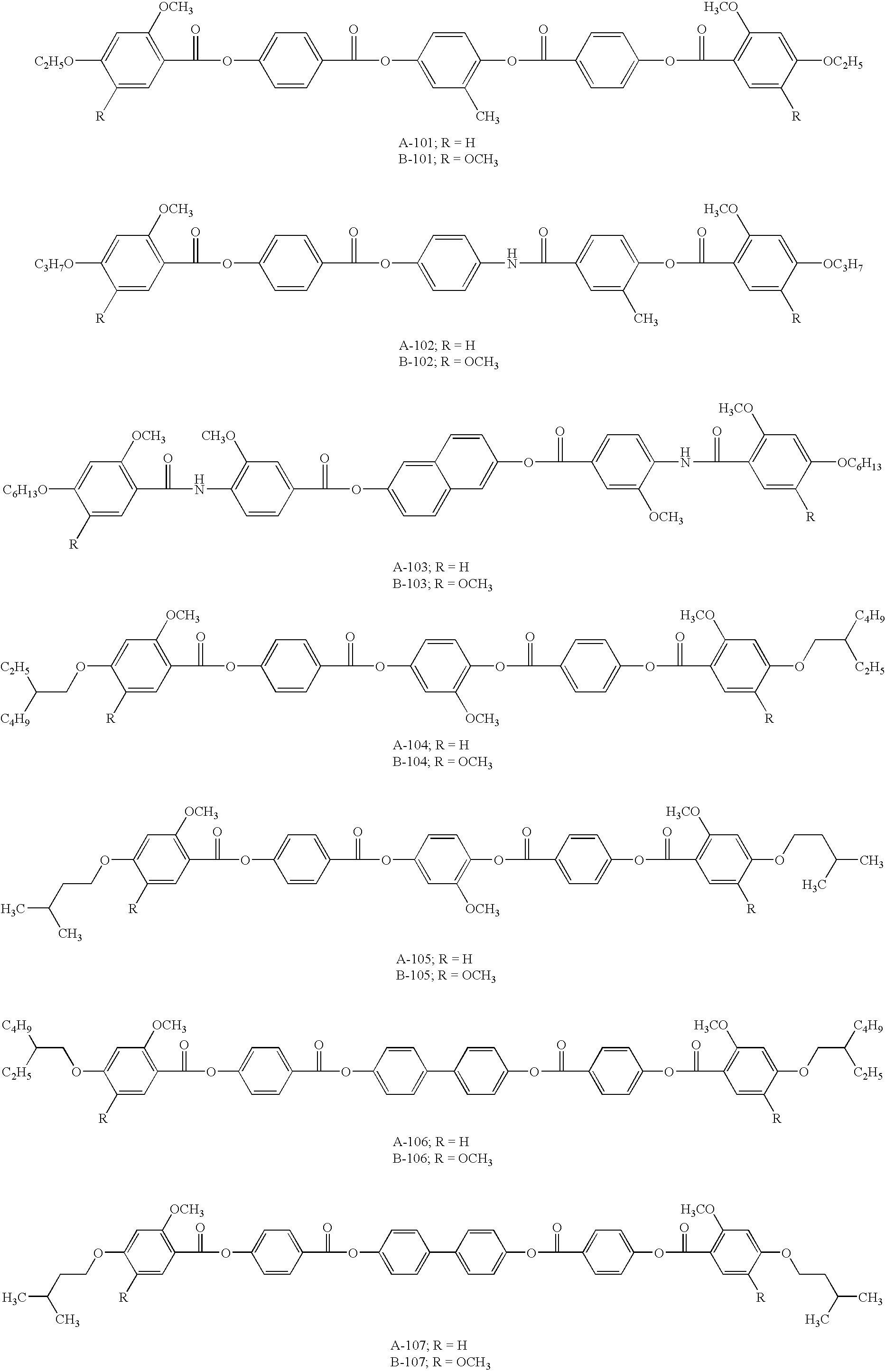

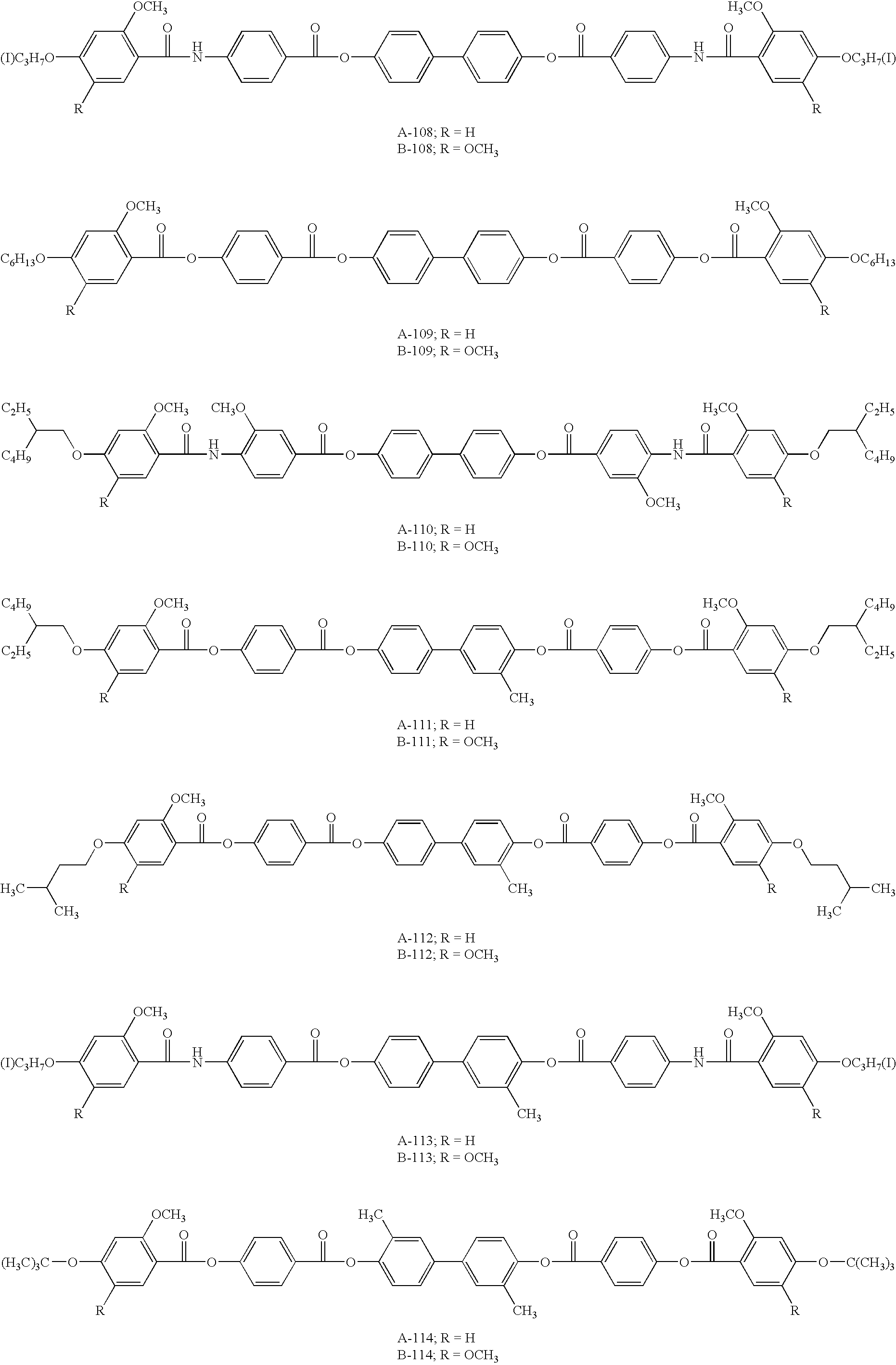

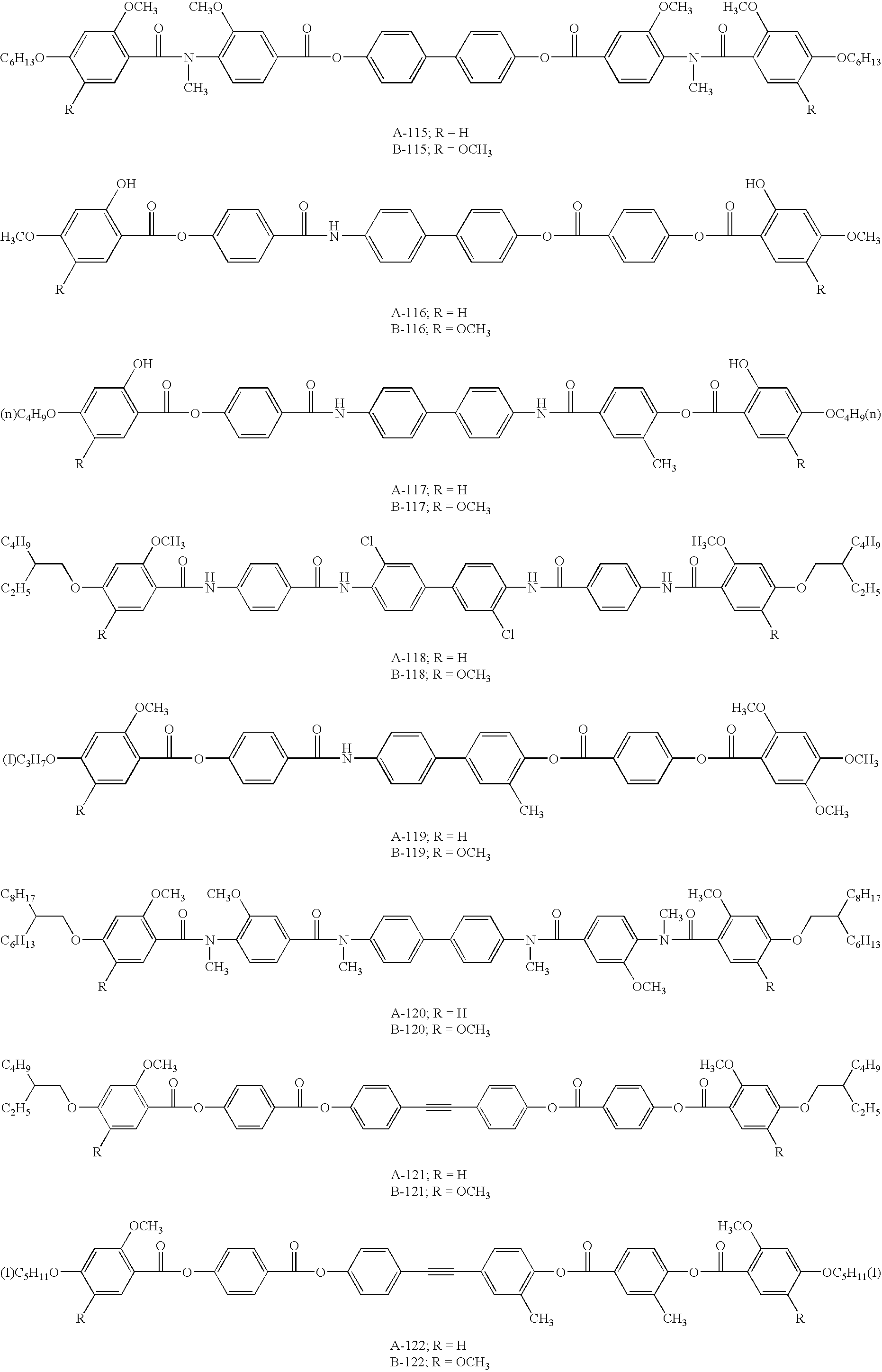

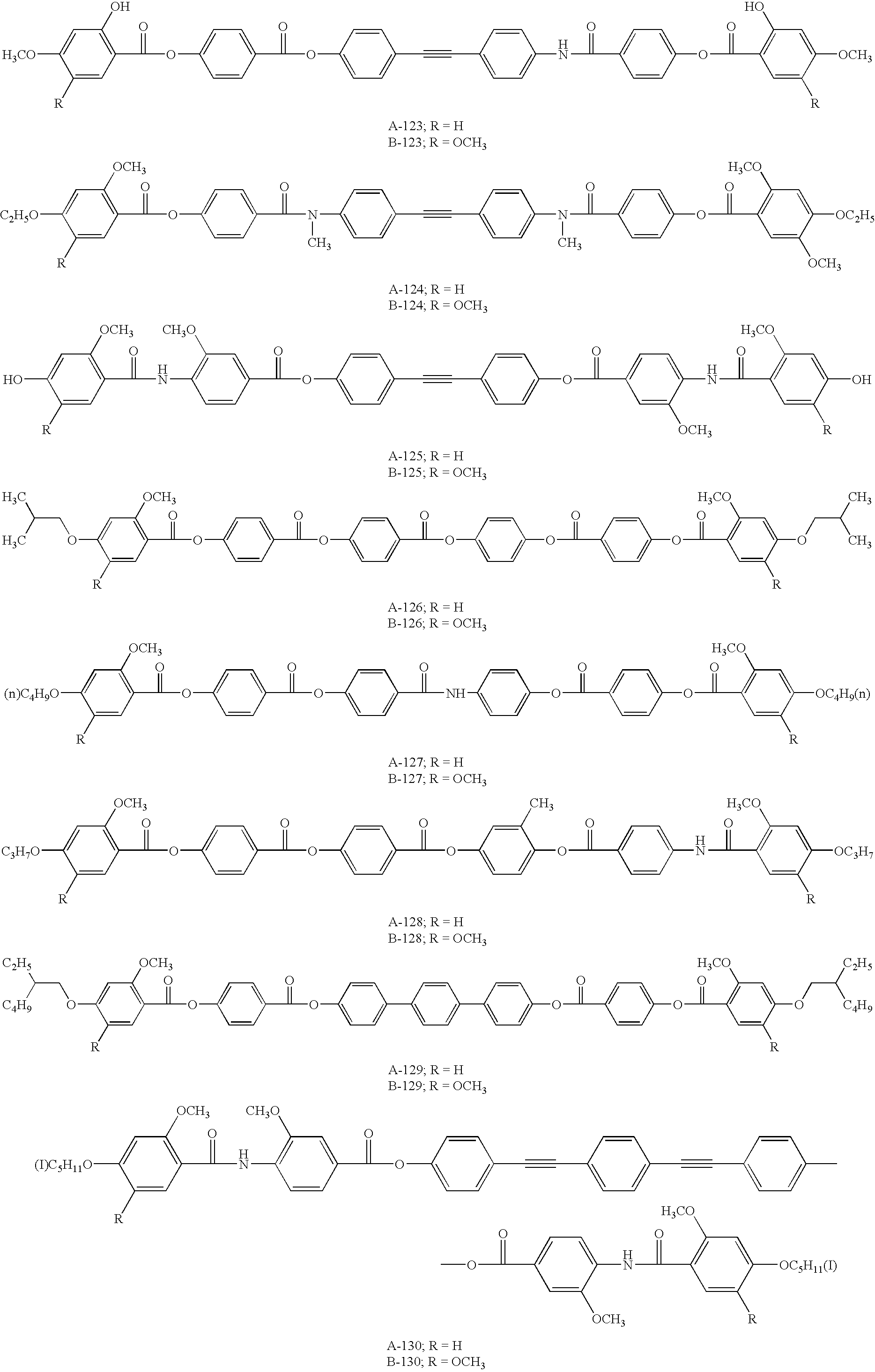

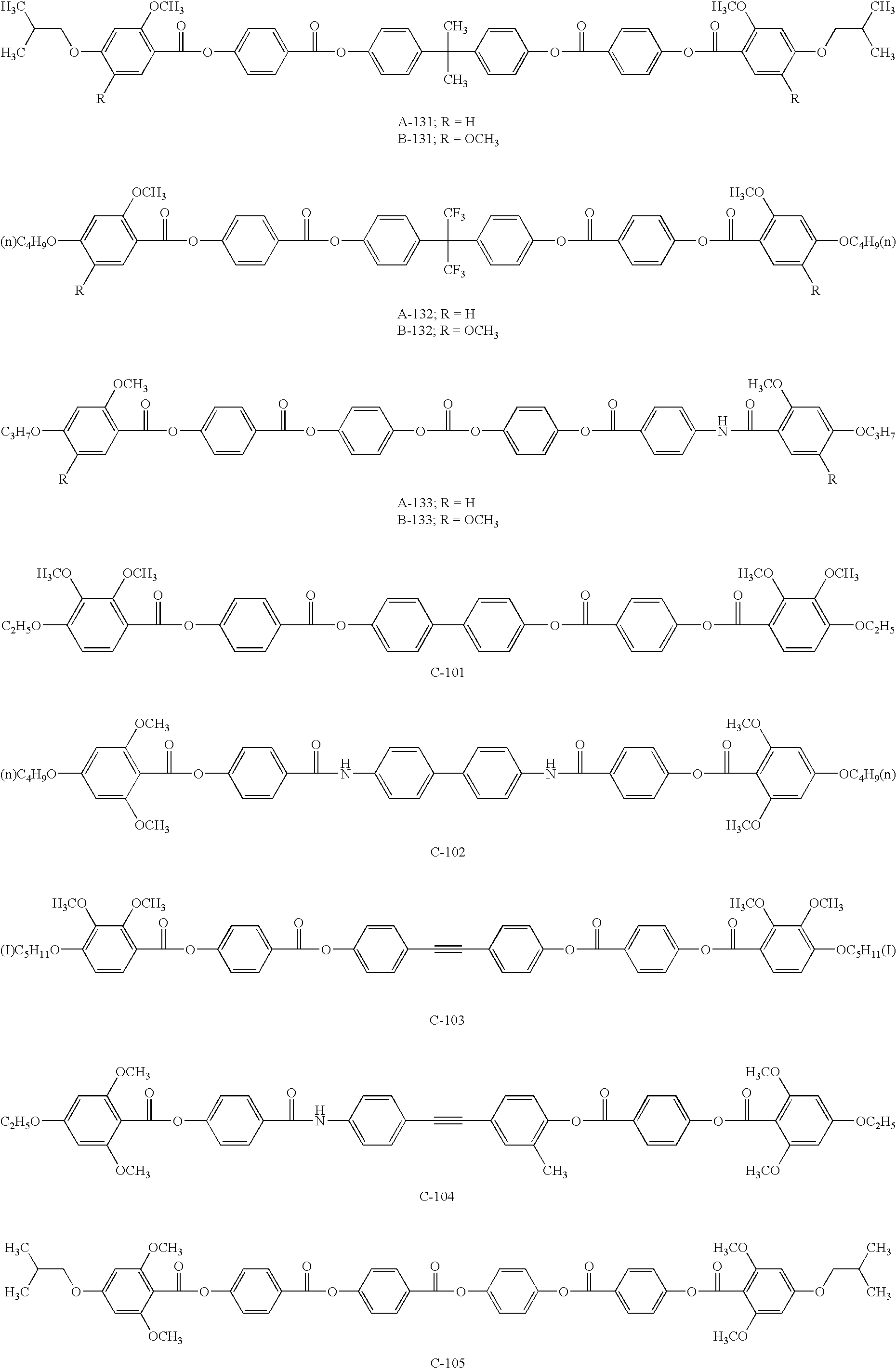

A compound represented by formula (V) may be synthesized by synthesizing first a substituted benzoic acid, and then by subjecting the substituted benzoic acid with phenol derivative or aniline derivative to the general esterification reaction or amidation reaction. If the reaction forms an ester bond or amide bond, any reaction may be used. For example, the methods include: a method where a functional group of the substituted benzoic acid is substituted with acid halide, and then is condensed with phenol derivative or aniline derivative; and a method where the substituted benzoic acid with a phenol derivative or aniline derivative are subjected to dehydration and condensation by using a condensation agent or catalyst.

As the preparation method of compounds represented by formula (V), a method where a functional group of the substituted benzoic acid is substituted with acid halide, and then is condensed with a phenol derivative or aniline derivative is preferred, when considering a production process etc.

In a preparation method of a compound represented by formula (V), a reaction solvent includes hydrocarbon solvent (preferably, toluene, and xylene are exemplified), ether solvent (preferably, dimethyl ether, tetrahydrofuran, and dioxane are exemplified), ketone solvent, ester solvent, acetonitryl, dimethyl formamide, and dimethyl acetoamide. These solvents may be used alone, or kinds of solvents may be used by mixing. Preferred solvents are toluene, acetonitryl, dimethyl formamide, and dimethyl acetoamide.

Reaction temperature is preferably from 0 to 150° C., more preferably from 0 to 100° C., further preferably from 0 to 90° C., and particularly preferably from 20 to 90° C.

Further, it is preferred not to use a base in the reaction. In the case of using a base, either an organic base or an inorganic base may be used, and an organic base such as pyridine, tertiary alkyl amine (preferably triethyl amine, and ethyl diisopropyl amine) is preferably used.

Compounds represented by formulae (V)-2-A and (V)-2-B may be synthesized by a known method. For example, in the case of a compound of n=4, the compounds may be obtained by connecting two molecules of the following intermediate B which is obtained by reaction of a starting compound having the following structure A with a derivative having reaction sites such as a hydroxyl group and an amino group, with one molecule of the following compound C. However, the synthesis method of a compound represented by formulae (V)-2-A and (V)-2-B is not limited to the example.

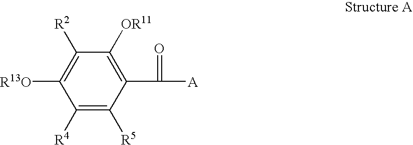

In the formula, A represents a reaction group such as a hydroxyl group, a halogen atom, R¹¹, R², R¹³ and R⁵ are the same as described above, and R⁴ is a hydrogen atom or a substituent represented by OR¹⁴ as described above.

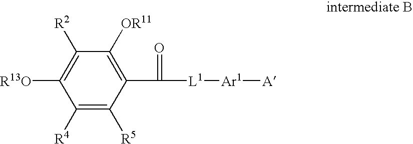

In the formula, A′ represents a reaction group such as a carboxyl group, R¹¹, R², R¹³′ R⁴, R⁵′ Ar¹ and L′ are the same as described above.

Compound C

B—Ar²-L²-Ar²—B′

In the formula, B and B′ represent a reaction group such as a hydroxyl group and amino group, and Ar² and L² are the same as Ar¹ and L¹ described above.

Compounds represented by formulae (V), (V)-1, and (V)-2 may be used alone, and two or more kinds may be used by mixing.

Specific examples of benzotriazole based ultraviolet absorbent useful in the invention include 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″, 4″,5″,6″-tetrahydrophthalimide methyl)-5′-methylphenyl)benzotriazole, 2,2-methylenebis(4-(1,1,3,3-tetramethyl butyl)-6-(2H-benzotriazol-2-yl)phenol), 2-(2′-hydroxy-3′-tert-butyl-5′-methylphenyl)-5-chlorobenzotriazole, 2-(2H-benzotriazol-2-yl)-6-(linear and side chain dodecyl)-4-methylphenole, and mixture of octyl-3-[3-tert-butyl-4-hydroxy-5-(chloro-2H-benzotriazol-2-yl)phenyl]propionate and 2-ethylhexyl-3-[3-tert-butyl-4-hydroxy-5-(5-chloro-2H-benzotriazol-2-yl)phenyl]propionate, but the invention is not limited thereto. Further, as commercial products, TINUVIN 109, TINUVIN 171, and TINUVIN 326 (all manufactured by Chiba Specialty Chemicals Co., Ltd.) may be preferably used.

[Plasticizer]

Plasticizer such as biphenyl phosphate and biphenyl phosphate may be added in the optically anisotropic layer.

Generally, in large screen displays, reduction in contrast and tint in inclination direction are significant. Accordingly, the optical film (also referred to as optically compensatory sheet) which contains the optically anisotropic layer of the Embodiment is particularly suitable for large screen liquid crystal displays. When an optical film is used for a large screen liquid crystal display, it is preferred to form a film having a width of 1470 mm or more. Further, the optical film of the invention includes not only a piece film cut to the size with which the film can be directly assembled in liquid crystal display, but also the film which is produced in a long shape by consecutive production to be wound in the form of a roll. With the latter, the optical film is held and transported as it is, and is used by cutting to a desirable size when actually embedded in a liquid crystal display and adhered to the polarizer, or the like. Further, with the latter, the optical film directly adheres to a polarizer, or the like which is produced in a long shape and includes a polyvinyl alcohol film, and then is used by cutting to a desirable size when actually embedded in liquid crystal display. The wound roll-shaped optical film includes a film wound in a roll length of 2500 m or more.

[Polarizing Plate]

Further, the embodiment relates to a polarizer, and a polarizing plate having an optical film of the invention on one surface of the polarizer. Like the optical film in the embodiment, the polarizing plate of the invention includes not only a polarizing plate of a piece film cut to the size with which the film can be directly embedded in a liquid crystal display, but also a polarizing plate which is produced in a long shape by consecutive production to be wound in the form of a roll (for example, a roll length of 2500 m or 3900 m or more). For use of the polarizing plate in large screen liquid crystal displays, as described above, it is preferred that the polarizing plate have a width of or more 1470 mm.

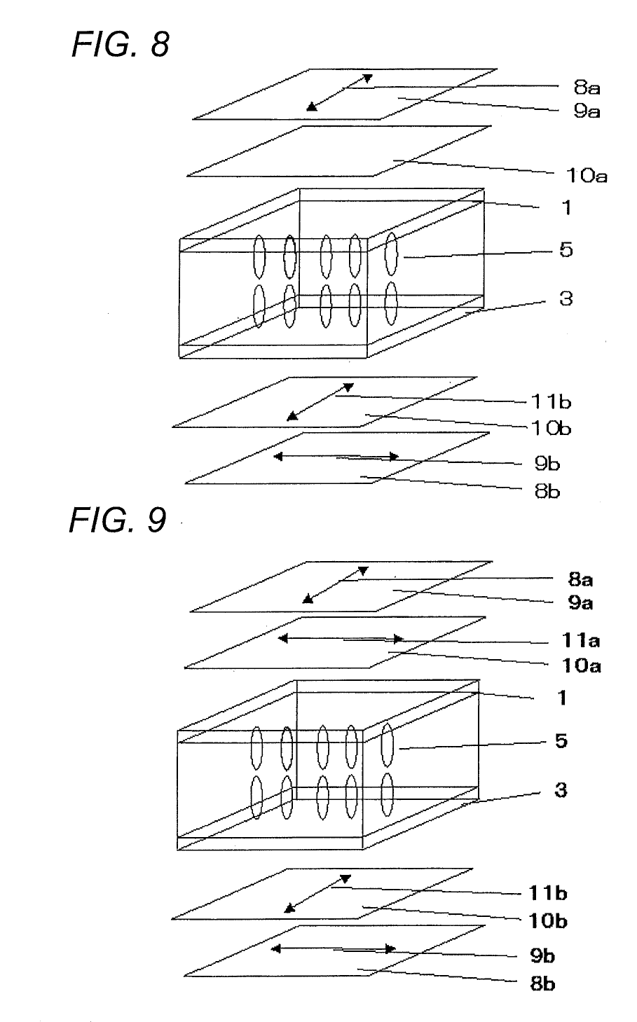

FIG. 8 and FIG. 9 are schematic diagrams of one example of the liquid crystal display according to the embodiment. A VA mode liquid crystal display has liquid cell LC (including upper substrate 1, lower substrate 3, and liquid crystal layer 5), a pair of upper polarizing plate P1 and lower polarizing plate P2 which have a liquid crystal cell LC being placed therebetween. The polarizing film generally forms a polarizing plate having a protective film on both surfaces to be assembled in a liquid crystal display, but FIG. 8 and FIG. 9 do not show the outer protective film of the polarizing film in order to simplify the drawings. Polarizing plates P1 and P2 have polarizing films 8a and 8b, and are disposed so as to orthogonalize the absorption axes thereof 9a and 9b with each other. Liquid crystal cell LC is a VA mode liquid crystal cell, and liquid crystal layer 5 is a homeotropic alignment for black display. Each of upper substrate 1 and lower substrate 3 has an alignment film (not shown) and an electrode layer (not shown) in the inner surface respectively, and further the inner surface of substrate 1 of observer side has a color filter layer (not shown).

Optically anisotropic layers 10a and 10b in embodiments described above are disposed respectively between the upper substrate 1 and the upper polarizing film 8a, and between the lower substrate 3 and the lower polarizing film 8b respectively.

Re(550) and Rth(550) of optically anisotropic layer 10b of FIG. 8 in Embodiment 2-1 specify the following formulae (A) and (B). The optically anisotropic layer 10b is disposed so as to orthogonalize in-plane slow axis 11b to absorption axis 9b of lower polarizing film 8b. That is, optically anisotropic layer 10b is disposed so as to orthogonalize slow axes respectively.

40 nm≦Re(550)≦275 nm (A)

0 nm≦Rth(550)≦275 nm (B)

Further, the optically anisotropic layer 10a has an in-plane retardation of substantially 0 nmf, and preferably has Rth in a thickness direction of 0 to 350 nm. The positions of 10a and 10b may be changed.

Optically anisotropic layers 10a and 10b of FIG. 9 in Embodiment 2-2 satisfy the (C) and (D). The optically anisotropic layers 10a and 10b are disposed so as to orthogonalize in-plane slow axes 11a and 11b to absorption axes 9a and 9b of upper polarizing film 8a and lower polarizing film 8b. That is, the optically anisotropic layers 10a and 10b are disposed so as to orthogonalize slow axes respectively.

30 nm≦Re(550)≦80 nm (C)

75 nm≦Rth(550)≦155 nm (D)

In Embodiment, Re(550) is preferably 30 to 80 nm, further preferably from 40 to 70 nm; and the Rth(550) of a phase difference film is preferably from 70 to 155 nm, and further preferably from 80 to 130 nm.

The liquid crystal display of the embodiment is a VA (vertical alignment) liquid crystal display, and therefore optical compensation of the phase difference (Re Rth when viewed from an inclination direction) is effective. In the VA mode, if a structure, in which one pixel is divided into plural areas and which is referred to as a multi-domain, is used, up, down, left, and right viewing angle characteristics are averaged, and display quality is improved, and accordingly this is preferred (the same as in embodiments 1-1 and 1-2).

The liquid crystal display of the embodiment is applied, depending on the driving methods, to an active matrix liquid crystal display which uses 3 terminal or 2 terminal semiconductor elements such as TFT (Thin Film Transistor) and MIN (Metal Insulator Metal), and a passive matrix liquid crystal display represented by an STN type called time division driving. The invention is effective in any display (the same as in embodiments 1-1, and 1-2).

The optical film of the embodiment has phase difference with a small incident angle dependence of, and the difference (R40−R0) of phase difference R0 per 100 μm at incident angle 0° and phase difference R40 per 100 μm at incident angle 40° is preferably 20 nm or less, and more preferably 10 nm or less.

The optical film of the embodiment has a thickness of 1 μm or more and less than 500 μm, and more preferably 10 μm or more and less than 300 μm. The optical film where the thickness is thinner than 1 μm is not preferred due to poor strength, and breaks are easily generated when stretched.

A production method of the optical film in the embodiment is not limited, but a lactone ring-containing polymer, other thermoplastic resins, and other additives may be mixed by a conventionally known mixing method, following by forming a thermoplastic resin composition in advance, then producing an optical film. In the production method of the thermoplastic resin composition, extrusion kneading of obtained mixture after preblending with mixer such as Omni Mixer may be used. In this case, the kneader used in the extrusion kneading is not limited, but an extruder such as a uniaxial extruder or biaxial extruder, or a conventionally known kneader such as a pressure kneader may be used.

Film-forming methods include known forming methods such as a solution casting method, a melting extrusion method, a calendar method, and a pressing forming method. Among these, a solution casting method and a melting extrusion method are preferred. At this time, as described above, a thermoplastic resin composition which is extruded and kneaded in advance may be used; and a lactone ring-containing polymer, other thermoplastic resins, and other additives may be dissolved separately in solution to form a homogeneous mixed liquid and used with a film forming method such as a solution casting method and a melting extrusion method.

A solvent used in the solution casting method includes chlorine solvent such as chloroform and dichloromethane; aromatic solvents such as toluene, xylene, benzene, and a mixed solvent thereof; alcohol solvents, such as methanol, ethanol, isopropanol, n-butanol, and 2-butanol; methyl cellosolve, ethyl cellosolve, butyl cellosolve, dimethylformamide, dimethyl sulfoxide, dioxane, cyclohexanone, tetrahydrofuran, acetone, methyl ethyl ketone (MEK), ethyl acetate, and diethyl ether are exemplified. These solvents may be used by one kind alone or two or more kinds may be used in combination.

As the apparatus for performing the solution casting method, for example, a drum type casting machine, a band type casting machine, and a spin coater or the like are exemplified.

As the melt extrusion method, a T die method and an inflation method are exemplified, and a film-forming temperature at that time is preferably from 150 to 350° C., and more preferably from 200 to 300° C. When a film is formed by the T die method, the T die is attached to the tip of a known uniaxial extruder or biaxial extruder, and a film extruded in a film shape is wound to obtain a film in the form of a roll. At this time, a uniaxial stretching process is also possible by arbitrarily adjusting the temperature of the winding roll and stretching is applied in the extruding direction. Further, processes such as successive biaxial stretching and simultaneous biaxial stretching can be added by adopting a process of stretching a film in a direction perpendicular to the extruding direction.

It is preferred that an optical film in the embodiment is stretched for retardation development. In this case, the film may be a uniaxially stretched film or a biaxially stretched film. In the case of forming a biaxially stretched film, the film may be a simultaneously biaxially stretched film or a successively biaxially stretched film. In the case of biaxial stretching, mechanical strength and film performances are heightened. By blending other thermoplastic resins, the optical film in the invention can restrain an increase in phase difference even when the film is stretched, and optical isotropy can be maintained.

Further, it is preferred that the optically anisotropic layer containing a lactone ring-containing polymer in the embodiment is stretched to at least one direction. Accordingly phase difference may be provided. It is preferred that the stretch ratio in stretching is 1.3 to 5 times (corresponding to stretch ratio of 30% to 400%). Accordingly, a particularly desirable phase difference can be obtained.

Liquid Crystal Display

The optically compensatory sheet and the polarizing plate in the embodiment can be used in liquid crystal displays of various modes. They can be used in liquid crystal displays of any of transmission type, reflection type and semi-transmission type.

### EXAMPLES

The invention will be described more specifically with reference to examples and comparative examples below. Various changes and modifications can be made in the materials, use amounts, proportions, treatment contents, and treatment procedures or the like in the following examples without departing from the spirit of the invention. Accordingly, the scope of the invention should not be construed to be restricted to the specific examples shown below.

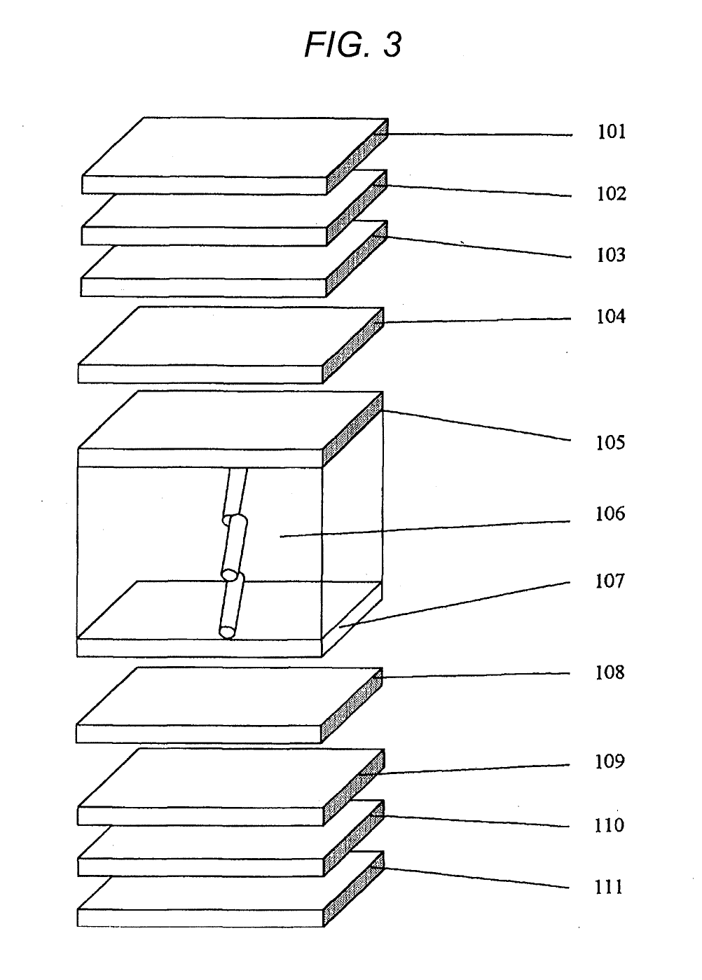

The outline of the constitution of an Examples of the liquid crystal display in Embodiments 1-1 and 1-2 of the invention is shown in FIG. 3. A VA (vertical alignment) liquid crystal display shown in FIG. 3 has a liquid crystal cell including a pair of substrates 105 and 107 arranged in the counter positions having an electrode at least on one side, and liquid crystal layer 106 containing liquid crystal molecules and placed between the substrates, a pair of polarizing plates having polarizing films 102 and 110 arranged with the liquid crystal layer therebetween, and protective films 101 and 111 provided on at least one side of the polarizing film. The liquid crystal display may have optically anisotropic layers 104 and 108 between the liquid crystal layer and at least one of the pair of polarizing plates. The liquid crystal molecules in the liquid crystal layer 106 are vertically oriented to the substrate surface when voltage is not applied, that is, when displaying black, and when voltage is applied, the liquid crystal molecules incline, and transmittance increases.

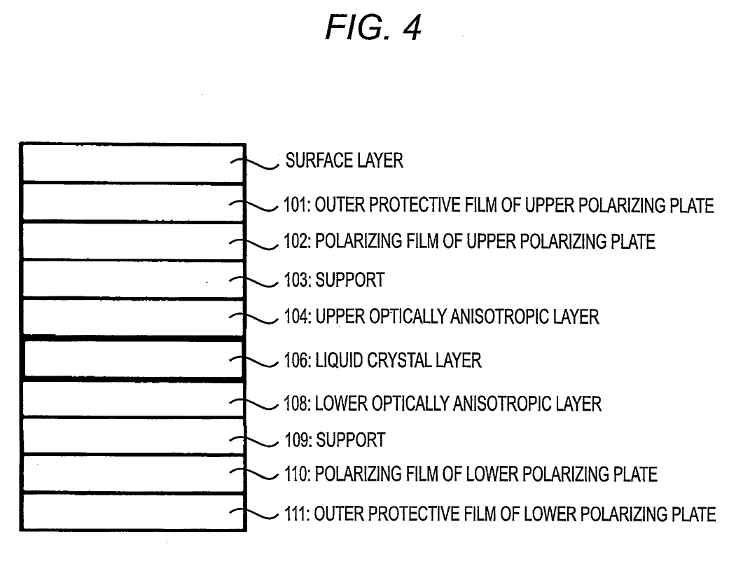

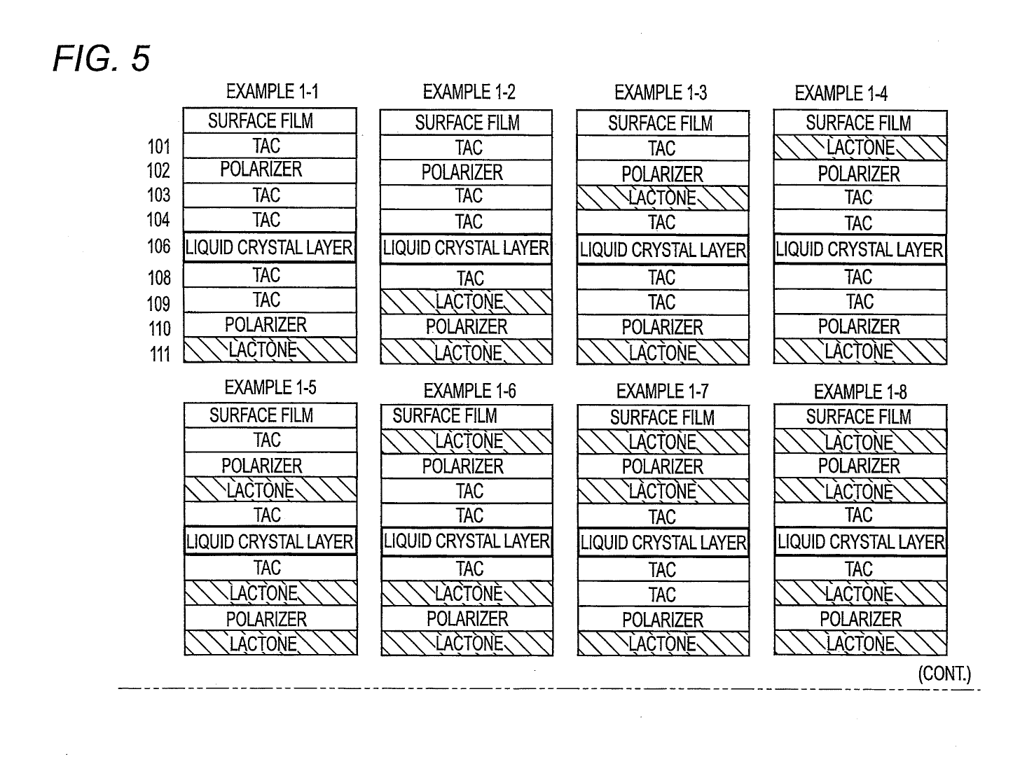

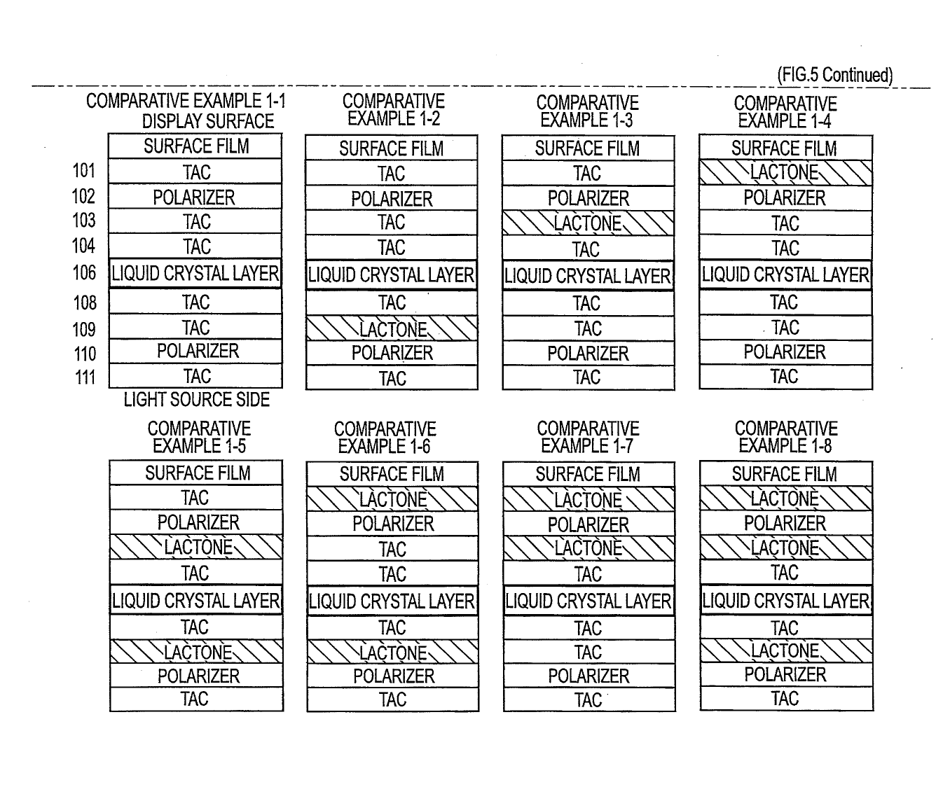

FIG. 4 represents the outline of the cross sectional view of FIG. 3. A layer structure of Examples and Comparative Examples described below is in accordance with FIG. 4. Further, FIG. 4, and FIGS. 5 to 7 described below show a surface layer (surface FILM) on the outer protective film of upper polarizing plate 101, but this represents one embodiment of the film laminator in the invention. The surface layer (surface FILM) does not need to be provided, and in practice such a surface layer (surface FILM) is not provided in Examples and Comparative Examples. The layer was measured by an Ellipsometer and the thickness of the outer protective film of the upper and lower polarizing plates (corresponding to members 101 and 111) was 80 μm, the thickness of the polarizing film of the upper and lower polarizing plates (corresponding to members 102 and 110) was 25 μm, the thickness of a support (corresponding to members 103 and 109) was 80 μm, and the thickness of the upper and lower optically anisotropic layers (corresponding to members 104 and 108) was 80 μm.

About Each Layer in Examples and Comparative Examples

(1) Lactone Film as an Outer Protective Film of Upper and Lower Polarizing Plates (a Film Containing a Thermoplastic Resin Composition Containing a Ring-Containing Polymer) (Used in Examples 1-1 to 1-4 and Comparative Examples 1-6 to 1-8 Described Below)

A lactone ring-containing polymer pellet was obtained according to the synthesis method described in [0230] to [0232] of WO 2006/025445A1. Subsequently, this pellet was melted and extruded from a coating hanger type T die having a width of 200 mm by a biaxial extruder having a 20 mm φ screw, to prepare a lactone film (thickness of 80 μm) as the outer protective film of the upper and lower polarizing plates.

(2) Lactone Film as Support (Used in Examples and Comparative Examples 1-2, 1-3, 1-5 to 1-8, Examples 2-1 to 2-3 and Comparative Examples 3-1 to 3-3 Described Below)

A lactone film (thickness of 80 μm) was produced as a support similarly to the preparation method of the lactone film as the outer protective film of upper and lower polarizing plates described above.

(3) TAC Film as Outer Protective Film of Upper and Lower Polarizing Plates (Used in Examples 1-1 to 1-3, Comparative Examples 1-1 to 1-3, Comparative Examples 1-5 to 1-8, Examples 2-1 to 2-3, Comparative Examples 2-1 to 2-3, Examples 3-1 to 3-3, and Comparative Examples 3-1 to 3-3 Described Below)

Fujitec TD80UL (manufactured by Fujifilm Corporation) (thickness of 80 μm) was used.

(4) TAC Film as Support (Used in Examples 1-1 to 1-4, Example 1-6, Comparative Examples 1-1 to 1-4, Comparative Examples 1-6 and 1-7, Examples 2-1 and 2-2, Comparative Examples 2-1 to 2-3, Examples 3-1 and 3-2, and Comparative Examples 3-1 to 3-3 Described Below)

Fujitec TD80UL (Fujifilm Corporation) (thickness of 80 μm) was used.

(5) TAC Film as the Optically Anisotropic Layer (Used in Examples 1-1 to 1-8, and Comparative Examples 1-1 to 1-8 Described Below)

Cellulose acetate film (thickness of 80 μm) was used which was prepared according to [0039] to [0043] of JP-A 2001-249223.

(6) Coating Layer as Optically Anisotropic Layer (Used in Examples 2-1 to 2-3, and Comparative Examples 2-1 to 2-3 Described Below)

A layer hardened by light radiation to a liquid crystal solution (SE-1) was used as the coating layer which was manufactured according to [0085] (Example 2) of JP-A 6-214116.

(7) Polyimide Layer as Optically Anisotropic Layer (Used in Examples 2-1 to 2-3, and Comparative Examples 2-1 to 2-3 Described Below)

A polyimide layer was used which was manufactured according to [0087] (Example 1) of JP-A 2005-208676.

Production Method of Optically Compensatory Sheet

In Examples 1-1 to 1-8 and Comparative Examples 1-1 to 1-8, an optically compensatory sheet was obtained by sticking a film for an optically anisotropic layer on a support with a 3% aqueous polyvinyl alcohol solution (PVA-117H, manufactured by Kurary Co., Ltd.) as an adhesive.

In Examples 2-1 to 2-3, an optically compensatory sheet which was provided with a coating layer as the optically anisotropic layer on a lactone film as the support was obtained by replacing the polyethylene terephthalate film which is the support according to [0085] (Example 2) of JP-A 6-214116 with a lactone film as the support manufactured as described above.

In Comparative Examples 2-1 to 2-3, an optically compensatory sheet which was provided with a coating layer as an optically anisotropic layer on a TAC film as a support was obtained by replacing the polyethylene terephthalate film which is the support according to [0085] (Example 2) of JP-A 6-214116 with a TAC film as the support.

In Examples 3-1 to 3-3, an optically compensatory sheet which was provided with a polyimide layer as an optically anisotropic layer on a lactone film as a support was obtained by replacing a TAC film which is the support according to [0087] (Example 1) of JP-A 2005-208676 with a lactone film as the support manufactured as described above.

In Comparative Examples 3-1 to 3-3, an optically compensatory sheet which was provided with a polyimide layer as an optically anisotropic layer on a TAC film as the support was obtained by replacing TAC film (UZ-TAC; manufactured by Fujifilm Corporation) which is the support according to [0087] (Example 1) of JP-A 2005-208676 with a TAC film (Fujitec TD80UL; manufactured by Fujifilm Corporation) as the support.

Production Method of Polarizing Plate

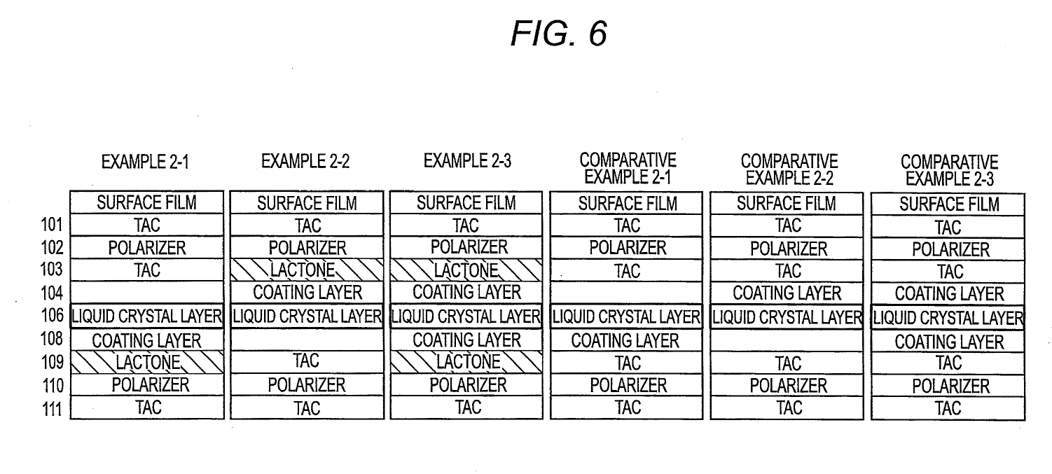

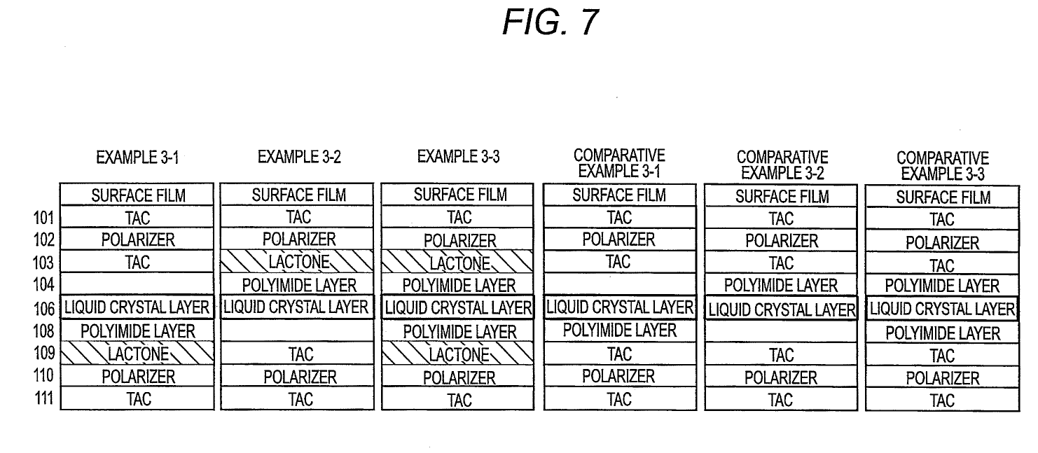

The outer protective film of the polarizing plate manufactured as described above and the surface of a support side of an optically compensatory sheet were subjected to alkaline saponification treatment, respectively. Further, with relation to “the support (simply referred to as the support) where an optically anisotropic layer is not provided” used in Examples 2-1 and 2-2, Comparative Examples 2-1 and 2-2 (refer to FIG. 6), Examples 3-1 and 3-2, and Comparative Examples 3-1 and 3-2 (refer to FIG. 7), the support was subjected to alkaline saponification treatment.

More specifically, the protective film/optically compensatory sheet/support were dipped in 1.5N aqueous sodium hydroxide solution for 2 minutes at 55° C., subsequently, were washed in a water bath at room temperature, and then were neutralized with 0.1N sulfuric acid at 30° C. Subsequently, they were washed again in a water bath at room temperature, and further were dried with warm air at 100° C.

On the other hand, a polyvinyl alcohol film in the form of a roll having a thickness of 80 μm was consecutively stretched to be 5 times in aqueous iodine solution, and was dried to obtain a polarizing film with a thickness of 20 μm.

A polarizing plate was manufactured by placing a polarizing film between the outer protective film of polarizing plate which was subjected to alkaline saponification treatment, and an optically compensatory sheet or a support which was subjected to alkaline saponification treatment such that these saponified surfaces are on a polarizing film side, and by sticking using 3% aqueous polyvinyl alcohol (PVA-117H, manufactured by Kurary Co., Ltd.) solution as an adhesive.

Evaluation of Optical Characteristics

The values of Re and Rth in Examples 2-1 to 2-3, Comparative Examples 2-1 to 2-3, Examples 3-1 to 3-3, and Comparative Examples 3-1 to 3-3 described below were measured by a standard mode of phase difference measurement with an automatic double refractometer (KOBRA 21ADH, manufactured by Oji Scientific Instruments). Rth was computed with the average refractive index of 1.48.

Re and Rth of the manufactured optically compensatory sheet (optically compensatory sheet where optically anisotropic layers 104 and 108 were provided with supports 103 and 109) are measured excluding 25 mm from both ends with an interval of 10 mm in the width direction and an interval of 10 mm in the longitudinal direction of 1,000 mm, and an average value was computed. As a result, Re and Rth of the support in the optically compensatory sheet used in Examples 2-1 to 2-3 were 3 nm and 52 nm respectively. Re and Rth of the support in the optically compensatory sheet used in Examples 3-1 to 3-3 were 3 nm and 52 nm respectively. On the other hand, Re and Rth of the support in the optically compensatory sheet used in Comparative Examples 2-1 to 2-3 were 3 nm and 52 nm. Re and Rth of the support in the optically compensatory sheet used in Comparative Examples 3-1 to 3-3 were 3 nm and 52 nm.

Evaluation of Display Characteristics

With respect to a manufactured liquid crystal display, luminance of omni-directional angle of visibility during black display and white display was measured with EZ-Contrast 160D, manufactured by ELDIM). Front contrast (Front CR) is a value obtained by dividing white luminance in the vertical direction of a liquid crystal display by black luminance. Further, Table 1-1 shows the values of black luminance in each of Examples and each of Comparative Examples.

Humidity Dependency of Display Performance

After leaving the manufactured liquid crystal display in an atmosphere of 25° C. 60% RH for 72 hours, black luminance was measured by EZ-Contrast 160D.

Subsequently, after leaving the manufactured liquid crystal display in an atmosphere of 25° C. 10% RH for 72 hours, black luminance was measured by EZ-Contrast 160D.

Black luminance change ratio in the measurement in the atmosphere of 25° C. 10% RH was calculated on the basis of black luminance in the measurement in the atmosphere of 25° C./60% RH to evaluate the change of display performance depending upon humidity.

More specifically, the change of display performance depending upon humidity was calculated by the following formula to obtain the change ratio, and was evaluated according to the following criteria.

“change (%)”=(“black luminance of the liquid crystal display left in the atmosphere of 25° C. 10% RH for 72 hours”/“black luminance of the liquid crystal display left in the atmosphere of 25° C. 60% RH for 72 hours”−1)×100

*: less than 10%
Θ: 10% or more and less than 20%
O: 20% or more and less than 25%
Δ: 25% or more and less than 30%
X: 30% or more

### Examples 1-1 to 1-8

The layer construction of the liquid crystal display in which a lactone film was used on the nearest side to light source when viewed from the liquid crystal cell is shown in FIG. 5. A TAC film is used in every optically anisotropic layer.

The polarizing plate and optically compensatory sheet of the front and rear side of the panel of a VA mode liquid crystal TV (LC30-AD1, manufactured by Sharp Corporation) were peeled off, and manufactured polarizing plates were stuck so that the transmission axis of the polarizing plate was in vertical direction to the screen on the visual check side, and the transmission axis of the polarizing plate is in a horizontal direction to the screen on the light source side.

### Comparative Examples 1-1 to 1-8

The layer construction of the liquid crystal display in which a TAC film was used on the light source side of the polarizing plate is shown in FIG. 5. A TAC film is used in every optically anisotropic layer. In the same manner as in Example 1, the polarizing plates were stuck on the VA liquid crystal panel.

### Examples 2-1 to 2-3

The layer construction of the liquid crystal display using, on at least one side of the display surface side and the light source side, a film provided with a coating layer as the optically anisotropic layer on the lactone film is shown in FIG. 6. In the same manner as in Example 1, the polarizing plates were stuck on the VA liquid crystal panel.

### Comparative Examples 2-1 to 2-3

The layer construction of the liquid crystal display using, on at least one side of the display surface side and the light source side, a film provided with a coating layer as the optically anisotropic layer on the TAC film is shown in FIG. 6. In the same manner as in Example 1, the polarizing plates were stuck on the VA liquid crystal panel.

### Examples 2-1 to 2-3

The layer construction of the liquid crystal display using, on at least one side of the display surface side and the light source side, a film provided with a layer containing polyimide as the optically anisotropic layer on the lactone film is shown in FIG. 7. In the same manner as in Example 1, the polarizing plates were stuck on the VA liquid crystal panel.

### Comparative Examples 2-1 to 2-3

The layer construction of the liquid crystal display using, on at least one side of the display surface side and the light source side, a film provided with a layer containing polyimide as the optically anisotropic layer on the TAC film is shown in FIG. 7. In the same manner as in Example 1, the polarizing plates were stuck on the VA liquid crystal panel.

The above results are shown in Table 1-1.

The liquid crystal display in which more lactone films are used in the polarizing plate on the light source side of liquid crystal cell is high in front contrast, and the difference in display performance in the atmosphere of 25° C. 10% RH and in the atmosphere of 25° C. 60% RH is small, so that it can be seen that this case is superior to the case where the comparative film is used. Further, in Table 1-1, “outer side”, “inner side”, and “optically anisotropic layer” on the light source side correspond to member 111, member 109, and member 108 of FIGS. 4 and 5 respectively; and “outer side”, “inner side”, and “optically anisotropic layer” in the display surface correspond to member 101, member 103, and member 104, respectively. Further, in Table, “-” means that a member corresponding to “-” has not been provided.

TABLE 1-1

| | Layer Construction in Liquid Crystal Display | | | | | | | | | |
|---|---|---|---|---|---|---|---|---|---|---|
| | | | | | | | | | Variation of | |
| | Light Source Side | | | Display Surface Side | | | | | Display | |
| | | | Optically | Optically | | | | | Performance | |
| | Outer | Inner | Anisotropic | Anisotropic | Inner | Outer | Black | | due to | Front |
| | Side | Side | Layer | Layer | Side | Side | Luminance | Change | Humidity | CR |
| Example 1-1 | Lactone | TAC | TAC | TAC | TAC | TAC | 0.55 | 22% | ◯ | 655 |
| Example 1-2 | Lactone | Lactone | TAC | TAC | TAC | TAC | 0.51 | 13% | Θ | 706 |
| Example 1-3 | Lactone | TAC | TAC | TAC | Lactone | TAC | 0.52 | 16% | Θ | 692 |
| Example 1-4 | Lactone | TAC | TAC | TAC | TAC | Lactone | 0.54 | 20% | ◯ | 667 |
| Example 1-5 | Lactone | Lactone | TAC | TAC | Lactone | TAC | 0.48 | 7% | * | 750 |
| Example 1-6 | Lactone | Lactone | TAC | TAC | TAC | Lactone | 0.50 | 11% | Θ | 720 |
| Example 1-7 | Lactone | TAC | TAC | TAC | Lactone | Lactone | 0.51 | 13% | Θ | 706 |
| Example 1-8 | Lactone | Lactone | TAC | TAC | Lactone | Lactone | 0.47 | 4% | * | 766 |
| Comparative | TAC | TAC | TAC | TAC | TAC | TAC | 0.60 | 33% | X | 600 |
| Example 1-1 | | | | | | | | | | |
| Comparative | TAC | Lactone | TAC | TAC | TAC | TAC | 0.56 | 24% | ◯ | 643 |
| Example 1-2 | | | | | | | | | | |
| Comparative | TAC | TAC | TAC | TAC | Lactone | TAC | 0.57 | 27% | Δ | 632 |
| Example 1-3 | | | | | | | | | | |
| Comparative | TAC | TAC | TAC | TAC | TAC | Lactone | 0.59 | 31% | X | 610 |
| Example 1-4 | | | | | | | | | | |
| Comparative | TAC | Lactone | TAC | TAC | Lactone | TAC | 0.53 | 18% | Θ | 679 |
| Example 1-5 | | | | | | | | | | |
| Comparative | TAC | Lactone | TAC | TAC | TAC | Lactone | 0.55 | 22% | ◯ | 655 |
| Example 1-6 | | | | | | | | | | |
| Comparative | TAC | TAC | TAC | TAC | Lactone | Lactone | 0.56 | 24% | ◯ | 643 |
| Example 1-7 | | | | | | | | | | |
| Comparative | TAC | Lactone | TAC | TAC | Lactone | Lactone | 0.52 | 16% | Θ | 692 |
| Example 1-8 | | | | | | | | | | |
| Example 2-1 | TAC | Lactone | Coating | — | TAC | TAC | 0.57 | 27% | Δ | 632 |
| | | | Layer | | | | | | | |
| Example 2-2 | TAC | TAC | — | Coating | Lactone | TAC | 0.58 | 29% | Δ | 621 |
| | | | | layer | | | | | | |
| Example 2-3 | TAC | Lactone | Coating | Coating | Lactone | TAC | 0.54 | 20% | ◯ | 667 |
| | | | layer | layer | | | | | | |
| Comparative | TAC | TAC | Coating | — | TAC | TAC | 0.61 | 36% | X | 590 |
| Example 2-1 | | | layer | | | | | | | |
| Comparative | TAC | TAC | — | Coating | TAC | TAC | 0.61 | 36% | X | 590 |
| Example 2-2 | | | | layer | | | | | | |
| Comparative | TAC | TAC | Coating | Coating | TAC | TAC | 0.62 | 38% | X | 581 |
| Example 2-3 | | | layer | layer | | | | | | |
| Example 3-1 | TAC | Lactone | Polyimide | — | TAC | TAC | 0.57 | 27% | Δ | 632 |
| | | | layer | | | | | | | |
| Example 3-2 | TAC | TAC | — | Polyimide | Lactone | TAC | 0.58 | 29% | Δ | 621 |
| | | | | layer | | | | | | |
| Example 3-3 | TAC | Lactone | Polyimide | Polyimide | Lactone | TAC | 0.54 | 20% | ◯ | 687 |
| | | | layer | layer | | | | | | |
| Comparative | TAC | TAC | Polyimide | — | TAC | TAC | 0.61 | 36% | X | 590 |
| Example 3-1 | | | layer | | | | | | | |
| Comparative | TAC | TAC | — | Polyimide | TAC | TAC | 0.61 | 36% | X | 590 |
| Example 3-2 | | | | layer | | | | | | |
| Comparative | TAC | TAC | Polyimide | Polyimide | TAC | TAC | 0.62 | 38% | X | 581 |
| Example 3-3 | | | layer | layer | | | | | | |

Examples corresponding to Embodiments 2-1 and 2-2 of the invention are described below.

Lactone Ring-Containing Polymer

A lactone ring-containing polymer was obtained according to the synthesis method as described in [0230] to [0232] of WO 2006/025445A1.

Manufacture of Optically Compensatory Sheet of Examples 101 to 109

Each of the components was mixed so as to have the ratio described in Table 2-1, and to prepare a lactone solution. The values of the triphenyl phosphate, biphenyl phosphate, and retardation developer of Table 2-1 are values (unit: parts by mass) on the basis of 100 parts by mass of the lactone ring-containing polymer. These solvents were each mixed with 430 parts by mass of methylene chloride and 64 parts by mass of methanol. These prepared lactone solutions were cast with a band casting machine, following by peeling of the obtained web from a band, then stretching with the stretch ratio described in Table 2-1 in the TD direction under the condition of 120° C. and dried to manufacture the optical compensation films 101 to 109 as the optically anisotropic layers each having thickness and Re(550)/Rth(550) described in Table 2-1. Retardation developers described in Table 2-1 each had the materials represented by the following structure formula, and were the same as in Table 2-2.

TABLE 2-1
Preparation ratio and optical characteristic of optical compensatory films 101 to 109

| Film No. | 101 | 102 | 103 | 104 | 105 | 106 | 107 | 108 | 109 |
|---|---|---|---|---|---|---|---|---|---|
| Triphenyl phosphate | 7 | 5 | 5 | 5 | 5 | 7 | 3 | 3 | 3 |
| Biphenyl phosphate | 5 | 2.4 | 2.4 | 2.4 | 2.4 | 5 | 2 | 2 | 2 |
| Retardation developer 1 | 9 | — | — | — | — | 5 | — | — | — |
| Retardation developer 2 | — | 10 | 7.2 | 6 | 4.3 | — | 2.6 | 2.4 | 2.2 |
| Retardation developer 3 | — | 8 | 6 | 5 | 3.6 | — | 8 | 7.2 | 6.6 |
| Strech ratio (%) | 30 | 30 | 35 | 45 | 60 | 30 | 30 | 35 | 40 |
| Film thickness (μm) | 80 | 50 | 50 | 50 | 50 | 55 | 55 | 55 | 55 |
| Re(550)/Rth(550) (nm) | 55/200 | 80/170 | 100/125 | 125/100 | 150/75 | 45/125 | 50/120 | 60/110 | 70/100 |

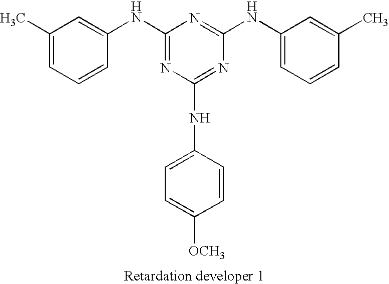

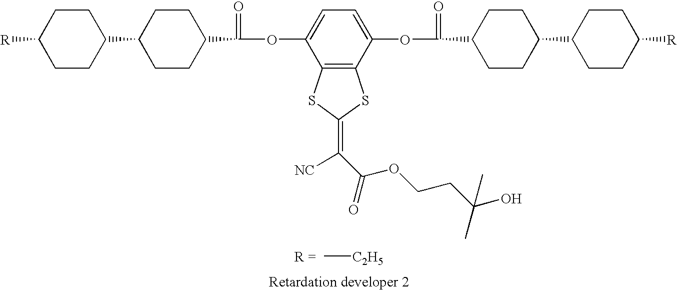

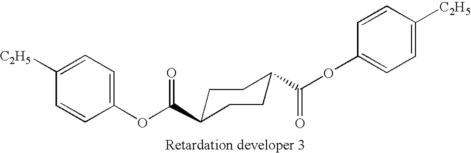

Manufacture of Optically Compensatory Sheet of Comparative Examples 201 to 208

Each of the components was mixed so as to have the ratio described in Table 2-2, and to prepare a lactone solution. The values of the triphenyl phosphate, biphenyl phosphate, and retardation developer of Table 2-2 are values (unit: parts by mass) on the basis of 100 parts by mass of the lactone ring-containing polymer. These solvents were each mixed with 430 parts by mass of methylene chloride and 64 parts by mass of methanol. This prepared lactone solution was cast with a band casting machine, following by peeling of the obtained web from the band, then stretching with the stretch ratio described in Table 2-2 in the TD direction under the condition of 120° C. and dried to manufacture optical compensation films 201 to 208 as the optically anisotropic layers each having thicknesses and Re(550)/Rth(550) described in Table 2-2.

Manufacture of Optically Compensatory Film of Comparative Examples 209 and 210

Each of the components was mixed so as to have the ratio described in Table 2-2 and to prepare a cellulose acylate solution. The values of the triphenyl phosphate, biphenyl phosphate, and retardation developer of Table 2-2 are values (unit: parts by mass) on the basis of 100 parts by mass of the cellulose acylate. These solvents were each mixed with 430 parts by mass of methylene chloride and 64 parts by mass of methanol. These prepared cellulose acylate solutions were cast with a band casting machine, following by peeling of the obtained web from the band, then stretching with stretch ratio described in Table 2 in the TD direction under the condition of 120° C. and dried to manufacture the optical compensation films 209 to 210 as the optically anisotropic layers each having thicknesses and Re(550)/Rth(550) described in Table 2-2.

TABLE 2-2
Preparation ratio and optical characteristic of optical compensatory films 201 to 210

| Film No. | 201 | 202 | 203 | 204 | 205 | 206 | 207 | 208 | 209 | 210 |
|---|---|---|---|---|---|---|---|---|---|---|
| Cellulose acylate | — | — | — | — | — | — | — | — | 2.92 | 2.86 |
| acetyl substitution | | | | | | | | | | |
| degree (209, 210) | | | | | | | | | | |
| Triphenyl phosphate | 7 | 5 | 7 | 5 | 7 | 3 | 7 | 5 | 3 | 3 |
| Biphenyl phosphate | 5 | 2.4 | 5 | 2.4 | 5 | 2 | 5 | 2.4 | 2 | 2 |
| Retardation | 5.8 | — | 13.5 | — | 5 | — | 5.8 | — | — | — |
| developer 1 | | | | | | | | | | |
| Retardation | — | 3.5 | — | 7.2 | — | 2.4 | — | 4.7 | 6 | 2 |
| developer 2 | | | | | | | | | | |
| Retardation | — | 2.8 | — | 6 | — | 7.2 | — | 3.7 | 5 | 6 |
| developer 3 | | | | | | | | | | |
| Strech ratio (%) | 15 | 10 | 55 | 35 | 30 | 50 | 15 | 8 | 20 | 20 |
| Film thickness (μm) | 80 | 50 | 80 | 140 | 75 | 55 | 105 | 50 | 50 | 55 |
| Re(550)/Rth(550) (nm) | 30/130 | 30/60 | 100/300 | 280/350 | 60/170 | 90/110 | 40/160 | 25/80 | 100/125 | 60/110 |

Manufacture of Polarizing Plates 101 to 109 of Examples and Polarizing Plates 201 to 210 of Comparative Examples

The optically compensatory film manufactured above as a support was subjected to alkaline saponification treatment. More specifically, these optically compensatory films were dipped in 1.5N aqueous sodium hydroxide solution for 2 minutes at 55° C., were subsequently washed in a water bath at room temperature, and were neutralized with 0.1N sulfuric acid at 30° C. Subsequently, they were washed again in a water bath at room temperature, and further were dried with warm air at 100° C.

On the other hand, polyvinyl alcohol film in the form of a roll having a thickness of 80 μm consecutively was stretched 5 times in aqueous iodine solution, and was dried to obtain a polarizing film with a thickness of 20 μm.

Each of the optically compensatory films which were subjected to alkaline saponification treatment as described above, and Fujitec TD80UL (Fujifilm Corporation) which was subjected to alkaline saponification treatment as described above, was prepared. Polarizing plates 101 to 109 and polarizing plates 201 to 210 were each manufactured by placing a polarizing film therebetween, such that these saponified surfaces were on a polarizing film side, and by sticking with 3% aqueous polyvinyl alcohol (PVA-117H, manufactured by Kurary Co., Ltd.) solution as an adhesive so that each film and TD80UL were a protective film of the polarizing film.

Manufacture of LCDs 101 to 109 of the Invention and LCDs 201 to 210 of Comparative Examples

VA mode liquid crystal displays 101 to 109 and 201 to 210 were each manufactured by peeling a polarizing plate and an optically anisotropic layer which had been disposed on a front surface and a rear surface of commercial VA liquid crystal TV (LC42RX1W, manufactured by Sharp Corporation), and by sticking each of the manufactured polarizing plates to the liquid crystal cell such that the protective film was outer side, using each of the two manufactured polarizing plates. When the polarizing plates were disposed, the absorption axis of the polarizing plate was stuck to the horizontal direction of the screen on the visible side and the absorption axis of the polarizing plate in backlight side was stuck to vertical direction of the screen.

Black display performance, and humidity dependency of black display performance (change in black display performance)

Black Display Performance

After a manufactured VA mode liquid crystal display was left in an atmosphere of 25° C. 60% RH for 72 hours (corresponding to “initial performance” of Table 2-3), the liquid crystal display was used for black display, the display performance of front and inclination direction (polar angle of 60°, azimuth of 0 to 360° (every 5°)) was measured by BM-5A (manufactured by Topcon Corporation) to calculate luminance in inclination direction, and the angle where the front and inclined black tint change Δu′v′ is maximum. As the judgment criteria, the display may be acceptable when the performance are equal to or less commercial product (black tint change (Δu′v′):0.06 or less, the leakage of black luminance at inclination direction: 3[cd/m²] or less), and the display may not be acceptable when any one of these two is not satisfied.

The black tint change Δu'v′ was calculated on the basis of the following formula.

Δu′v′=√((u′inclination−u′front)²+(v′inclination−v′front)²)

Wherein, “u′ front (inclination)” and “v′ front (inclination)” represents tint (CIE1976 u′v′ chromaticity diagram) in front (inclination) direction respectively.

O: Both change in black tint and leakage of black luminance may be acceptable.

x: Either one of Change in black tint or leakage of black luminance may not be acceptable.

Change in Black Display Performance

Subsequently, after leaving a VA type liquid crystal display was left in an atmosphere of 25° C. 10% RH for 72 hours (corresponding to “after change” of Table 2-3), black display performance was confirmed, and whether there is change in display performance due to humidity or not was confirmed on the basis of the criteria as described above.

O: Change in black tint and leakage of black luminance may be acceptable.

x: Change in black tint or leakage of black luminance may not be acceptable.

These results are shown in Table 2-3. From these results, it has been found that the liquid crystal display using the lactone film of the invention as the optically compensatory film has a good black display performance, has stable performance without regard to humidity, and is superior compared with the film of Comparative Examples.

TABLE 2-3
Black display performance and change in black display performance according to humidity

| | | | | | After the change (after leaving | |
|---|---|---|---|---|---|---|
| | | | | | the liquid crystal display at | |
| | | | Initial performance | | 25° C. 10% RH for 72 hours) | |
| | | | | Leakage of black | | Leakage of black |
| | | Change in | Ting change at | luminance at | Tint chang at | bluminance at |
| | Black display | black display | inlicnation | inclination | inclination | inclunation |
| | performance | perfomenace | direction | direction | direction | direction |
| Example 101 | ◯ | ◯ | 0.05 | 2.8 | 0.053 | 2.7 |
| Example 102 | ◯ | ◯ | 0.03 | 1.8 | 0.04 | 2 |
| Example 103 | ◯ | ◯ | 0.02 | 1.5 | 0.03 | 1.6 |
| Example 104 | ◯ | ◯ | 0.04 | 1.8 | 0.045 | 1.7 |
| Example 105 | ◯ | ◯ | 0.05 | 2.5 | 0.04 | 2.5 |
| Example 106 | ◯ | ◯ | 0.04 | 2.8 | 0.045 | 3 |
| Example 107 | ◯ | ◯ | 0.04 | 2 | 0.04 | 2.2 |
| Example 108 | ◯ | ◯ | 0.03 | 1.5 | 0.035 | 1.8 |
| Example 109 | ◯ | ◯ | 0.04 | 2 | 0.04 | 2.3 |
| Comparative | X | ◯ | 0.04 | 5.5 | 0.03 | 5.8 |
| example 201 | | | | | | |
| Comparative | X | ◯ | 0.06 | 7.2 | 0.07 | 7.4 |
| example 202 | | | | | | |
| Comparative | X | ◯ | 0.02 | 9.3 | 0.02 | 9.1 |
| example 203 | | | | | | |
| Comparative | X | ◯ | 0.02 | 15 | 0.02 | 14.5 |
| example 204 | | | | | | |
| Comparative | X | ◯ | 0.07 | 4.1 | 0.08 | 4.6 |
| example 205 | | | | | | |
| Comparative | X | ◯ | 0.05 | 5 | 0.05 | 4.7 |
| example 206 | | | | | | |
| Comparative | X | ◯ | 0.03 | 5.5 | 0.04 | 5.8 |
| example 207 | | | | | | |
| Comparative | X | ◯ | 0.04 | 6.2 | 0.04 | 6.5 |
| example 208 | | | | | | |
| Comparative | ◯ | X | 0.02 | 1.4 | 0.04 | 5 |
| example 209 | | | | | | |
| Comparative | ◯ | X | 0.03 | 1.6 | 0.05 | 5.5 |
| example 210 | | | | | | |

### INDUSTRIAL APPLICABILITY

According to an embodiment of the invention, a liquid crystal display that has little atmosphere dependency regarding optical performance, in particular, little humidity dependency, excellent front contrast, and further excellent durability, is provided.

Further, according to another embodiment of the invention, images of high contrast may be displayed at a wide viewing angle, and the VA mode liquid crystal display where color shift (tint changes when viewed from inclination direction) is reduced may be provided. Further, according to this embodiment, the liquid crystal displays of the invention may be produced by a simple method.

The invention has been described in detail or by referring to specific embodiments, but it is obvious to those skilled in the art that various modifications and alternations can be made to the invention without departing from the spirit or scope of the present invention.

The present application is based on Japanese Patent Application Nos. 2007-256819 and 2007-256885 filed Sep. 28, 2007 and Japanese Patent Application No. 2008-245034 filed Sep. 24, 2008, the contents of which are incorporated herein by reference.

1. A VA (vertical alignment) liquid crystal display comprising at least:
a light source,
a liquid crystal cell that comprises a pair of substrates and a liquid crystal layer being placed between the substrates, and
a film that contains a thermoplastic resin composition containing a lactone ring-containing polymer,
wherein the film is arranged on the nearer side to the light source of the liquid crystal cell.

2. A VA (vertical alignment) liquid crystal display comprising at least:
a film that contains a thermoplastic resin composition containing a lactone ring-containing polymer, wherein each of in-plane retardation (Re) and retardation in a thickness direction (Rth) of the film is 10 nm or less, and
an optically anisotropic layer on the film.

3. The VA (vertical alignment) liquid crystal display as claimed in claim 2, wherein the optically anisotropic layer is formed by applying a liquefied polymer on the film.

4. The VA (vertical alignment) liquid crystal display as claimed in claim 2, wherein the optically anisotropic layer contains polyimide.

5. A VA (vertical alignment) liquid crystal display comprising:
a liquid crystal cell,
two polarizing plates disposed outside the liquid crystal cell, and
an optically anisotropic layer disposed at either of two spaces between the liquid crystal cell and two polarizing plates,
wherein the optically anisotropic layer contains a lactone ring-containing polymer, and in-plane retardation Re and retardation in a thickness direction Rth of the optically anisotropic layer satisfy the following formulae (A) and (B),
40 nm≦Re(550)≦275 nm (A)
0 nm≦Rth(550)≦275 nm (B)
wherein Re(550) and Rth(550) represent in-plane retardation (nm) and retardation (nm) in a thickness direction at the wavelength of 550 (nm).

6. A VA (vertical alignment) liquid crystal display comprising:
a liquid crystal cell,
two polarizing plates disposed outside the liquid crystal cell, and
optically anisotropic layers disposed at both of two spaces between the liquid crystal cell and two polarizing plates,
wherein the optically anisotropic layers contain a lactone ring-containing polymer, and in-plane retardation Re and retardation in a thickness direction Rth of the optically anisotropic layers satisfy the following formulae (C) and (D),
30 nm≦Re(550)≦80 nm (C)
75 nm≦Rth(550)≦155 nm. (D)

7. The VA (vertical alignment) liquid crystal display as claimed in claim 5,
wherein the optically anisotropic layer containing the lactone ring-containing polymer contains at least one kind of retardation developer.

8. The VA (vertical alignment) liquid crystal display as claimed in claim 7,
wherein the retardation developer is a compound represented by the following formula (I): 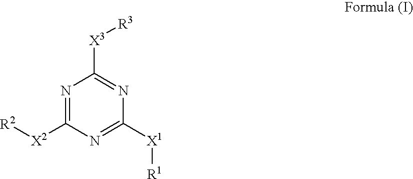
wherein
X¹ represents a single bond, —NR⁴—, —O— or S—,
X² represents a single bond, —NR⁵—, —O— or S—,
X³ represents a single bond, —NR⁶—, —O— or S—,
R¹, R² and R³ each independently represents an alkyl group, an alkenyl group, an aromatic group, or a heterocyclic group, and
R⁴, R⁵ and R⁶ each independently represents a hydrogen atom, an alkyl group, an alkenyl group, an aryl group or a heterocyclic group.

9. The VA (vertical alignment) liquid crystal display as claimed in claim 7,
wherein the retardation developer is a compound represented by the following formula (II): 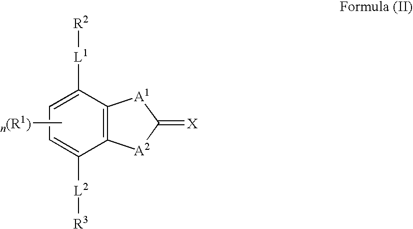
wherein
L¹ and L² each independently represents a single bond, or a divalent connecting group,
A¹ and A² each independently represents a group selected from the group consisting of —O—, —NR— (R represents a hydrogen atom or a substituent), —S— and —CO—,
R¹, R² and R³ each independently represents a substituent,
X represents an atom of 6th group, 5th group, or 4th group, and
n represents an integer of from 0 to 2.

10. The VA (vertical alignment) liquid crystal display as claimed in claim 7, wherein the retardation developer is a compound represented by the following formula (III):
Ar¹-L²-X-L³-Ar² Formula (III)
wherein
Ar¹ and Ar² each independently represents an aromatic group,
L² and L³ each independently represents a divalent connecting group selected from —O—CO— or CO—O— group, and
X represents a 1,4-cyclohexylene group, a vinylene group, or an ethynylene group.

11. The VA (vertical alignment) liquid crystal display as claimed in claim 5, wherein the optically anisotropic layer including the lactone ring-containing polymer is stretched in at least one direction.

12. The VA (vertical alignment) liquid crystal display as claimed in claim 11, wherein a stretch ratio during the stretching is 1.3 to 5 times.
